(19) United States
(12) Patent Application Publication
(10) Pub. No.: US 2024/0157295 A1
(43) Pub. Date: May 16, 2024

(54) ULTRAFAST CATALYTIC CO2 CAPTURE CATALYZED BY A NOVEL ULTRASOUND-TREATED IONIC LIQUID

(71) Applicant: University of Wyoming, Laramie, WY (US)

(72) Inventors: Maohong Fan, Ames, IA (US); Xiaowen Zhang, Laramie, WY (US); Yangyan Gao, Laramie, WY (US); Armistead G. Russell, Atlanta, GA (US); Xin He, Laramie, WY (US)

(73) Assignees: University of Wyoming, Laramie, WY (US); Georgia Tech Research Corporation, Atlanta, GA (US)

(21) Appl. No.: 18/049,226

(22) Filed: Oct. 24, 2022

Related U.S. Application Data
(62) Division of application No. 17/177,766, filed on Feb. 17, 2021, now Pat. No. 11,478,747.
(60) Provisional application No. 63/088,880, filed on Oct. 7, 2020.
(60) Provisional application No. 62/977,610, filed on Feb. 17, 2020.

(51) Int. Cl. B01D 53/86; B01J 31/02; B01J 37/34

(52) U.S. Cl. CPC B01D 53/8671; B01D 53/8693; B01J 31/0278; B01J 37/343; B01D 2257/504; B01D 2259/816

(57) ABSTRACT

A transformational energy efficient technology using ionic liquid (IL) to couple with monoethanolamine (MEA) for catalytic CO₂ capture is disclosed. [EMmim⁺][NTF₂⁻] based catalysts are rationally synthesized and used for CO₂ capture with MEA. A catalytic CO₂ capture mechanism is disclosed according to experimental and computational studies on the [EMmim⁺][NTF₂⁻] for the reversible CO₂ sorption and desorption.

### CROSS-REFERENCE TO RELATED APPLICATIONS

This application claims priority under 35 U.S.C. § 119 to provisional application Ser. No. 62/977,610 filed Feb. 17, 2020, provisional application Ser. No. 63/088,880 filed Oct. 7, 2020, and patent application Ser. No. 17/177,766 filed on Feb. 17, 2021, all of which are incorporated by reference in their entirety.

### GRANT REFERENCE

This disclosure was made with government support under a grant number 1903627 awarded by the National Science Foundation. The government has certain rights in the disclosure.

### BACKGROUND

### I. Field of the Disclosure

The present disclosure relates to a fast and stable approach for catalytic CO₂ capture from both gas streams (e.g., flue gas) and atmosphere. Particularly, but not exclusively, the present disclosure relates to the development of homogeneous catalyst—a new bifunctional ionic liquid (IL), [CH2COOCH3mim+][NTF2−] denoted as [EMmim+][NTF2−] (see SI) in a CO₂ capture process and used as catalysts for CO₂ desorption and sorption instead of a sorbet. This present disclosure also relates to the integration of ultrasonic treatment into the catalysis performance improvement of [EMmim+][NTF2−] for development of a new generation of CO₂ capture catalysts. The ionic liquid [EMmim][NTf₂] providing a stable transformative catalyst instead of a sorbent for CO₂ capture.

### II. Description of the Prior Art

Carbon dioxide (CO₂) is a primary greenhouse gas that makes a great contribution to global warming, owing to the excessive emissions from the combustion of fossil fuels. Carbon capture, utilization, and storage (CCUS) is the mature technology that can be carried out to alleviate the CO₂ discharge, which is urgently needed for achieving the goals set in the Paris Climate Accord. Amine-based CO₂ absorption is one of the potentially cost-effective options for capturing CO₂ from both gas streams (e.g., flue gas) and atmosphere. CO₂ capture is critical because of its increasing importance as a resource for material and fuel synthesis.

The fundamental challenge of chemisorption-based technologies can be the slow absorption and desorption reaction kinetics when CO₂ desorption at >100° C., which excessive energies may be needed to vaporize a large amount of liquid water during CO₂ desorption operation and condense the same amount of water vapor prior to CO₂ desorption during cyclic CO₂ sorption and desorption. Monoethanolamine (MEA) solution has low price and high reactivity with CO₂, which apply to the benchmark solvent for evaluating amine-based CO₂ capture processes at small scale. However, this technology is still not acceptable for versatile and large-scale uses mainly, attributed to (1) the critical limitations for >100° C. CO₂ desorption or very energy intensive MEA regeneration process, and (2) the resultant aggregated MEA degradation, as well as (3) severe corrosion at such high temperatures. In other words, to render fast CO₂ desorption from aqueous solvent, high temperature (120-140° C.) must be required for the current state-of-the-art, resulting in excessive energy demands for the water vaporization. Therefore, there is a need for [EMmim+][NTF2−] as the new bifunctional IL catalysts in CO₂ capture process instead of a sorbent, which is not only very effective for catalyzing CO₂ desorption but also CO₂ sorption. Thus, in accordance with one or more aspects of the present disclosure, [EMmim][NTf2] is used as a transformative catalyst instead of a sorbent for CO₂ capture.

### SUMMARY

Therefore, it is a primary object, feature, or advantage of the present disclosure to improve over the state of the art.

According to at least one exemplary aspect, it is an object of the present disclosure to provide for a new use of monoethanolamine (MEA) solution

According to at least one other exemplary aspect, it is an object of the present disclosure to provide for controlled ultrasonic hydrolysis to enhance the catalytic ability of [EMmim+][NTF2−] (IL).

According to at least another exemplary aspect, it is an object of the present disclosure to provide for [EMmim⁺][NTF₂⁻] based catalysts that can be synthesized and used for CO₂ capture with MEA.

According to at least another exemplary aspect, it is an object of the present disclosure to provide for [EMmim⁺][NTF₂⁻] based catalysts that can be used for CO₂ capture with MEA without the presence of H₂O.

According to at least another exemplary aspect, it is an object of the present disclosure to provide for [EMmim⁺][NTF₂⁻] based catalysts that can be used for solid based CO₂ capture.

According to at least another exemplary aspect, it is an object of the present disclosure to provide for [EMmim⁺][NTF₂⁻] based catalysts that can be used for liquid based CO₂ capture.

According to at least one other exemplary aspect, it is an object of the present disclosure to provide a solution where [EMmim⁺][NTF₂⁻] can not only significantly move the initial CO₂ desorption point to earlier times, but can also increase the rates of CO₂ desorption (r_{d, CO}_{₂}) from the spent MEA solutions containing the same amounts CO₂.

According to at least one exemplary aspect, it is an object of the present disclosure to provide a solution for low energy efficient technologies that demonstrates much quicker CO₂ desorption kinetics at low temperature enabled with the use of the catalyst, which significantly advances the development of a new generation of CO₂ capture technologies, from at least the perspectives of decreasing the parasitic penalty of these systems, capital investment, and environmental protection.

According to at least one other exemplary aspect of the present disclosure, ionic liquid [EMmin][NTf₂] promotes both CO₂ absorption and desorption.

According to at least another exemplary aspect, the time needed for reaching the maximum desorption rate with the use of [EMmim][NTf₂] is shortened by 150 seconds in comparison to the time required for CO₂ desorption without the use of the IL catalyst.

According to at least one other exemplary aspect, the ionic liquid (ILS) [EMmim][NTf₂] catalyst can make CO₂ capture much less demanding for high quality energy.

According to still another exemplary aspect of the present disclosure, the increases in desorption rate and the desorbed CO₂ amount that can be obtained with [EMmim][NTf₂] can reach as high as 791% at 507 seconds and 534% at 551 seconds.

According to yet another exemplary aspect, the ionic liquid [EMmim][NTf₂] is beneficial to the elimination of the secondary environmental pollutants resulting from MEA degradation during high-temperature CO₂ desorption of conventional CO₂ capture technologies.

According to another exemplary aspect, MEA and the [EMmim][NTf₂] are optimally configured to be stable with 50 cyclic tests in view of the FT-IR spectra of the regenerated MEA solution confirming no change in both quantities of absorbed and desorbed CO₂.

According to still another exemplary aspect of the present disclosure, ionic liquid [EMmim][NTf₂] can be thermally stable at temperatures as high as 300° C.

According to yet another exemplary aspect of the present disclosure, direct evidence is shown of hydrolysis of —COOCH3 in the IL into —COOH a key function group in catalyzing the subsequent CO₂ desorption.

According to at least one other exemplary aspect, observations of the changes in concentrations of intermediates with FT-IR spectra may cause significant catalytic effect of the ionic liquid [EMmim][NTf₂].

According to still one other exemplary aspect of the present disclosure, [mimCH₂COOH]⁺, P1-WH_{cat}-MEA-CO₂ decreases the overall CO₂ capture energy consumption.

According to at least one other exemplary aspect, a method for catalytic CO₂ capture is disclosed. The method includes, for example, steps such as providing a catalyst and a monoethanolamine (MEA), coupling ultrasonically treated ionic liquid with the MEA, and capturing CO₂ from the catalyst with the MEA.

According to at least one other exemplary aspect, a method for catalytic CO₂ capture is disclosed. The method includes, for example, steps such as providing a catalyst selected from the group of [EMmim⁺][NTF₂⁻] based catalysts and a CO₂ loaded monoethanolamine (MEA) solution, treating the catalyst with an ionic liquid, and capturing CO₂ from the catalyst with the MEA.

In accordance with at least one exemplary aspect of the present disclosure, a method for catalyzing both CO₂ sorption and desorption is disclosed. The method includes, in at least one aspect, the exemplary steps of providing a catalyst selected from the group of [EMmim⁺][NTF₂⁻] based catalysts and a CO₂ loaded monoethanolamine (MEA) solution, treating the MEA with an ionic liquid (IL) for providing a IL [EMmim⁺][NTF₂⁻] based catalyst, and absorbing and desorbing CO₂ with IL catalyst.

One or more of these and/or other objects, features, or advantages of the present invention will become apparent from the specification and claims that follow. No single embodiment need provide every object, feature, or advantage. Different embodiments may have different objects, features, or advantages. Therefore, the present invention is not to be limited to or by any objects, features, or advantages stated herein.

### BRIEF DESCRIPTION OF THE DRAWINGS

Illustrated embodiments of the disclosure are described in detail below with reference to the attached drawing figures, which are incorporated by reference herein, and where:

FIG. 1A provides a catalytic effect of [EMmim+][NTF2−] and US−[EMmim+][NTF2−] on the CO₂ desorption (des.) in accordance with an exemplary aspect of the present disclosure;

FIG. 1B provides another view of a catalytic effect of [EMmim+][NTF2−] and US−[EMmim+][NTF2−] on the CO₂ desorption (des.) in accordance with an exemplary aspect of the present disclosure;

FIG. 2A is a pictorial representation demonstrating stability of the MEA/US−[EMmim+][NTF2−] CO₂ capture system for cyclic CO₂ absorption-desorption tests more than 4 months in accordance with an exemplary illustration;

FIG. 2B is a plot illustrating an evaluation of stability of [EMmim][NTf₂] as a catalyst for MEA based CO₂ capture;

FIG. 3A is a schematic representation of the [EMmim+][NTF2−] catalyst ultrasound activation process for preparing US−[EMmim+][NTF2−]+MEA solution CO₂ capture system;

FIG. 3B is another schematic representation of the [EMmim+][NTF2−] catalyst ultrasound activation process for preparing US−[EMmim+][NTF2−]+MEA solution CO₂ capture system;

FIG. 3C is another schematic representation of the [EMmim+][NTF2−] catalyst ultrasound activation process for preparing US−[EMmim+][NTF2−]+MEA solution CO₂ capture system;

FIG. 4A illustrates an exemplary plot of the intensity-time profiles of Raman spectra of spent MEA solutions collected during CO₂ desorption without and with catalyst at different regeneration time in accordance with one exemplary test;

FIG. 4B illustrates another exemplary plot of the intensity-time profiles of Raman spectra of spent MEA solutions collected during CO₂ desorption without and with catalyst at different regeneration time in accordance with one exemplary test;

FIG. 4C illustrates an exemplary plot of the intensity-time profiles of FT-IR spectra of spent MEA solutions collected during CO₂ desorption without and with catalyst at different regeneration time in accordance with one exemplary test;

FIG. 4D illustrates another exemplary plot of the intensity-time profiles of FT-IR spectra of spent MEA solutions collected during CO₂ desorption without and with catalyst at different regeneration time in accordance with one exemplary test;

FIG. 4E illustrates another exemplary plot of FT-IR spectra of the catalytic and uncatalytic solutions during uncatalyzed CO₂ absorption and desorption at different times. Catalyzed CO₂ desorption in accordance with an exemplary aspect of the present disclosure;

FIG. 4F illustrates another exemplary plot of FT-IR spectra of the catalytic and uncatalytic solutions during catalyzed CO₂ absorption and desorption at different times;

FIG. 4G illustrates another exemplary plot of FT-IR spectra of the catalytic and uncatalytic solutions during uncatalyzed CO₂ desorption and desorption at different times;

FIG. 4H illustrates another exemplary plot of FT-IR spectra of the catalytic and uncatalytic solutions during catalyzed CO₂ desorption and desorption at different times;

FIG. 5A illustrates exemplary DFT based non-catalytic and catalytic CO₂ capture reaction pathways;

FIG. 5B illustrates exemplary DFT based non-catalytic and catalytic CO₂ capture energy profiles;

FIG. 6 provides a schematic diagram of the synthetic route of IL [EMmim⁺][NTF₂⁻];

FIG. 7 illustrates a molecular structure of commercially available IL catalysts [Emim⁺][HSO₄⁻] and [Bmim⁺][PF₆⁻];

FIG. 8 illustrates ¹H NMR spectrum of [EMmim⁺][NTF₂⁻];

FIG. 9 illustrates ¹³C NMR spectrum of [EMmim⁺][NTF₂⁻];

FIG. 10 illustrates FT-IR spectrum of [EMmim⁺][NTF₂⁻];

FIG. 11A illustrates an ESI-MS spectrum of [EMmim⁺][NTF₂⁻];

FIG. 11B illustrates another ESI-MS spectrum of [EMmim⁺][NTF₂⁻];

FIG. 12A provides a diagram of CO₂ desorption setup (1: N₂ cylinder; 2: Mixed gas (CO₂, N₂ and O₂) cylinder; 3: mass flow controller; 4: thermostatic water bath; 5: data recording unit; 6: stirred tank reactor; 7: condenser; 8: desiccator; 9: mass spectrometer; 10: data analyzing computer);

FIG. 12B is another schematic representation of a CO₂ absorption and desorption experimental setup in accordance with an exemplary aspect of the present disclosure;

FIG. 13A provides graphs illustrating the effect of IL catalyst types ([EMmim⁺][NTF₂⁻], [Bmim⁺][PF₆⁻] and [Emim⁺][HSO₄⁻]) on catalytic CO₂ desorption (des.) performance;

FIG. 13B provides graphs illustrating the effect of IL catalyst types ([EMmim⁺][NTF₂⁻], [Bmim⁺][PF₆⁻] and [Emim⁺][HSO₄⁻]) on catalytic CO₂ absorption performance;

FIG. 14A provides a graph of CO₂ absorption curves of 20 wt % MEA solution illustrating the effect of [EMmim⁺][NTF₂⁻] catalyst dosage on catalytic CO₂ absorption performance;

FIG. 14B provides a graph of CO₂ desorption rate of rich 20 wt % MEA solution illustrating the effect of [EMmim⁺][NTF₂⁻] catalyst dosage on catalytic CO₂ desorption (des.) performance;

FIG. 14C is a plot illustrating the catalytic effects of [EMmim][NTf₂] dosage on the CO₂ absorption performances;

FIG. 14D is a plot illustrating the catalytic effects of [EMmim][NTf₂] dosage on the CO₂ desorption (des.) performances;

FIG. 14E is another plot illustrating the catalytic effects of [EMmim][NTf₂] dosage on the CO₂ desorption (des.) performances;

FIG. 15A provides a graph of CO₂ absorption curves of 20 wt % MEA solution illustrating the effect of [EMmim⁺][NTF₂⁻] catalyst dosage and ultrasonic treatment on catalytic CO₂ absorption performance. (a) CO₂ absorption curves of 20 wt % MEA solution. (b) CO₂ desorption rate of rich 20 wt % MEA solution;

FIG. 15B provides a graph of CO₂ desorption rate of rich 20 wt % MEA solution illustrating the effect of [EMmim⁺][NTF₂⁻] catalyst dosage and ultrasonic treatment on catalytic CO₂ desorption (des.) performance;

FIG. 15C is a plot illustrating the catalytic effects of [EMmim][NTf₂] on CO₂ absorption in accordance with an exemplary aspect of the present disclosure;

FIG. 15D is a plot illustrating the catalytic effects of [EMmim][NTf₂] on CO₂ desorption in accordance with an exemplary aspect of the present disclosure;

FIG. 15E is another plot illustrating the catalytic effects of [EMmim][NTf₂] on CO₂ desorption in accordance with an exemplary aspect of the present disclosure;

FIG. 15F is yet another plot illustrating the catalytic effects of [EMmim][NTf₂] on CO₂ desorption in accordance with an exemplary aspect of the present disclosure;

FIG. 15G is a plot illustrating CO₂ absorption curves with and without catalyst when the absorption processes were terminated within 7000 seconds with the same outlet CO₂ concentrations (3.2 vol %);

FIG. 15H is a plot illustrating CO₂ desorption curves with and without catalyst when the absorption processes were terminated within 7000 seconds with the same outlet CO₂ concentrations (3.2 vol %);

FIG. 15I is a plot illustrating CO₂ desorption curves with and without catalyst when the absorption processes were terminated within 7000 seconds with the same outlet CO₂ concentrations (3.2 vol %);

FIG. 16A provides a graph of CO₂ absorption curves of 20 wt % MEA solution illustrating the effect of ultrasonic treatment on catalytic CO₂ absorption performance;

FIG. 16B provides a graph of CO₂ desorption rate of rich 20 wt % MEA solution illustrating the effect of ultrasonic treatment on catalytic CO₂ desorption (des.) performance;

FIG. 16C provides another graph of CO₂ desorption rate of rich 20 wt % MEA solution illustrating the effect of ultrasonic treatment on catalytic CO₂ desorption (des.) performance;

FIG. 17A provides a graph illustrating the amount of absorbed and desorbed CO₂ from MEA solution with US−[EMmim⁺][NTF₂⁻] catalyst during cycle tests;

FIG. 17B provides another graph illustrating the amount of absorbed and desorbed CO₂ from MEA solution with US−[EMmim⁺][NTF₂⁻] catalyst during cycle tests;

FIG. 17C provides another graph illustrating the amount of absorbed and desorbed CO₂ from MEA solution with US−[EMmim⁺][NTF₂⁻] catalyst during cycle tests;

FIG. 17D provides a graph illustrating the amount of absorbed and desorbed CO₂ from MEA solution with US−[EMmim⁺][NTF₂⁻] catalyst during cycle tests;

FIG. 17E provides a graph illustrating the amount of absorbed and desorbed CO₂ from MEA solution with US−[EMmim⁺][NTF₂⁻] catalyst during cycle tests;

FIG. 17F provides a graph illustrating the amount of absorbed and desorbed CO₂ from MEA solution with US−[EMmim⁺][NTF₂⁻] catalyst during cycle tests;

FIG. 17G is a plot illustrating an evaluation of stability of [EMmim][NTf₂] as a catalyst for MEA based CO₂ capture;

FIG. 17H is another plot illustrating an evaluation of stability of [EMmim][NTf₂] as a catalyst for MEA based CO₂ capture;

FIG. 18A illustrates exemplary FT-IR and Raman spectra of MEA solution with US−[EMmim⁺][NTF₂⁻] catalyst after cycle tests;

FIG. 18B illustrates another exemplary FT-IR and Raman spectra of MEA solution with US−[EMmim⁺][NTF₂⁻] catalyst after cycle tests;

FIG. 18C illustrates exemplary FT-IR and Raman spectra of MEA solution with US−[EMmim⁺][NTF₂⁻] catalyst after cycle tests;

FIG. 19 illustrates the TGA curve of [EMmim⁺][NTF₂⁻];

FIG. 20 illustrates the principle of the activation and formation of amide-bond compound;

FIG. 21A illustrates FT-IR spectra of [EMmim⁺][NTF₂⁻];

FIG. 21B illustrates another FT-IR spectra of [EMmim⁺][NTF₂⁻];

FIG. 21C illustrates another FT-IR spectra of [EMmim⁺][NTF₂⁻];

FIG. 22 illustrates the [EMmim⁺][NTF₂⁻] catalyst ultrasonic activation process in accordance with the present disclosure;

FIG. 23 illustrates the UV-Vis Absorption spectra of 4-nitroaniline for [EMmim⁺][NTF₂⁻] IL in water with different concentrations and pretreated conditions;

FIG. 24 provides graphs illustrating the optimized geometries associated with transformation between different MEA configurations;

FIG. 25A provides a graph illustrating the relative energy comparison between our calculation and disclosure's results in CO₂ absorption process in MEA solution followed by ZW mechanism;

FIG. 25B provides a graph illustrating the relative energy comparison between our calculation and disclosure's results in CO₂ absorption process in MEA solution followed by bicarbonate mechanism;

FIGS. 26A-C provide pictorial representations of the relative energy comparison among P2-R1 to P2-R3 with and without mim⁺COOH;

FIG. 27A provides graphs illustrating the Catalysis ability comparison of MEA-cat Complex with mimCOO⁻;

FIG. 27B provides graphs illustrating the reaction energy profile for the possible catalyzed pathways for MEA-CO₂ and H₂O-MEA-CO₂;

FIG. 27C is a pictorial representation of catalysis ability comparisons between MEA-cat Complex and [mimCH₂COO⁻]⁺ in accordance with an exemplary aspect of the present disclosure;

FIG. 27D is another pictorial representation of catalysis ability comparisons between MEA-cat Complex and [mimCH₂COO⁻]⁺ in accordance with an exemplary aspect of the present disclosure;

FIG. 28A provides a pictorial representation of the Brønsted basicity comparison of mim⁺COO⁻, NTF₂⁻, H₂O and MEA, where the pictorial representation is the optimized geometries associated with the proton transfer reaction of ZW with mim⁺COO⁻, NTF₂⁻, H₂O and MEA, and plot (b) is the reaction energy profile for proton transfer reaction of ZW with mim⁺COO⁻, NTF₂⁻, H₂O and MEA;

FIG. 28B provides a graph illustrating the Brønsted basicity comparison of mim⁺COO⁻, NTF₂⁻, H₂O and MEA, where the plot is the reaction energy profile for proton transfer reaction of ZW with mim⁺COO⁻, NTF₂⁻, H₂O and MEA;

FIGS. 29A-H provide graphs illustrating all the configurations, including reactants, intermediate, such as complexes, transition states and products listed in the Figures;

FIG. 30 is a pictorial representation of FT-IR spectrum of [EMmim][NTf₂], collecting with a Thermo Nicolet Magna-IR 760 spectrometer with a resolution of 4 cm⁻¹ by scanning 32 times from 4000 to 400 cm⁻¹;

FIG. 31 is a plot illustrating a comparison of FT-IR spectra of 20 wt % MEA solution with [EMmim][NTf₂] catalyst after first run and 50 cyclic tests in accordance with an exemplary aspect of the present disclosure;

FIG. 32A is a pictorial and plot illustrations of the [EMmim][NTf₂] catalyst activation process via hydrolysis in CO₂ absorbing system;

FIG. 32B(1)-(4) are schematic representations of the [EMmim][NTf₂] catalyst and the hydrolysis activation process in accordance with an exemplary aspect of the present disclosure;

FIG. 33A is a plot illustrating changes of the quantities of CO₂ absorbed and desorbed, and pH values of the uncatalytic and catalytic solutions with absorption times in accordance with an exemplary aspect of the present disclosure; and

FIG. 33B is a plot illustrating changes of the quantities of CO₂ absorbed and desorbed, and pH values of the uncatalytic and catalytic solutions with desorption times in accordance with an exemplary aspect of the present disclosure.

### BRIEF DESCRIPTION OF THE TABLES

Illustrated embodiments of the disclosure are described in detail below with reference to the attached Tables, which are incorporated by reference herein, and where:

Table 1 provides tabulated pH values of aqueous IL solution and MEA solution;

Table 2 provides Hammett functions of [EMmim⁺][NTF₂⁻] IL in water with different concentrations and pretreated conditions; and

Table 3 provides pH values of Aqueous IL Solution and MEA Solution.

### DETAILED DESCRIPTION

### 1. Introduction

Carbon dioxide (CO₂) has been determined as a primary greenhouse gas that makes a great contribution to global warming, owing to the excessive emissions from the combustion of fossil fuels. Carbon capture, utilization, and storage (CCUS) is the mature technology that can be carried out to alleviate the CO₂ discharge, which has been urgently needed for achieving the goals set in the Paris Climate Accord. CO₂ capture is critical not only because of its close connection with climate change according to Paris Climate Accord but also because of its increasing importance as a resource for material and fuel synthesis. Thus, CO₂ capture is very important. Chemisorption is one of the most important methods for CO₂ capture. The fundamental challenge of chemisorption-based technologies is the slow absorption and desorption reaction kinetics, especially the latter one, which leads to the need for CO₂ desorption at >100° C. Consequently, excessive energies are needed to vaporize a large amount of liquid water during CO₂ desorption operation and condense the same amount of water vapor prior to CO₂ desorption during cyclic CO₂ sorption and desorption. Also, severe corrosion and sorbent degradations that could result in secondary environmental and health issues, especially when organic amines are used as sorbents.

Amine-based CO₂ absorption can be one of the potentially cost-effective options for capturing CO₂ from both gas streams (e.g., flue gas) and atmosphere. It has relatively low price and high reactivity with CO₂, monoethanolamine (MEA) solution can be considered the benchmark solvent for evaluating amine-based CO₂ capture processes at small scale. However, this technology can still not be acceptable for versatile and large-scale uses mainly, attributed to (1) the critical limitations for >100° C. CO₂ desorption or very energy intensive MEA regeneration process, and (2) the resultant aggregated MEA degradation, as well as (3) severe corrosion at such high temperatures. For rendering fast CO₂ desorption from aqueous solvent, high temperature (120-140° C.) must be required for the current state-of-the-art, resulting in excessive energy demands for the water vaporization.

A key question is whether it can be possible to overcome the three challenges by desorbing CO₂ or regenerating spent MEA at temperatures less than 100° C., which can be the pivotal to reduce the heat duty while still achieving a desired CO₂ desorption rate. Heterogeneous catalysis has been considered to be a promising solution because it can not only simultaneously overcome the above-mentioned challenges, due to its function in accelerating energy-intensive CO₂ desorption at low temperatures, but it can also significantly lower the energy quantity and quality required for CO₂ capture. Fan et al. reported that the use of nanostructured TiO(OH)₂ to catalyze MEA-based CO₂ capture could drastically increase the rate of CO₂ desorption from spent MEA solution by over 4,000% at 88° C. with 2% or 20,000 ppm TiO(OH)₂. Furthermore, the TiO(OH)₂ catalyzed-MEA CO₂ capture system showed excellent stability, even with 50 cyclic CO₂ absorption-desorption tests. However, to date, homogeneous catalysis with no potential diffusional limitations has not been utilized for the CO₂ capture technologies.

Ionic liquids (ILs), consisting of organic cations and organic or inorganic anions, are environmentally friendly due to their various desired characteristics, including high chemical/thermal stability, tunable physicochemical characters (acid/base sites), low corrosiveness and low heat capacity, which can be highly desirable for CO₂ capture systems. To date, there can be no study reported in the disclosure on the use of ILs as the catalyst for the CO₂ capture process despite the fact that high solubility of CO₂ can be reported in some IL. After a long time of study, a homogeneous CO₂ capture catalyst—a new ionic liquid (IL), [CH₃COOCH₂mim][NTf₂] denoted as [EMmim][NTf₂] was discovered. The IL, used as a CO₂ capture catalyst instead of a sorbent, is not only very effective for catalyzing CO₂ desorption but also CO₂ sorption. It should be emphasized that [EMmim][NTf₂] is used as a transformative catalyst instead of a sorbent for CO₂ capture in this work. In addition, ultrasonic chemistry can be an important modern method for modifying materials. The transitory collapse of cavitation microbubbles formed during the ultrasound wave traveling process can result in high temperature, high pressure, enhanced mass transfer and shear forces in the microenvironment. It has been used for significant acceleration of chemical changes. Also, it can be utilized in modifying catalysts for improving their catalytic performance. Thus, the research can be designed to integrate ultrasonic treatment into the catalysis performance improvement of [EMmim⁺][NTF₂⁻] for development of a new generation of CO₂ capture catalysts.

A method is disclosed for chemisorption based capture CO₂ technologies. The method comprises providing a catalyst and a monoethanolamine (MEA); treating the catalyst with ultrasonically treated ionic liquid (IL); and capturing CO₂ from the catalyst with the MEA.

In another exemplary aspect of the present disclosure, a method is disclosed for chemisorption based capture CO₂ technologies. The method comprises providing a catalyst selected from the group of [EMmim⁺][NTF₂⁻] based catalysts and a CO₂ loaded monoethanolamine (MEA) solution; treating the MEA with an ionic liquid (IL) for providing a IL [EMmim⁺][NTF₂⁻] based catalyst; and absorbing and desorbing CO₂ with IL catalyst.

In yet another aspect of the present disclosure, another method for both CO₂ sorption and desorption of chemisorption-based technologies is disclosed. The method comprises providing an aqueous solution of monoethanolamine (MEA); providing CO₂ through a gas inlet; and absorbing and desorbing CO₂ without the presence of water.

### 2. Effect of Designed Homogeneous IL Catalyst

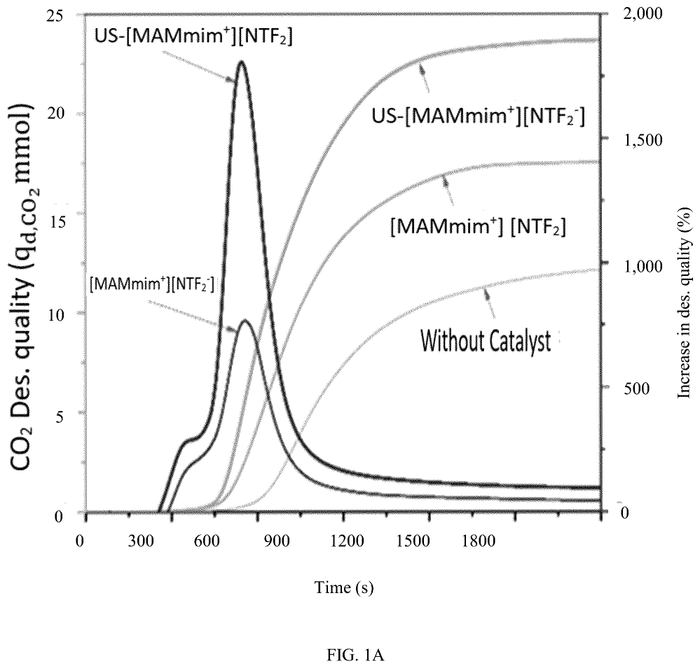

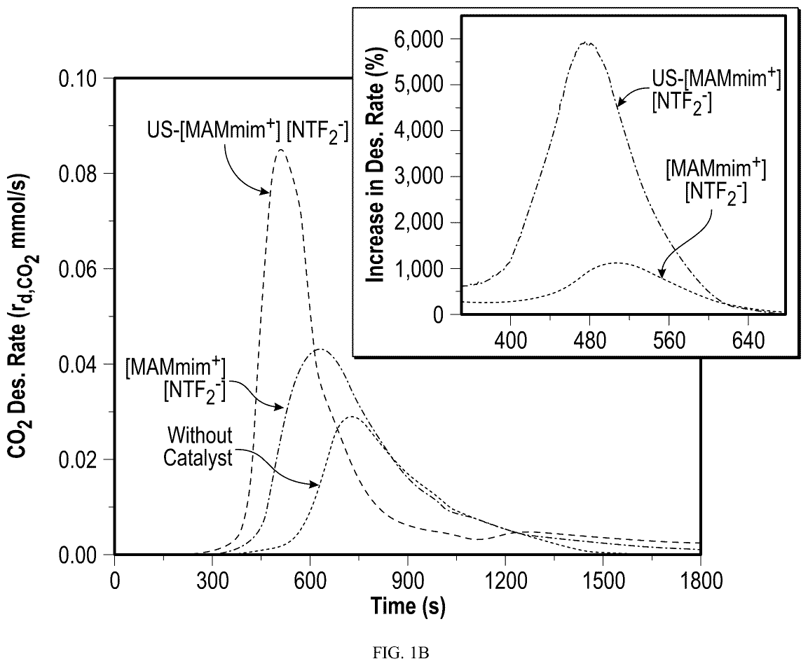

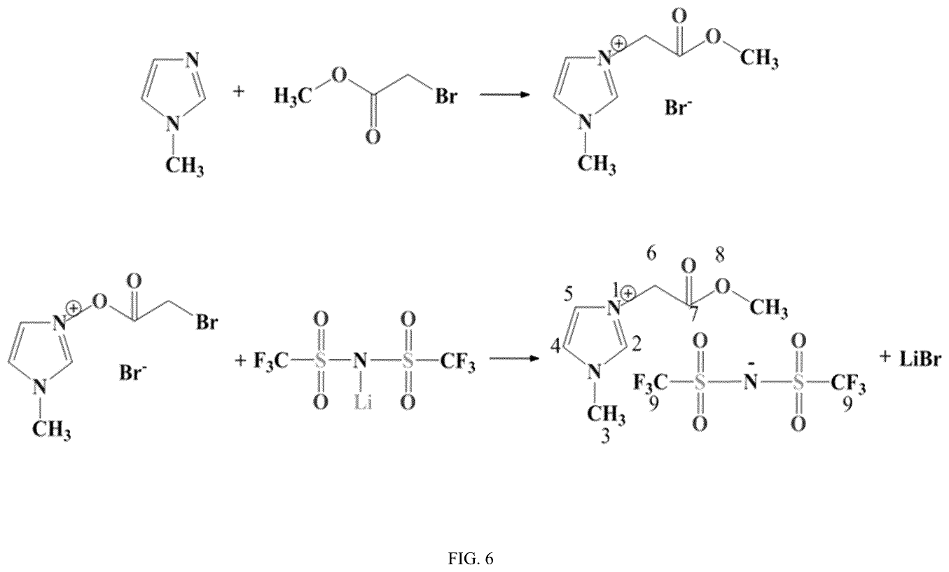

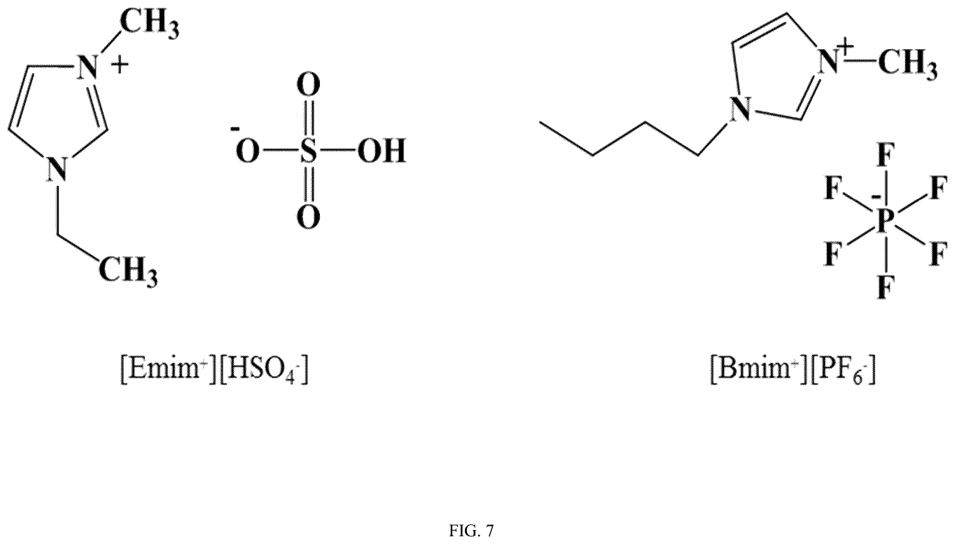

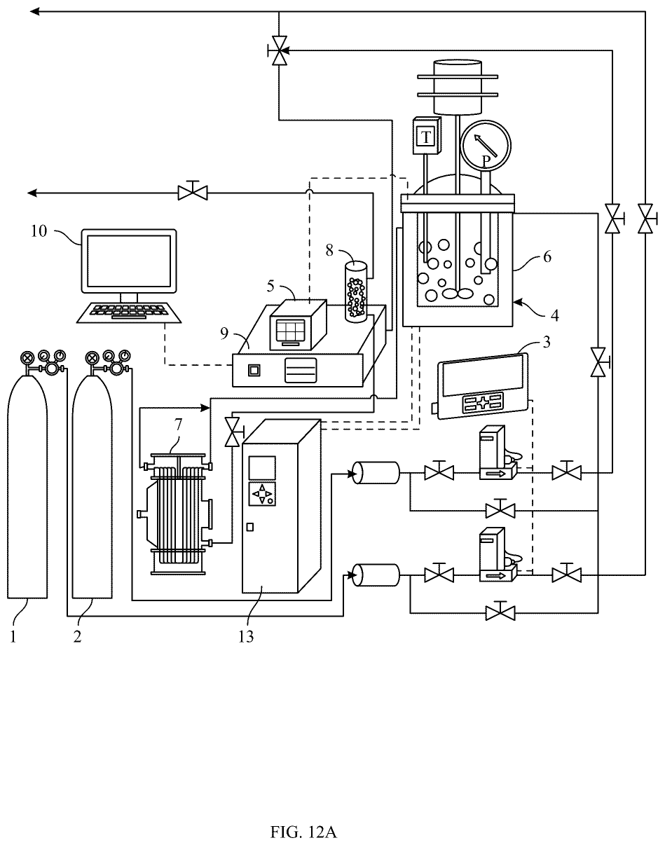

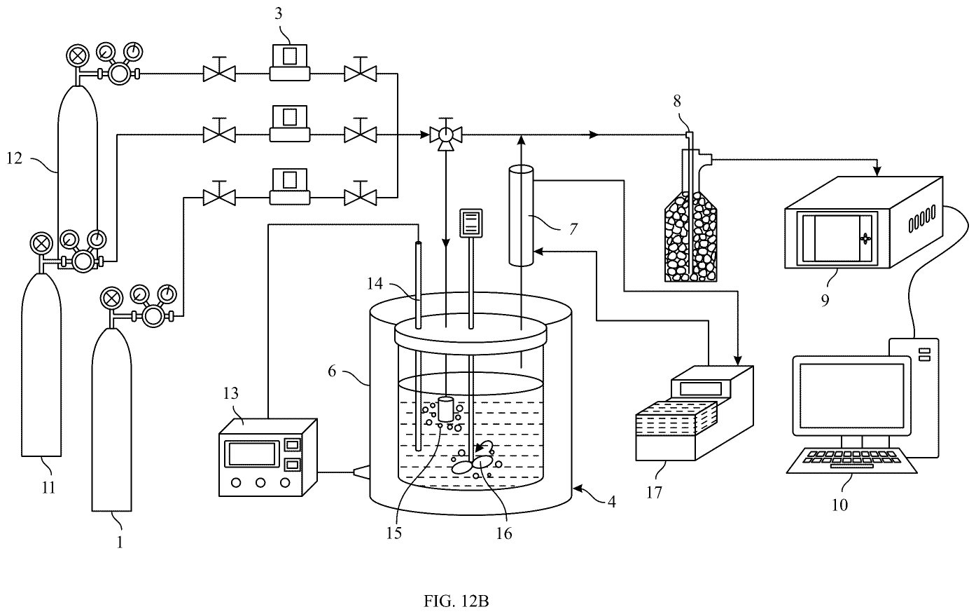

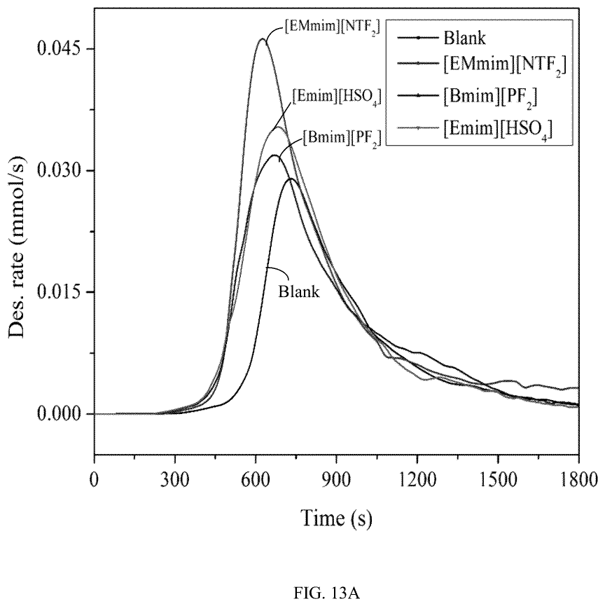

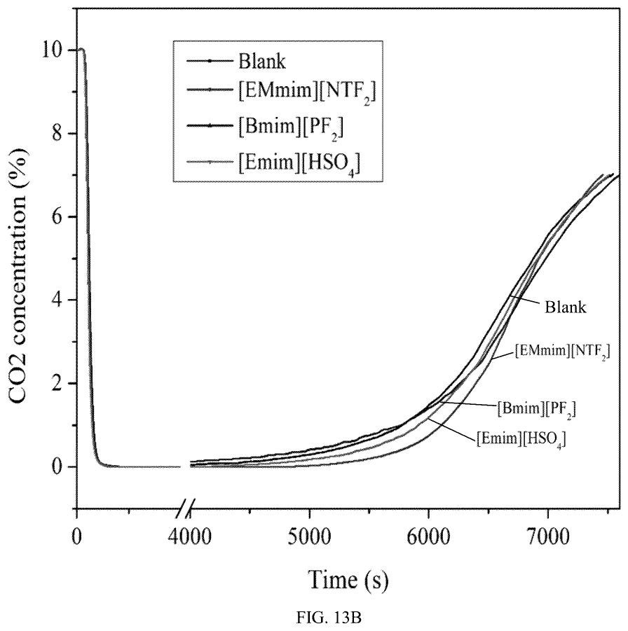

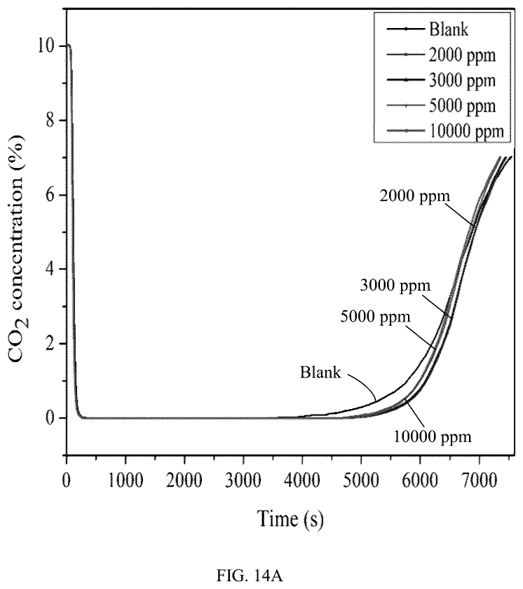

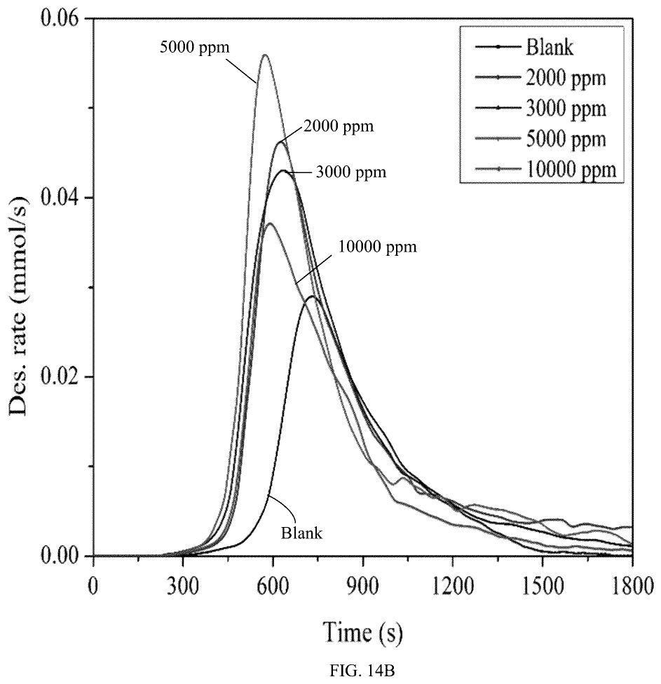

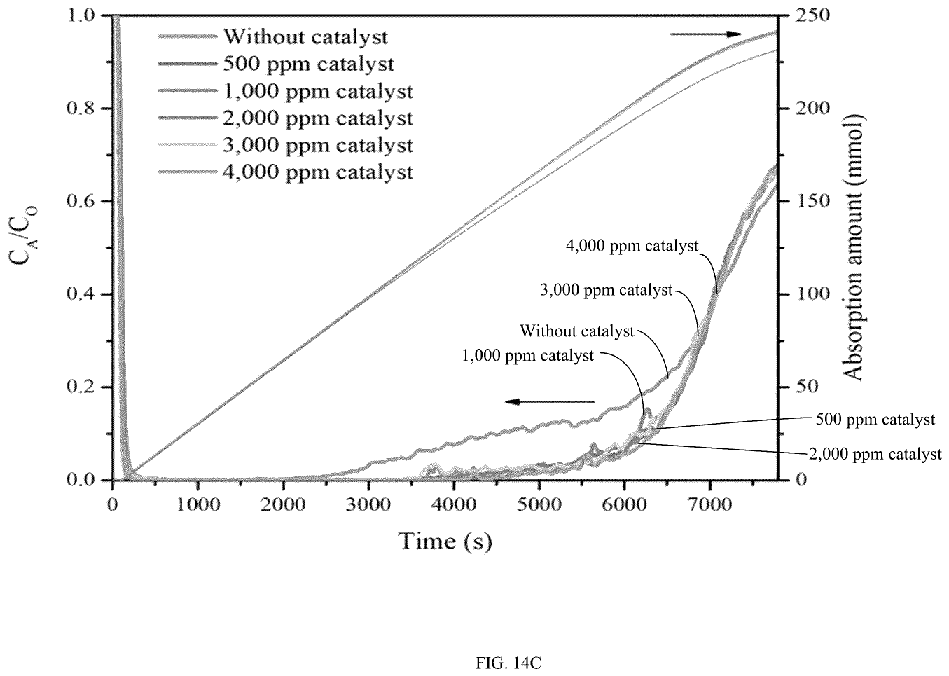

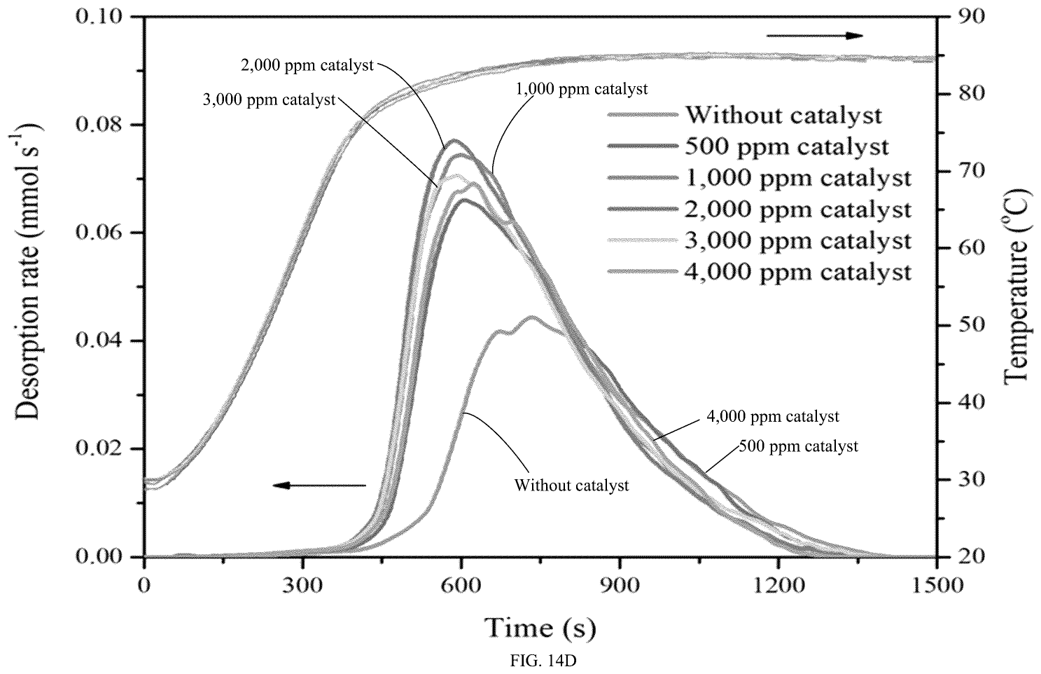

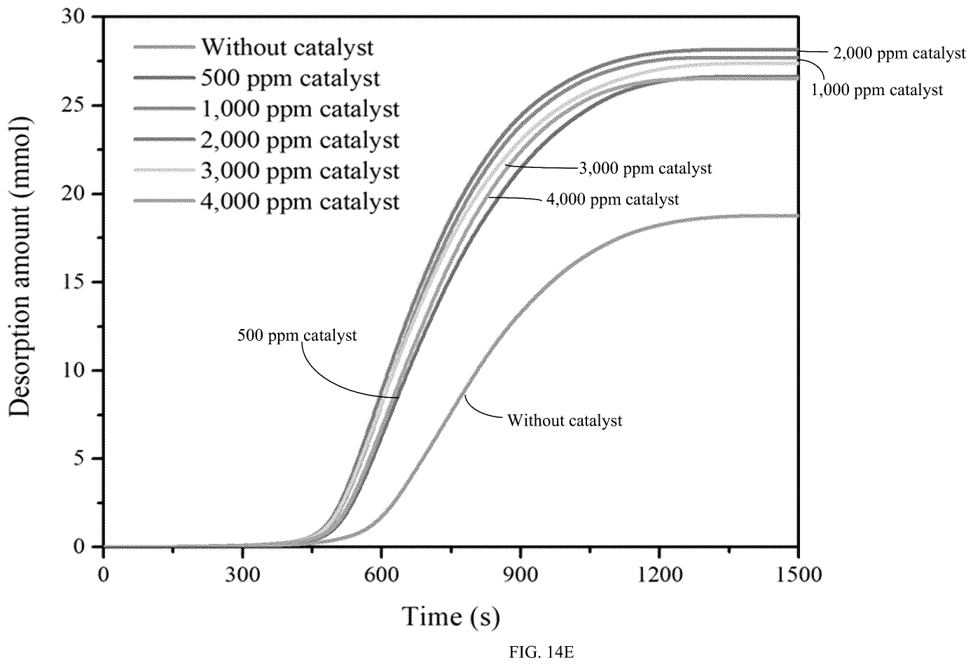

FIGS. 1A and 1B display the CO₂ desorption performances of 20 wt % MEA solution catalyzed by [CH₂COOCH₃mim⁺][NTF₂⁻] or [EMmim⁺][NTF₂⁻] with and without ultrasonic pre-treatment. For example, as shown in FIG. 1A, the effect of catalysts on the CO₂ desorption rate (q_{d, CO}_{₂}) and as shown for example in FIG. 1B the effect of catalysts on the quantity of desorbed CO₂ (r_{d, CO}_{₂}). Desorption conditions: 100 g of 20 wt % spent MEA solutions without and with catalysts contain the same amounts of CO2; catalyst concentrations: 2,000 ppm; flow rate of carrier gas N2: 500 mL/min; temperature: 30-85° C.; time: 1800 s. It should be noted that the methods for synthesizing [EMmim⁺][NTF₂⁻] and the results of [EMmim⁺][NTF₂⁻] characterization are provided in the FIGS. 6, and 8-11B. The catalytic CO₂ capture setup can be shown in FIGS. 12A and 12B. Two commercial IL catalysts [Emim⁺][HSO₄⁻] and [Bmim⁺][PF₆⁻] (FIGS. 7A and 7B) were also obtained and compared for the CO₂ desorption process. For example, as shown in FIG. 7A, [Emim⁺][HSO₄⁻] and as shown in FIG. 7B, [Bmim⁺][PF₆⁻]. [Emim⁺][HSO₄⁻] (Purity >98.0%; CAS No.: 412009-61-1; MDL Number MFCD06798195) can be purchased from Tokyo Chemical Industry Co., Ltd. (TCI). [Bmim⁺][PF₆⁻] (Purity >97.0% (HPLC); CAS No. 174501-64-5; MDL number MFCD03093295) can be obtained from Sigma-Aldrich, Inc. According to FIG. 14D, [EMmim⁺][NTF₂⁻] can not only significantly move the initial CO₂ desorption point to earlier times, but can also increase the rates of CO₂ desorption (r_{d, CO}_{₂}) from the spent MEA solutions. The FIGS. 14A-16C show the favorable catalytic effects of the [EMmim⁺][NTF₂⁻] on the CO₂ absorption process. Notice that the catalytic CO₂ desorption performance of the EMmim⁺][NTF₂⁻] gives much better performance than that without the ultrasonic pre-treatment and are significantly superior to the two commercial IL catalysts (as shown in FIGS. 13A and 13B), where, for example, the CO₂ absorption curves of 20 wt % MEA solution are shown in FIG. 13B. The CO₂ desorption rate of rich 20 wt % MEA solution, for example are shown in FIG. 13A. The catalyst dosage can be 3,000 ppm equivalently containing 10.1 ppm of —COOH. Note that the three ILs catalysts could enhance the CO₂ desorption performance when compared to the blank run. While the catalytic CO₂ desorption performance of the synthesized IL catalyst [EMmim⁺][NTF₂⁻] can be better than that of the two commercial IL catalysts. Thus, the FIGS. 14A-16C clearly show that the ultrasonic pre-treatment can significantly promote the catalytic function of [EMmim⁺][NTF₂⁻]. It has been found that the dosage of 3,000 ppm [EMmim⁺][NTF₂⁻] can rapidly hydrolyse the IL to give equivalently 10.1 ppm of fully disassociated —COOH moiety within 20 min using an ultrasonic power of 9 w.

The maximum rate r_{d, CO}_{₂} or r_{m, d, CO}_{₂} achieved with and without using [EMmim⁺][NTF₂⁻] and US−[EMmim⁺][NTF₂⁻], as well as the corresponding desorption times, are shown in FIGS. 1A-1B. The relative rate r_{d, CO}_{₂} improvements obtained with [EMmim⁺][NTF₂⁻] and US−[EMmim⁺][NTF₂⁻] presented in FIG. 1B can reach as high as 1,140 and 6,000% respectively, while the corresponding absolute rate r_{d, CO}_{₂} improvements shown in FIG. 1B are 149% and 293%, respectively. Also, the times needed for reaching the rate maximum r_{m, d, CO}_{₂} with [EMmim⁺][NTF₂⁻] and US−[EMmim⁺][NTF₂⁻] are shortened by 116 and 222 s, respectively, as shown, in comparison to the time required for CO₂ desorption without the use of the organocatalyst.

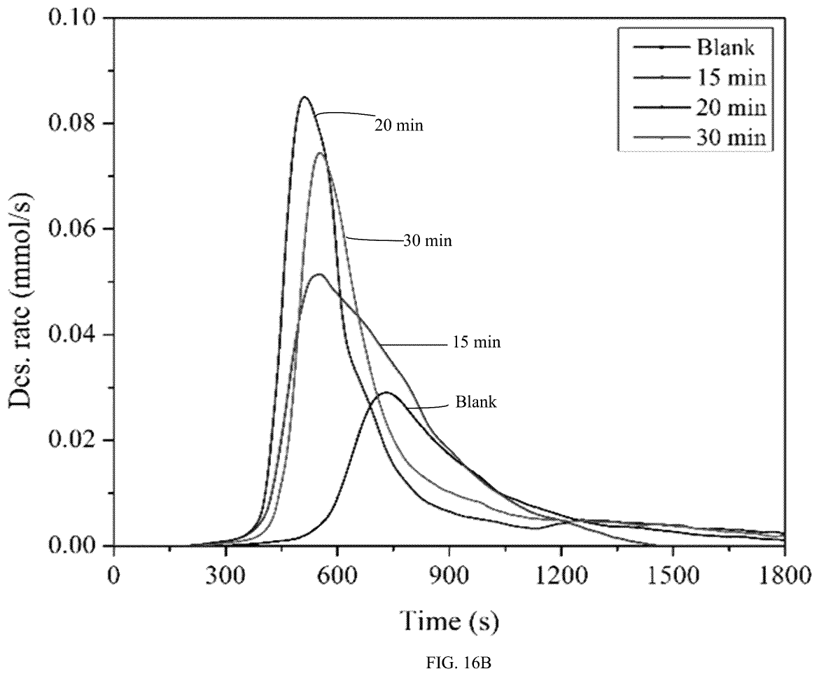

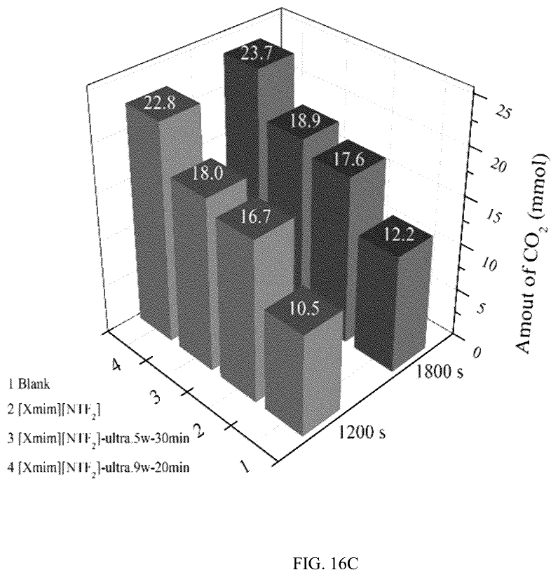

As shown in FIG. 1A, there can be only 12.2 mmol quantity of desorption of CO₂ q_{d, CO}_{₂} for the blank run, and the significant improvement of the q_{d, CO}_{₂} can be 95% (23.7 mmol) when US−[EMmim⁺][NTF₂⁻] can be introduced. When the desorption time can be shortened to 1,200 s, the use of US[EMmim⁺][NTF₂⁻] can increase the q_{d, CO}_{₂} by about 120% (as shown FIGS. 16A-16C). It can be seen from FIG. 1A that the presence of [EMmim⁺][NTF₂⁻] and US−[EMmim⁺][NTF₂⁻] can increase q_{d, CO}_{₂} as high as 766% higher at ˜554 s and 1,807% larger at ˜544 s, respectively. US−[EMmim⁺][NTF₂⁻] not only has a much lower dosage (6.7 times lower) but also has a higher catalytic CO₂ desorption rate (1.33 times higher) than that of the reported TiO(OH)₂ catalyst¹. Also, as a homogeneous catalyst, US−[EMmim⁺][NTF₂⁻] can be used directly in existing CO₂ capture plants without the need for modifying the existing CO₂ desorption facility in an industrial application. Therefore, the experimental results demonstrate that [EMmim⁺][NTF₂⁻] can be effective and US−[EMmim⁺][NTF₂⁻] can be even much more effective, for catalyzing the CO₂ desorption.

The optimal dosage of this catalyst for accelerating CO₂ desorption, the key step for reducing overall CO₂ capture energy consumption, is 2,000 ppm according to FIGS. 14C-14E, which illustrate the CO₂ absorption profiles of 20 wt % MEA sorbent in FIG. 14C, the CO₂ desorption rates of 20 wt % MEA sorbent in FIG. 14D, and the total CO₂ desorption amounts in FIG. 14E.

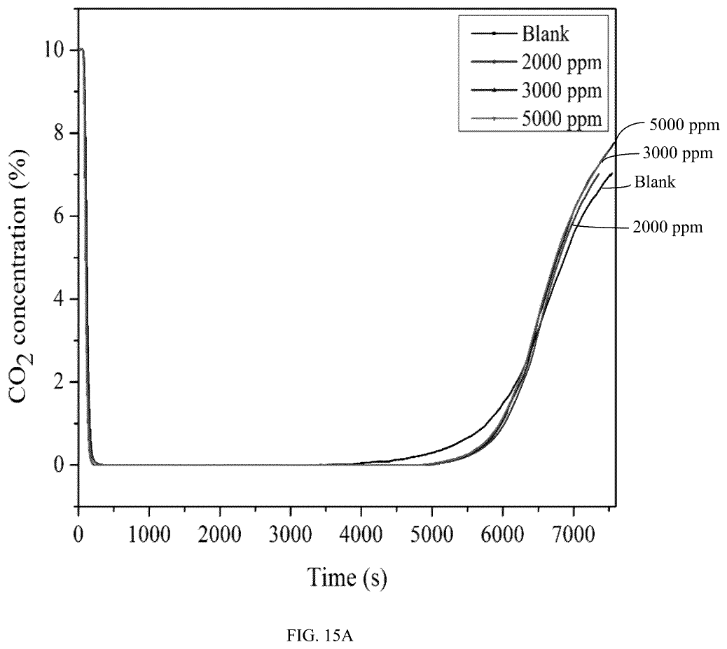

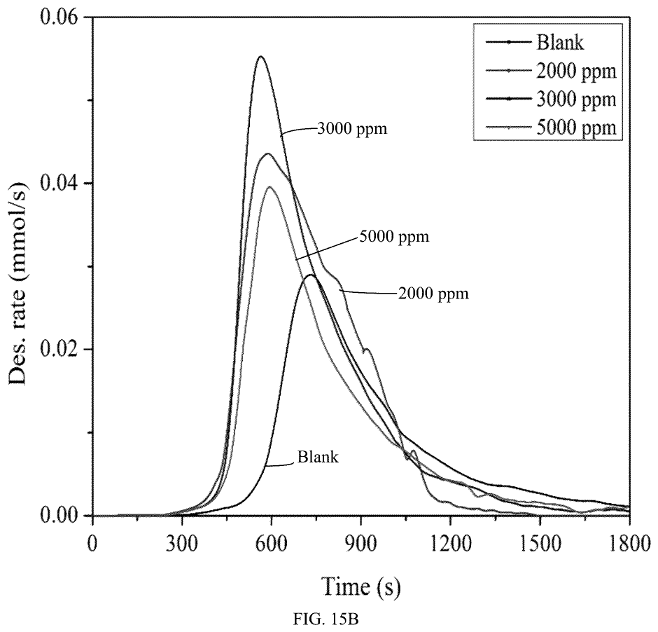

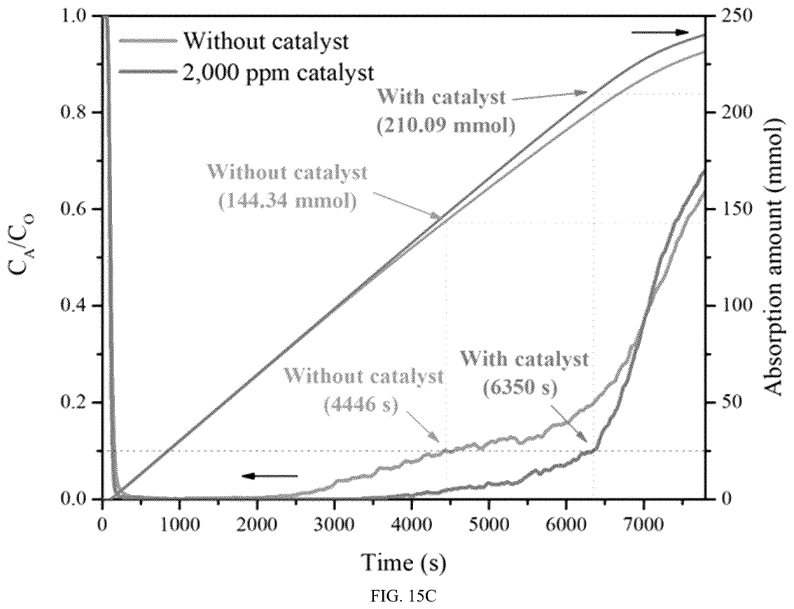

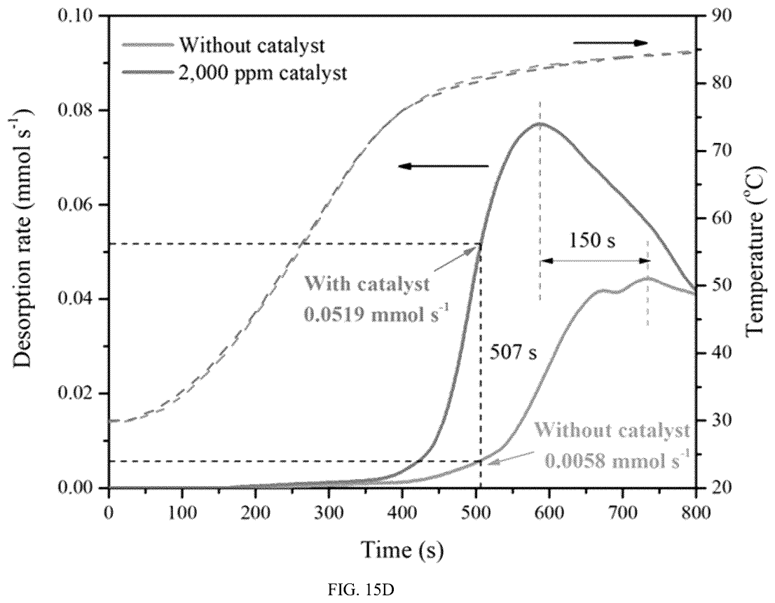

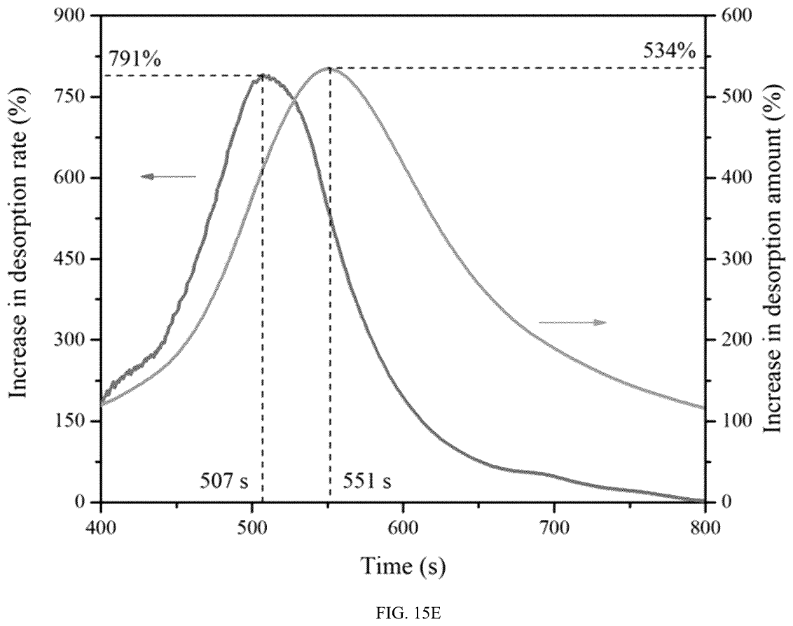

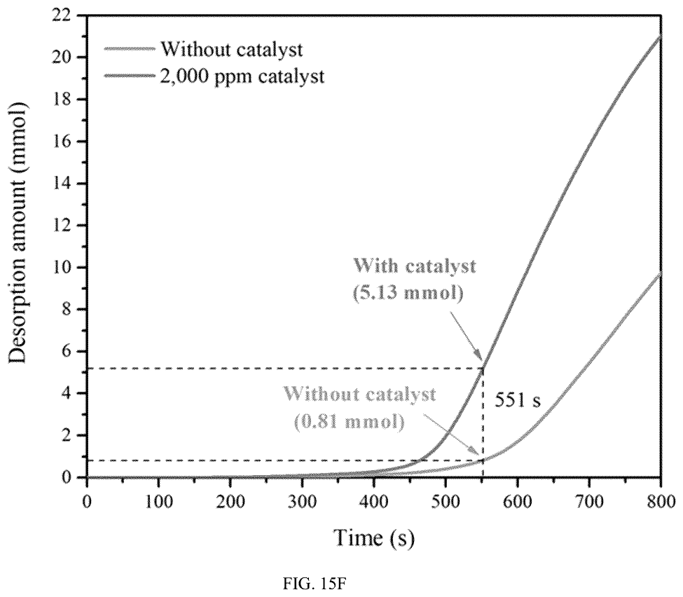

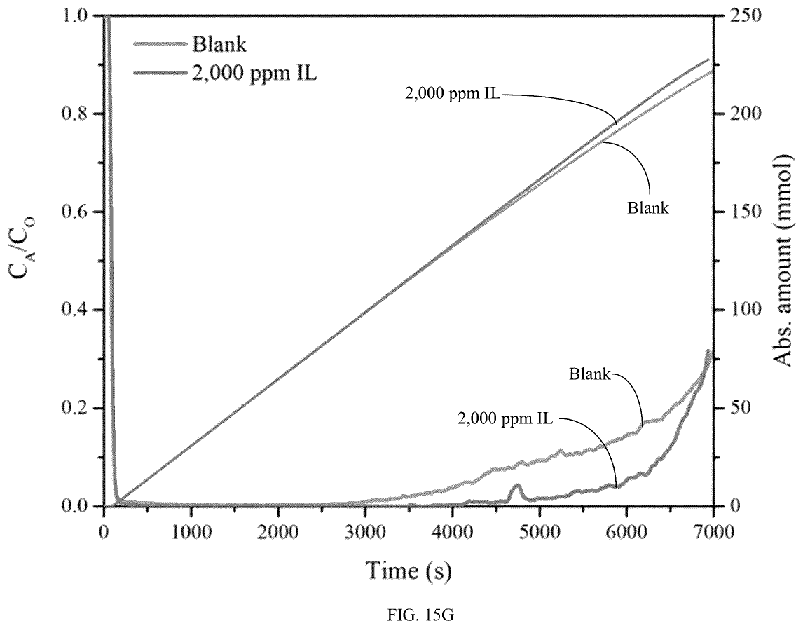

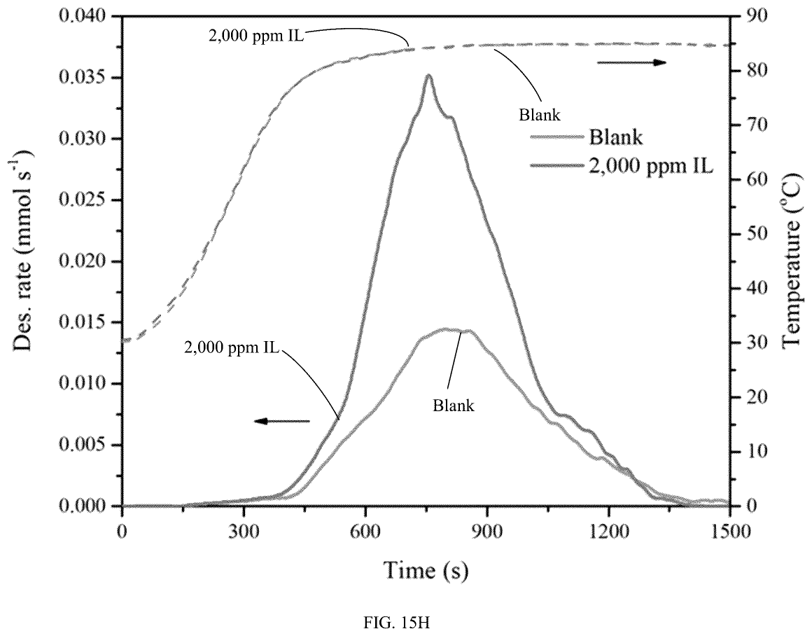

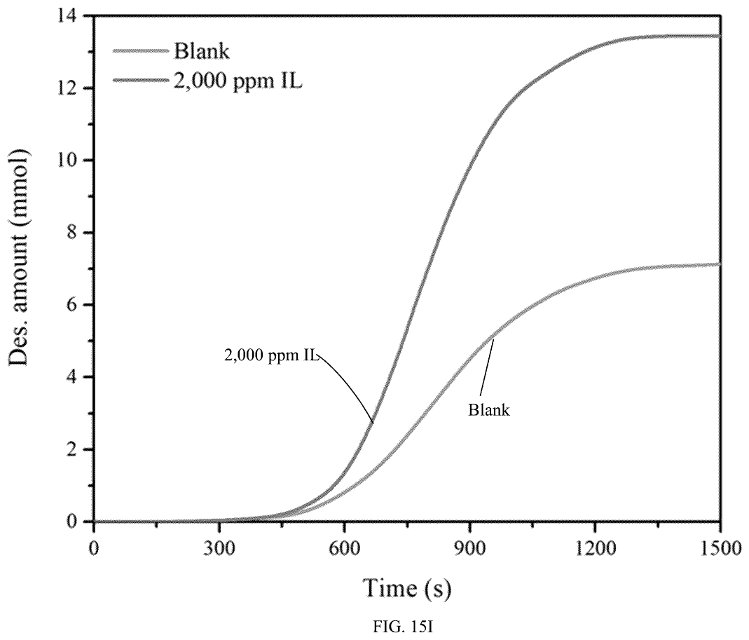

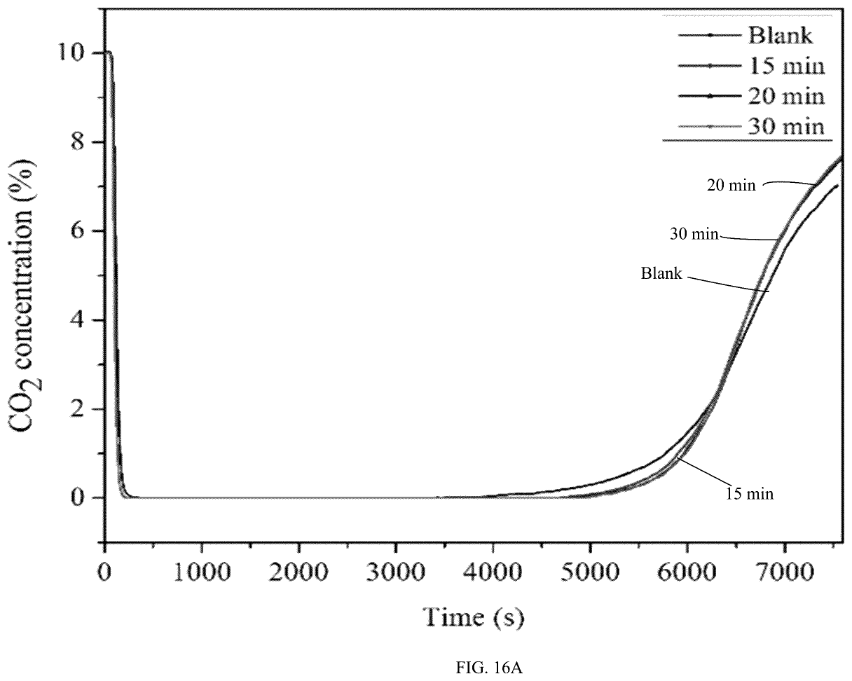

FIGS. 15C-15F exhibit the CO₂ absorption and desorption performances of 20 wt % MEA solution catalyzed by 2,000 ppm [EMmim][NTf₂]. The IL [EMmin][NTf₂] can promote both CO₂ absorption and desorption. Capturing 90% CO₂ is targeted by the U.S. Department of Energy, and thus the period with 90% CO₂ capture efficiency is defined as effective absorption time. According to FIG. 15C, 20 wt % MEA sorbent without catalyst can absorb only 144.34 mmol CO₂ within the shorter effective absorption time of 4,446 s, while the sorbent with 2,000 ppm IL catalyst can absorb 210.09 mmol CO₂, and extend effective absorption time to 6,350 s, which are 45.55% and 42.83% absorption improvements, respectively, compared to the sorbent without catalyst.

Variations of desorption with time with and without uses of catalyst are illustrated in FIG. 15D. The time needed for reaching the maximum desorption rate with the use of [EMmim][NTf₂] is shortened by 150 s in comparison to the time required for CO₂ desorption without the use of the IL catalyst. Meanwhile, the peak desorption rate improvement is 175%. The increases in desorption rate and the desorbed CO₂ amount obtained with [EMmim][NTf₂] can reach as high as 791% at 507 s and 534% at 551 s (see FIG. 15D, FIG. 15E, and FIG. 15F), respectively. The quantities of CO₂ desorbed from uncatalytic and catalytic solutions are 18.7 and 28.2 mmol, respectively. When the absorption time is 7,000 s or the outlet CO₂ concentrations of both uncatalyzed and catalyzed CO₂ absorption are 3.2 vol % (FIGS. 15G-15I), use of [EMmim][NTf₂] can increase the total desorbed CO₂ amount by 88.90%. Where, specifically, in accordance with aspects of the present disclosure, FIG. 15G discloses the CO₂ absorption profiles of 20 wt % MEA sorbent. Where, specifically, in accordance with aspects of the present disclosure, FIG. 15H shows, by example, the CO₂ desorption rates of 20 wt % MEA sorbent. And, where, specifically, in accordance with aspects of the present disclosure FIG. 15I shows, for example, the total CO₂ desorption amounts. It should be noted that dosage of [EMmim][NTf₂] is only 2,000 ppm—the lowest dosage for achieving such significant CO₂ capture catalysis effect. To the best knowledge, such a low catalyst dosage has not been reported for achieving such a significant CO₂ capture. Also, as a homogeneous catalyst, [EMmim][NTf₂] is easy to use. Therefore, [EMmim][NTf₂] is quite effective for catalyzing both the CO₂ absorption and desorption processes.

### 3.0 Stabilities of the Catalytic Co₂ Capture System

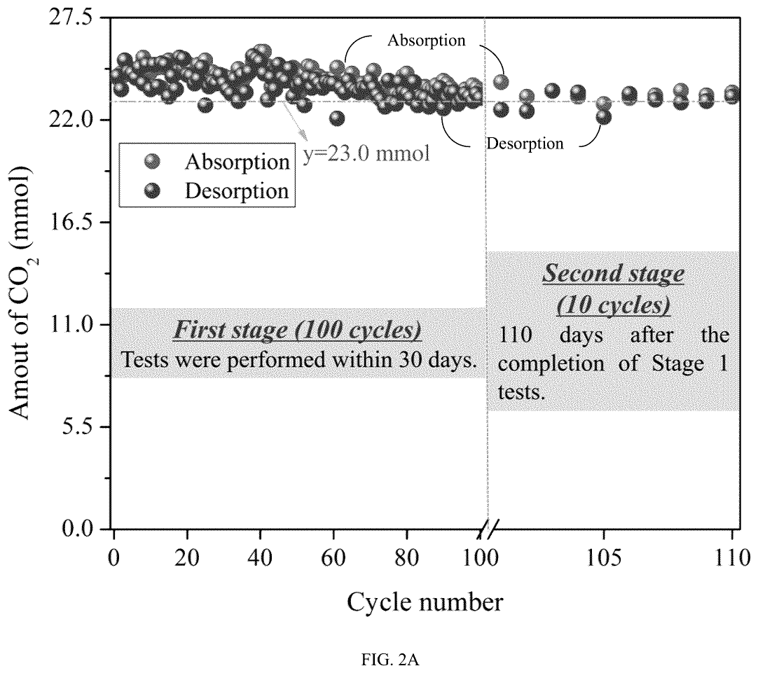

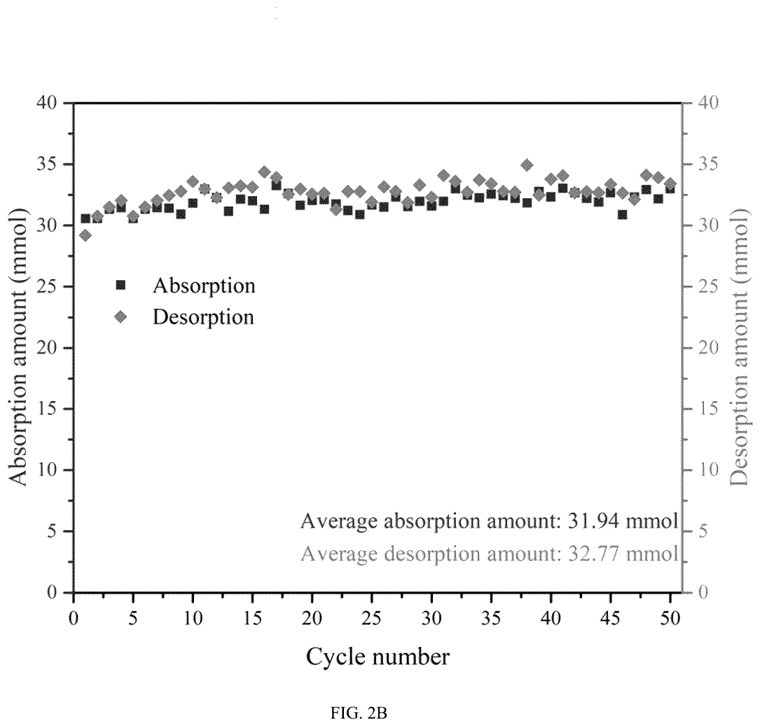

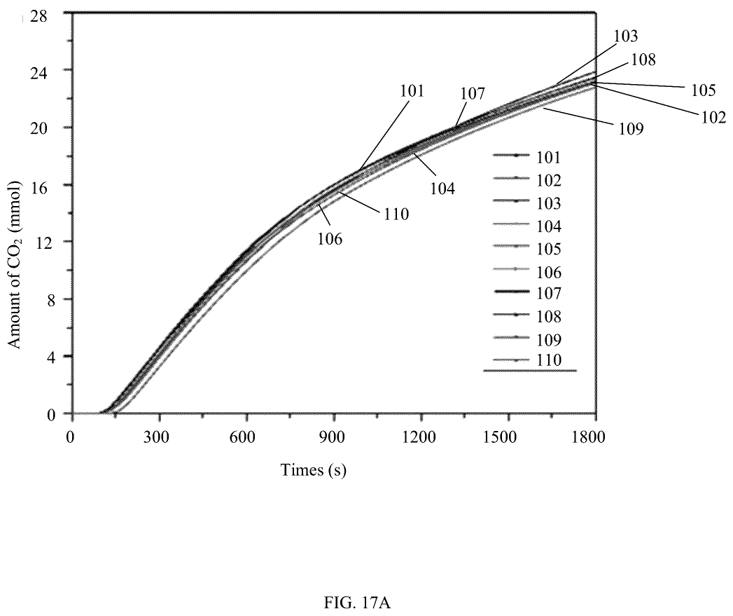

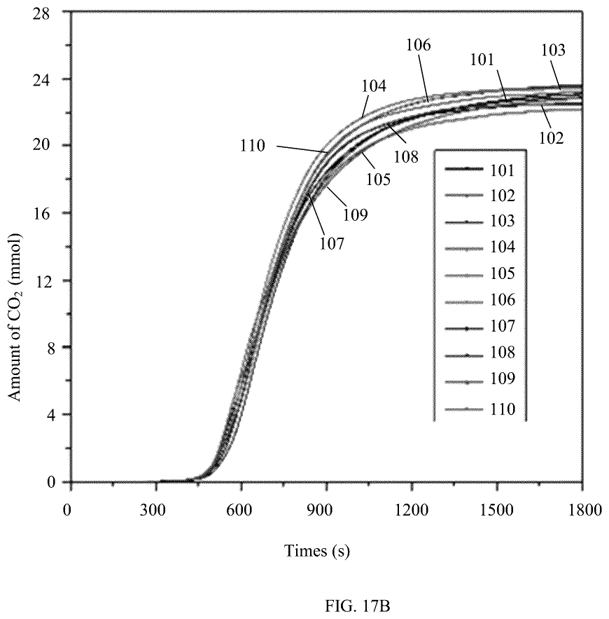

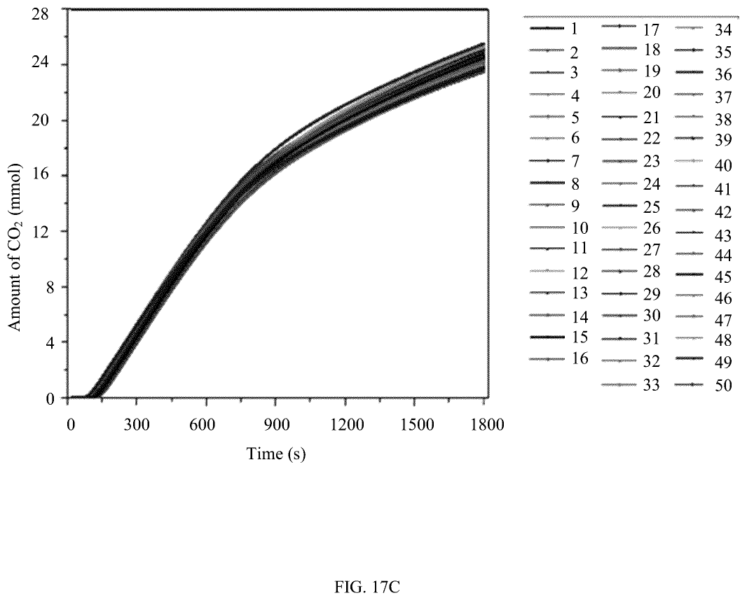

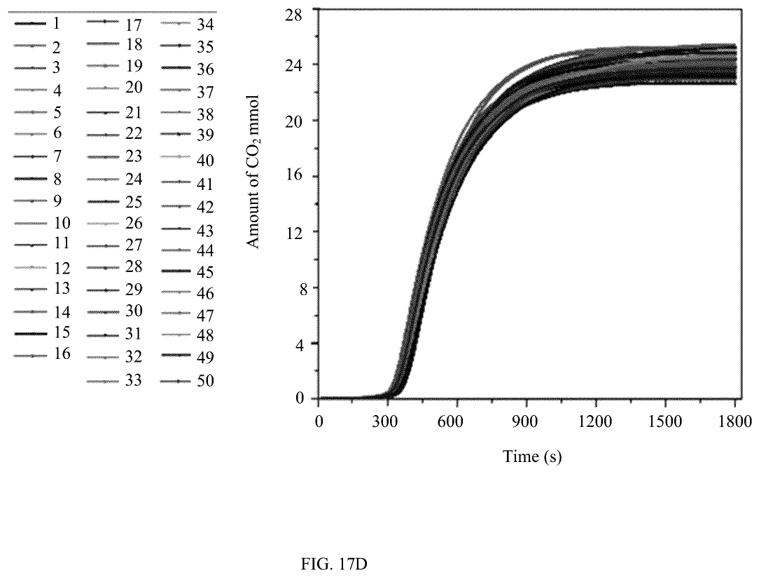

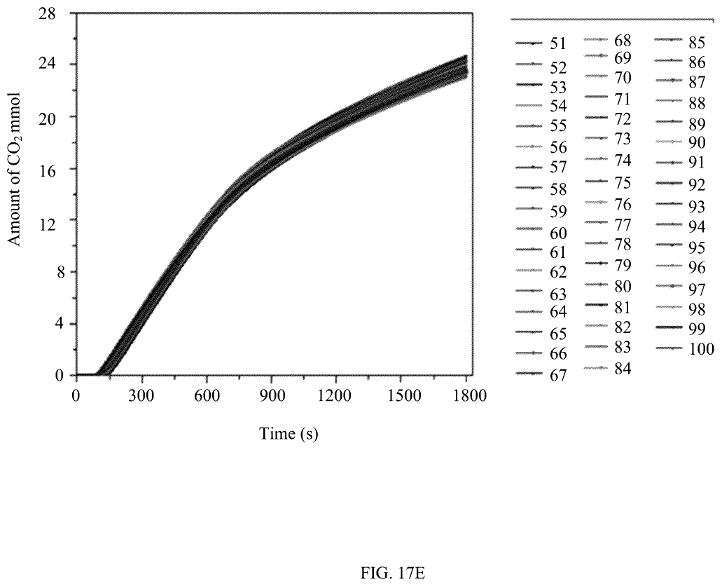

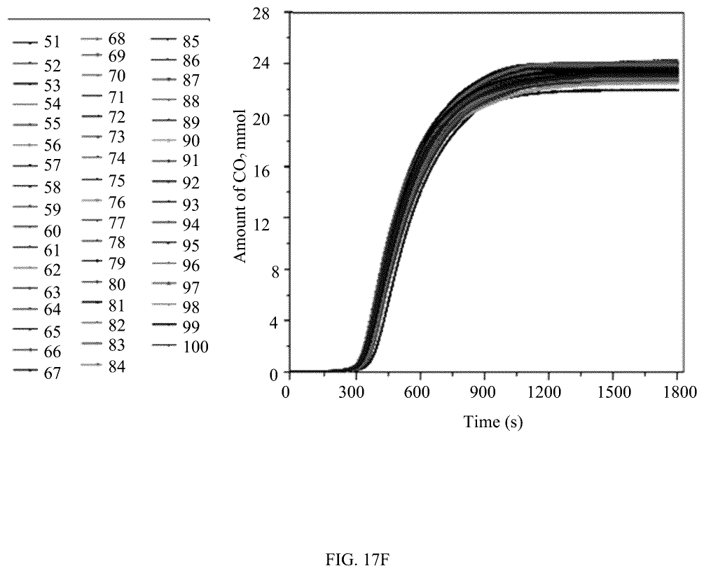

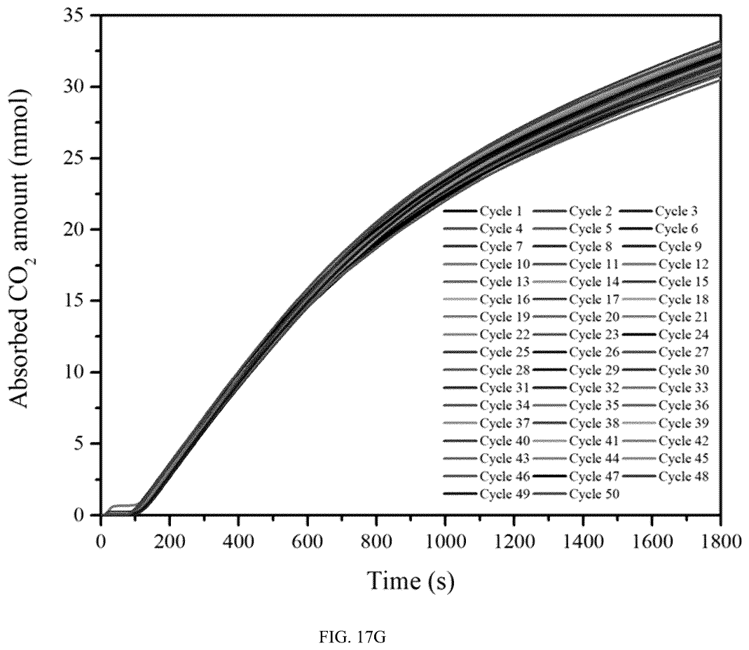

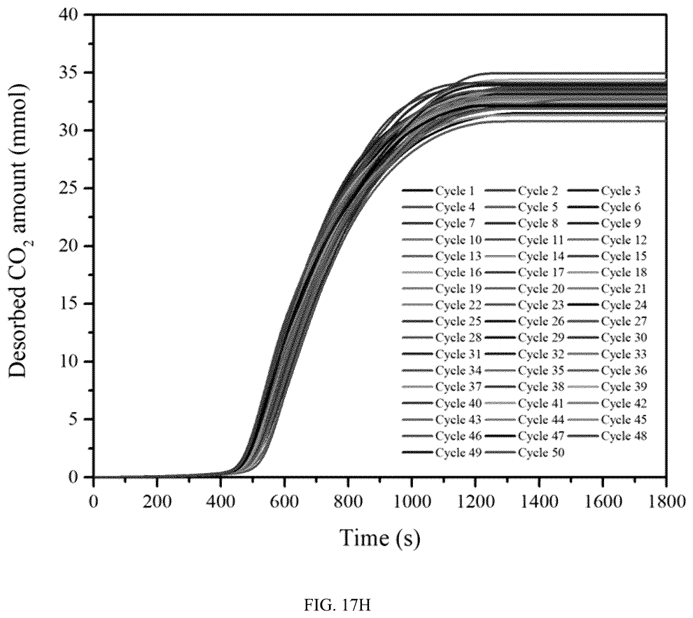

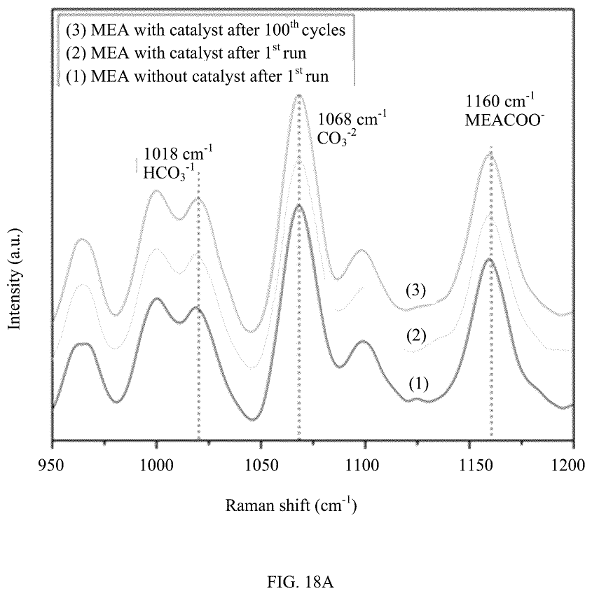

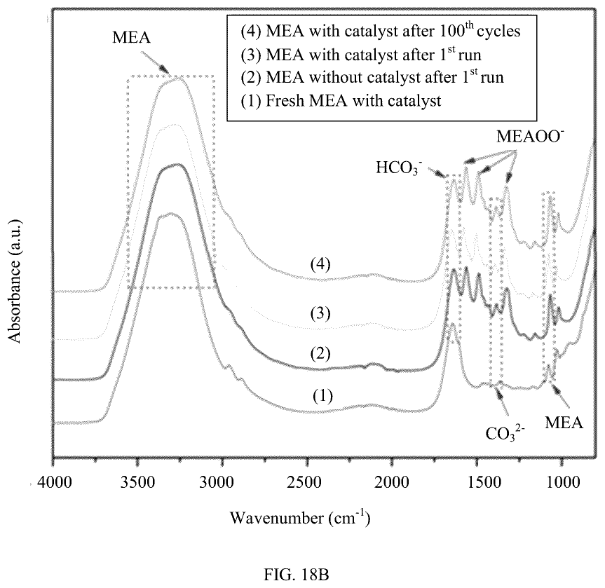

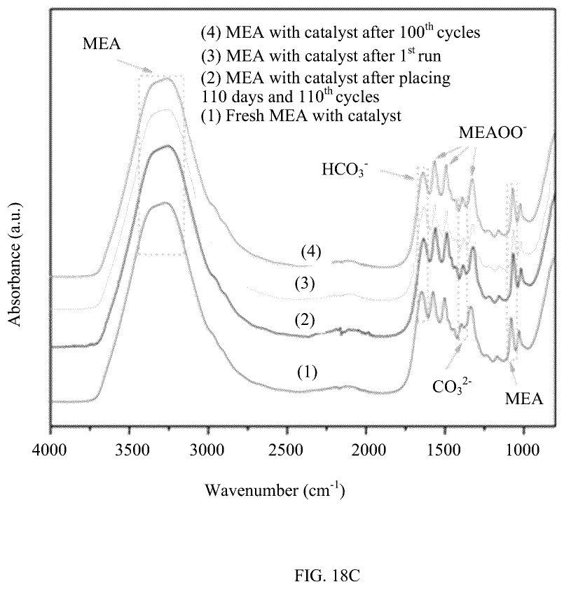

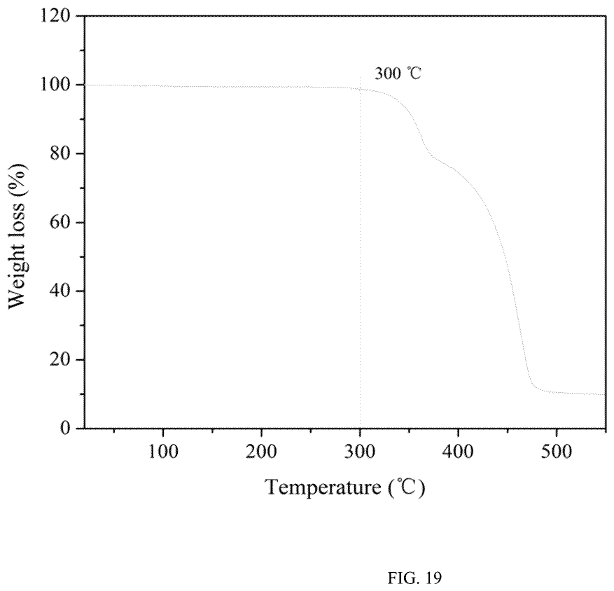

The long-term stabilities of US−[EMmim⁺][NTF₂⁻] for CO₂ absorption-desorption can be studied with 110 cyclic tests during more than 4 months, and the results are shown in FIGS. 2A and 2B where, for example, For Stage 1: CO₂ absorption-desorption cyclic test for 1-100 cycles within 30 days. For Stage 2: tests were performed with the same solvent system used in stage 1 after the tests of stage 1 had been completed for 110 days (101-110 cyclic tests). Absorption conditions: 100 g 20 wt % MEA solution with 3,000 ppm catalyst; composition of inlet gas: 10 vol % CO₂, 10 vol % 02, and 80 vol % N₂; flow rate of inlet gas: 500 mL/min; temperature: 30° C.; time: 1,800 s. Desorption conditions: flow rate of carrier gas N₂: 500 mL/min; temperature: 30-85° C.; time: 1,800 s, and FIG. 17A-17H, where, for example, FIGS. 17C and 17D are the amount of absorbed and desorbed CO₂ for the 1-50 cycle tests. FIGS. 17E and 17F are the amount of absorbed and desorbed CO₂ for the 51-100 cycle tests. FIGS. 17A and 17B are the amount of absorbed and desorbed CO₂ for the 101-110 cycle tests. For the amount absorbed and desorbed, as shown in FIGS. 17A and 17B, after the 100 cycle tests were completed, and the catalytic CO₂ capture system can be placed for 110 days, and then started for the 101-110 cycle tests. Absorption conditions: 100 g 20 wt % MEA solution with 3,000 ppm catalyst; composition of inlet gas: 10 vol % CO₂, 10 vol % 02, and 80 vol % N₂; flow rate of inlet gas: 500 mL/min; temperature: 30° C.; time: 1,800 s. Desorption conditions: flow rate of carrier gas N2: 500 mL/min; temperature: 85° C.; time: 1,800 s. It can be seen that the MEA/US−[EMmim⁺][NTF₂⁻] solution or both MEA and US−[EMmim⁺][NTF₂⁻] are stable within more than 4 months, which can be quite satisfactory from industrial application perspective. It can be seen that no apparent change in both quantities of absorbed and desorbed CO₂ with the 100 cycles in Stage 1. The average working CO₂ capture capacity within the 100 cyclic tests conducted within 30-day under the given conditions can be 23.2 mmol, which can be very close to the 24.3 mmol obtained in the first run. The slight decrease can be due to the accumulative MEA losses, resulting from the difficulty in condensing and recycling the regenerated MEA in each CO₂ desorption step. In other words, a trace amount of the regenerated MEA can be taken away during each cyclic CO₂ absorption desorption operation. As shown in FIGS. 18A-18C, FT-IR and Raman results of the regenerated MEA solution also confirm that no change in the structure of MEA molecules can be observed after 100 cycles of the tests. Thus, the chemical reversibility of both MEA and the organocatalyst can be easily realized for the tested CO₂ absorption and desorption temperatures, −30° C. and 85° C., respectively. It should be noted that [EMmim⁺][NTF₂⁻] can thermally be stable at as high as 300° C. as shown in FIG. 19, where, for example, Thermogravimetric analyses (TGA) curve of IL can be obtained using a TA Instruments SDT Q600 apparatus with a heating ramp of 10° C./min at the temperature of 20-550° C. It should be noted that [EMmim⁺][NTF₂⁻] can thermally be stable at as high as 300° C.

To further confirm the outstanding stability of the coexisting MEA/US−[EMmim⁺][NTF₂⁻] based CO₂ capture solution, 10 more cyclic or Stage 2 tests were performed after 110 days of the completion of 100 cyclic or Stage 1 tests, by using the same used MEA/US−[EMmim⁺][NTF₂⁻] system. For Stage 2, each of the cyclic test results are shown in FIGS. 2A and 2B and FIGS. 17A and 17B, where it can be seen that the average working CO₂ capture capacity can be 23.0 mmol, which represents only a 1.7% decrease compared to that obtained in Stage 1. Furthermore, the FT-IR results (FIG. 18C), of the MEA/US−[EMmim⁺][NTF2] CO₂ capture system indicate both MEA and US−[EMmim⁺][NTF₂⁻] are stable for more than 4 months. For example, the Raman and FT-IR spectra of MEA solution with IL after 100 cycle tests are shown in FIGS. 18A and 18B. FIG. 18C shows the FT-IR spectra of MEA solution with IL after placing 110 days and 120 cycle tests. These Raman and FT-IR spectra further confirmed the outstanding stability of the coexisting MEA/US−[EMmim⁺][NTF₂⁻] based CO₂ capture solution Such a good cyclic performance has not yet been reported in the disclosure.

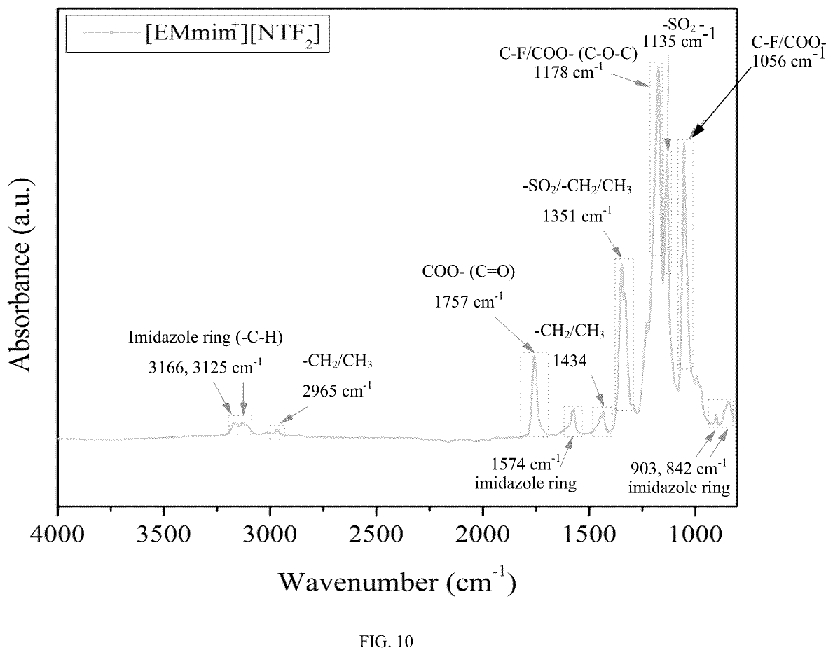

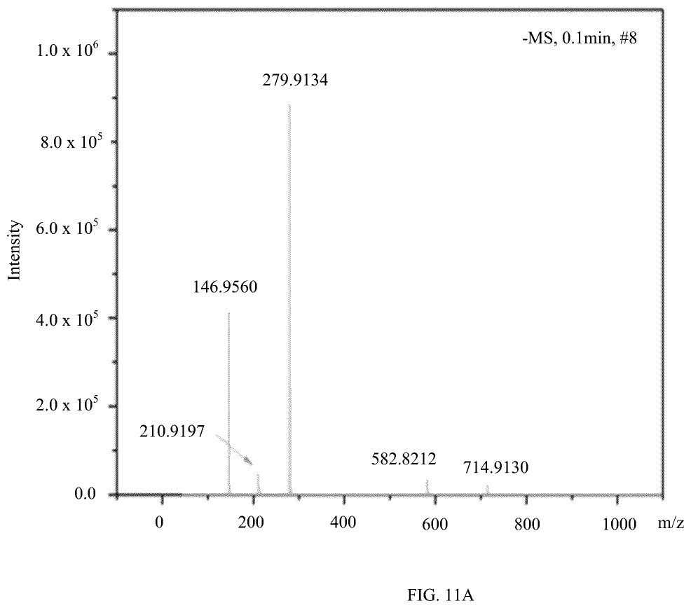

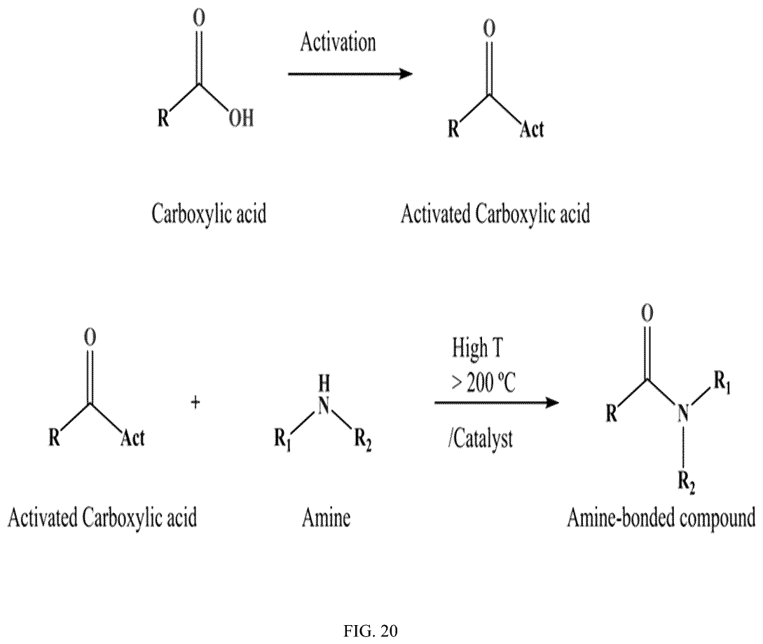

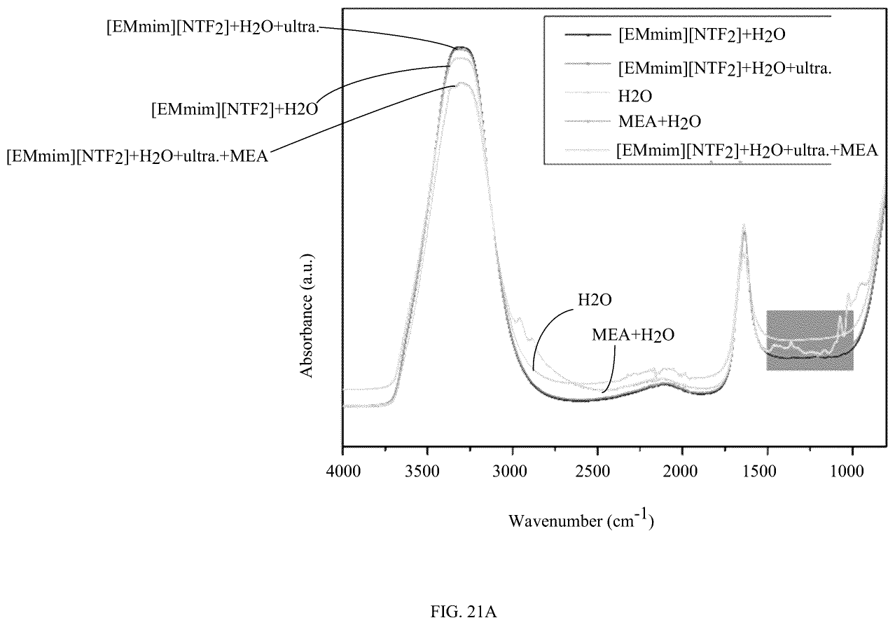

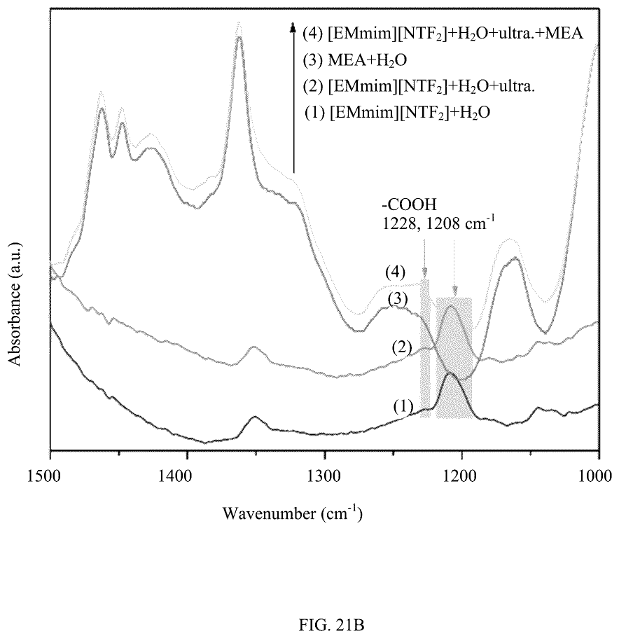

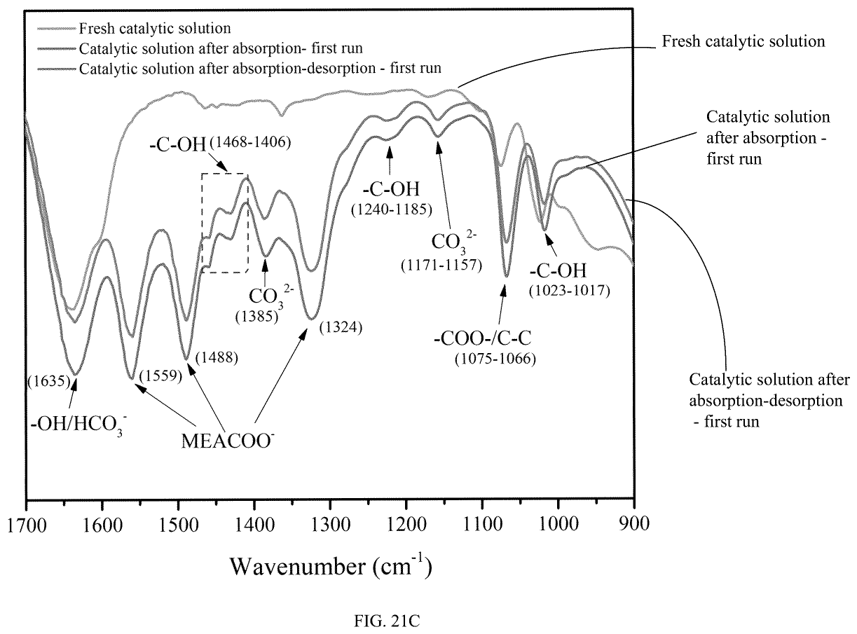

The great repeatability of the CO₂ capture system lies in the good stability of the catalytic CO₂ capture solution. According to Valeur et al. in FIG. 20, strict conditions, not only desired catalysts but also high operation temperatures (>200° C.) must be required to complete the energetic demands for reversible CO₂ capture. For example, the reaction between the mim⁺COOH and amine cannot take place unless at the high temperature condition or the presence of coupling reagents. Also, due to the alkyl ester is an inert substrate, the reaction between the alkyl ester and amine requires rather harsh reaction conditions, such as high temperature, high pressure or the use of strongly basic reagent. The listed reaction cannot occur in the present work, due to the lower CO₂ desorption temperature (no more than 85° C.) and the absence of the required catalyst for the reaction. However, much milder CO₂ absorption and desorption temperatures were actually adopted in this case, and thus [EMmim⁺][NTF2] should be stable which can be further confirmed by the FT-IR spectra of the mixture of US−[EMmim⁺][NTF₂⁻] and MEA or catalytic CO₂ capture system as shown in FIG. 10 and FIGS. 21A-21C, where, for example, the peaks of the —COOH in US−[EMmim⁺][NTF₂⁻] and the mixture of US−[EMmim⁺][NTF₂⁻] and MEA are identical, a sign of no interaction between two function groups, —COOH and —NH₂, or no formation of stable —CONH₂. The observation indicates that the catalytic function of trace amount of US−[EMmim⁺][NTF₂⁻] should not be affected by even large quantity of MEA via the formation of —CONH₂. The peaks of the —COOH in US−[EMmim⁺][NTF₂⁻] and the mixture of US−[EMmim⁺][NTF₂⁻] and MEA are similar, a sign of no interaction between the two functional groups, —COOH and —NH₂, or no formation of —CONH₂ and thus the catalytic CO₂ capture system can be stable.

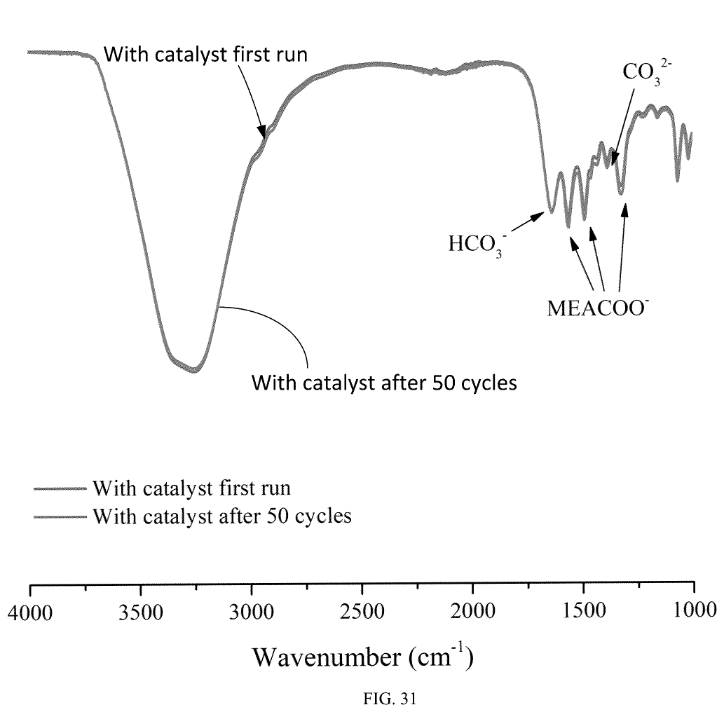

In another exemplary aspect of the present invention, stability characteristic of [EMmim][NTf₂] for CO₂ capture was studied with 50 cyclic tests, and the results are shown in FIGS. 2B, 17G and 17H. Where, specifically, in accordance with aspects of the present disclosure, FIG. 2B discloses the quantities of absorbed and desorbed CO₂ with the presence of [EMmim][NTf₂] catalyst during 50 cyclic tests. Where, specifically, in accordance with aspects of the present disclosure FIG. 17G discloses the CO₂ absorption profiles of 50 cyclic tests. And, where, specifically, in accordance with aspects of the present disclosure FIG. 17H discloses the CO₂ desorption profiles of 50 cyclic tests. There is no apparent change in both quantities of absorbed and desorbed CO₂. The average CO₂ capture working capacities within the 50 cyclic tests are 31.94 and 32.77 mmol for absorption and desorption amounts, respectively, as shown in FIG. 31. HCO₃⁻, CO₃²⁻ and MEACOO⁻ are generated during CO₂ absorption process, which is the FT-IR spectra of the regenerated MEA solution confirming that no change in the structure of MEA molecules was observed after 50 cycles of the tests. Thus, both MEA and the [EMmim][NTf₂] are stable. Moreover, [EMmim][NTf₂] can thermally be stable at as high as 300° C. as shown in FIG. 19.

### 4. Exemplary Mechanism

4.1 Experimental

4.1.1 Activation of the IL Catalyst Via Ultrasound

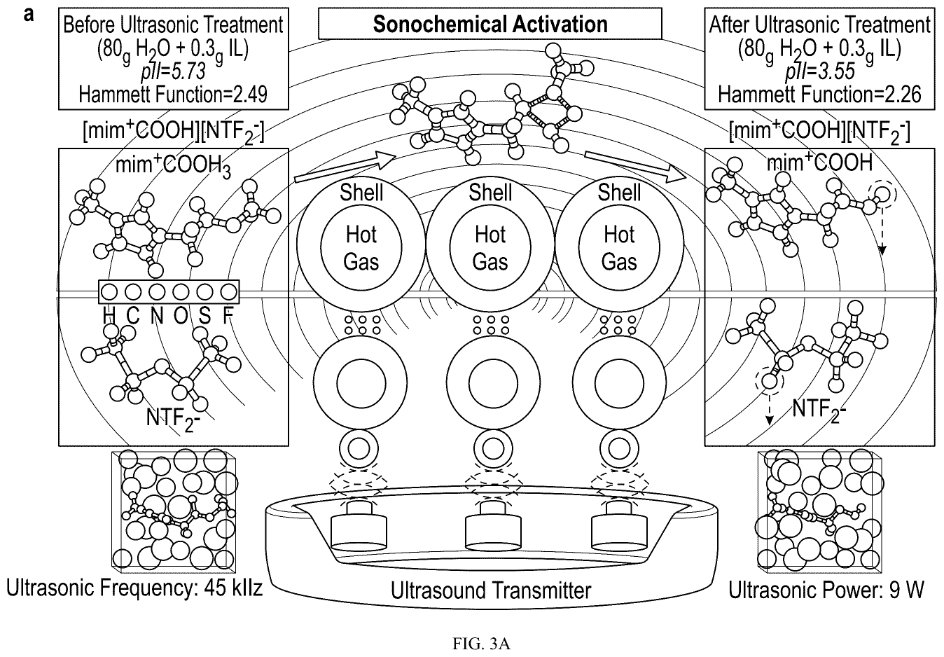

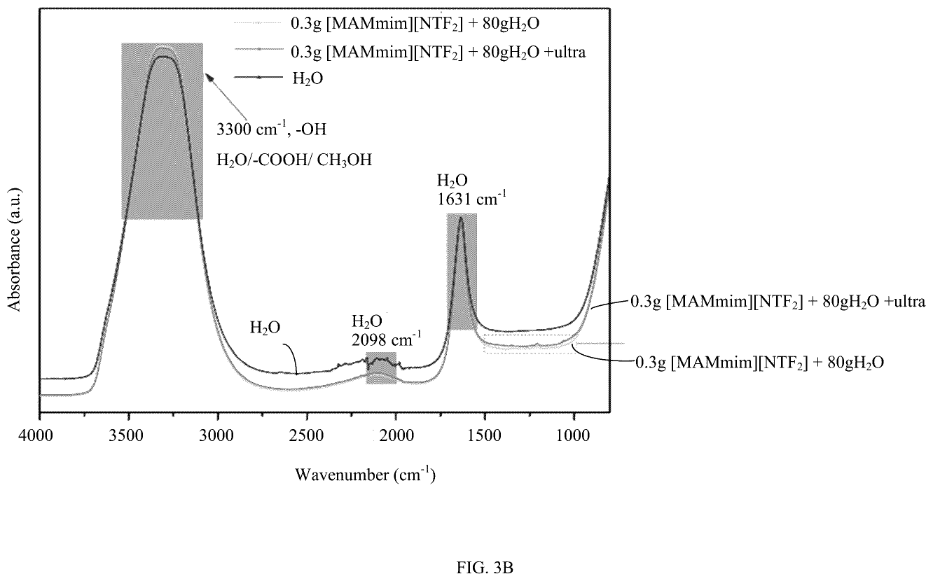

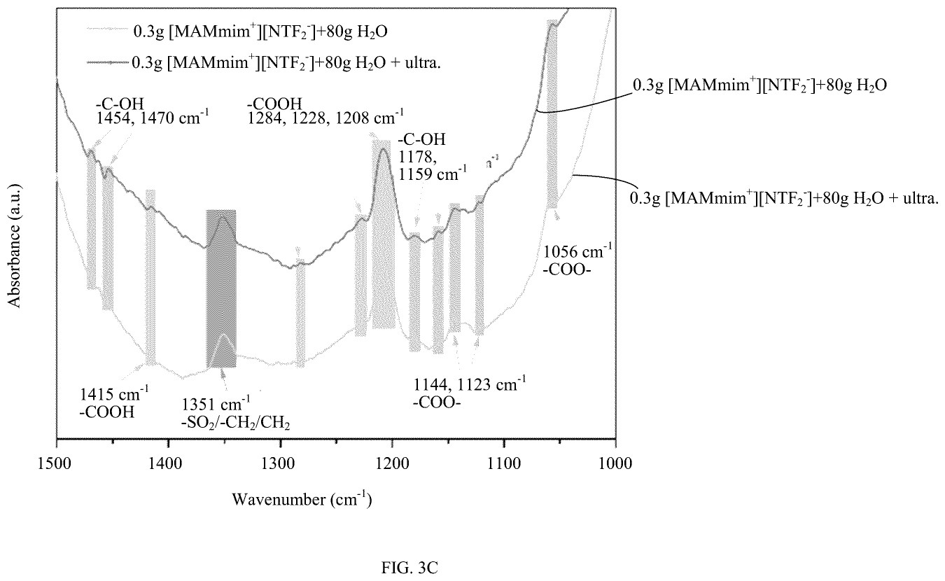

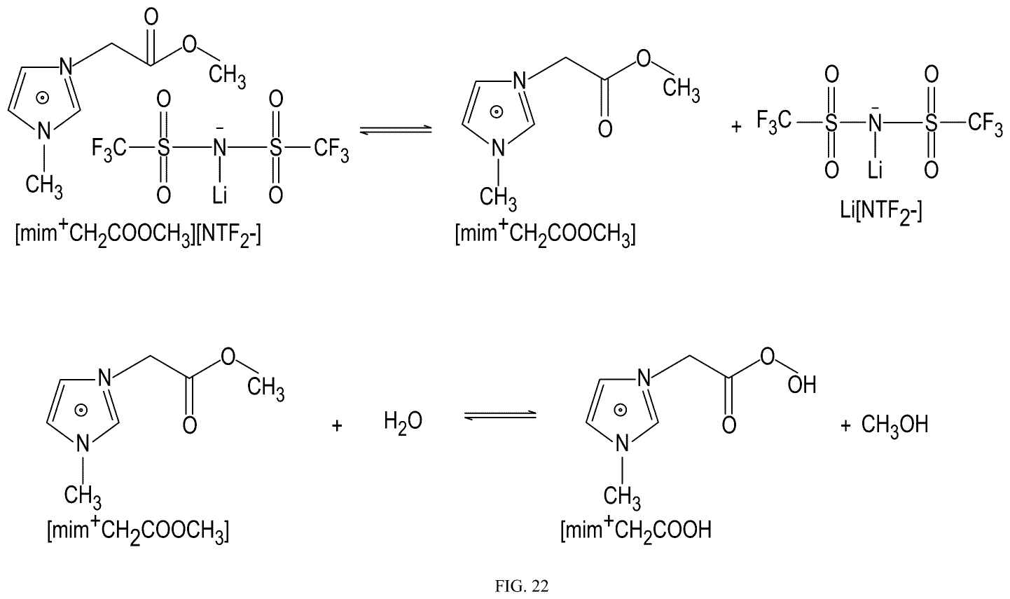

The proposed mechanism for activating-[EMmim⁺][NTF₂⁻] with ultrasound to obtain the US−[EMmim⁺][NTF₂⁻] has been shown in FIGS. 3A-3C, where, for example, as shown in FIG. 3A, the schematic representation of the [EMmim+][NTF2−] catalyst and the [EMmim+][NTF2−] catalyst ultrasound activation process. FIG. 3B shows the FT-IR spectra of [EMmim+][NTF2−] and US−[EMmim+][NTF₂−]. The conditions of ultrasonic activation: time: 20 min; ultrasonic power: 9 W; temperature: 30° C.; ultrasonic system: 80 g H2O+0.3 g [EMmim+][NTF₂−] are shown in FIG. 3C. FIG. 22, shows for example, having the following ultrasonic conditions: time: 20 min, temperature: 30° C., ultrasonic power: 9 W; ultrasonic system: 80 g water 0.3 g IL catalyst. Note that after the ultrasonic activation, the part of ester group in the [EMmim⁺][NTF₂⁻] can be hydrolyzed into desired form of mim⁺COOH. The molecular structure of the IL, [EMmim⁺][NTF₂⁻] has shown in FIG. 3A. [EMmim⁺][NTF₂⁻] possesses a degree of acidity, which can be verified via the measurement of the pH, 5.73, of the solution resulting from the addition of 0.3 g [EMmim⁺][NTF₂⁻] to 80 g H₂O (Table 1).

TABLE 1

| Sample | pH |
|---|---|
| 80 g H₂O | 6.48 |
| 80 g H₂O + 0.3 g [EMmim⁺][NTF₂⁻] | 5.73 |
| 80 g H₂O + 0.3 g [EMmim⁺][NTF₂⁻] + ultrasonic | 3.55 |
| 20 g MEA + (80 g H₂O + 0.3 g [EMmim⁺][NTF₂⁻] + ultrasonic) | 12.35 |
| 20 g MEA + 80 g H₂O | 12.36 |
| MEA without catalyst after abs.-des. process - first run | 9.65 |
| MEA with [EMmim⁺][NTF₂⁻] catalyst after abs.-des. process - | 9.75 |
| first run | |
| MEA with [EMmim⁺][NTF₂⁻] catalyst after abs.-des. process- 100 | 9.44 |
| cycles | |

Also, the acidity of the [EMmim⁺][NTF₂⁻] can be observed with its FT-IR spectrum presented in FIG. 3C, which mainly attributes to the slight hydrolysis of the ester group (—COOR) in IL to form the terminal carboxylic acid groups (—COOH). The acidity of US−[EMmim⁺][NTF₂⁻] can be considerably enhanced due to the generation of more —COOH moiety via ultrasound-activated hydrolysis of the —COOR in the [EMmim⁺][NTF₂⁻], as given in FIGS. 3A-3C. The activation of [EMmim⁺][NTF₂⁻] can be attributed to a controlled degree of hydrolysis from ester group (—COOR) to form corresponding carboxylic acid groups (—COOH), which can be based on the formation, growth, and implosive collapse of cavitation microbubbles occurring during the traveling of a high power ultrasound wave via aqueous [EMmim⁺][NTF₂⁻].

The FT-IR spectra of [EMmim⁺][NTF₂⁻] and US−[EMmim⁺][NTF₂⁻] are shown in FIGS. 3B and 3C. The bands around 1056, 1144 and 1123 cm⁻¹ are assigned to the signature of —COOR groups. Compared to the spectrum of [EMmim⁺][NTF₂⁻], the spectrum of US−[EMmim⁺][NTF₂⁻] presents several additional and intensive peaks at 1208, 1128, 1284 and 1415 cm⁻¹, which are attributed to the stretching vibration of —COOH. Also, the spectrum of US−[EMmim⁺][NTF₂⁻] shows the enhanced peak intensities for stretching vibration of the hydroxyl group (—OH) at 1159, 1178, 1454 and 1470 cm⁻¹. The pH of the US−[EMmim⁺][NTF₂⁻] can be decreased to 3.55 (Table 1), equivalent to an increase in concentration of H⁺ by ˜151 times, a large jump via a green activation process as proven with the obvious enhancement in the peak intensity of —COOH in FIG. 3C.

TABLE 1

| Sample | pH |
|---|---|
| 80 g H₂O | 6.48 |
| 80 g H₂O + 0.3 g [EMmim⁺][NTF₂⁻] | 5.73 |
| 80 g H₂O + 0.3 g [EMmim⁺][NTF₂⁻] + ultrasonic | 3.55 |
| 20 g MEA + (80 g H₂O + 0.3 g [EMmim⁺][NTF₂⁻] + ultrasonic) | 12.35 |
| 20 g MEA + 80 g H₂O | 12.36 |
| MEA without catalyst after abs.-des. process - first run | 9.65 |
| MEA with [EMmim⁺][NTF₂⁻] catalyst after abs.-des. process - | 9.75 |
| first run | |
| MEA with [EMmim⁺][NTF₂⁻] catalyst after abs.-des. process- 100 | 9.44 |
| cycles | |

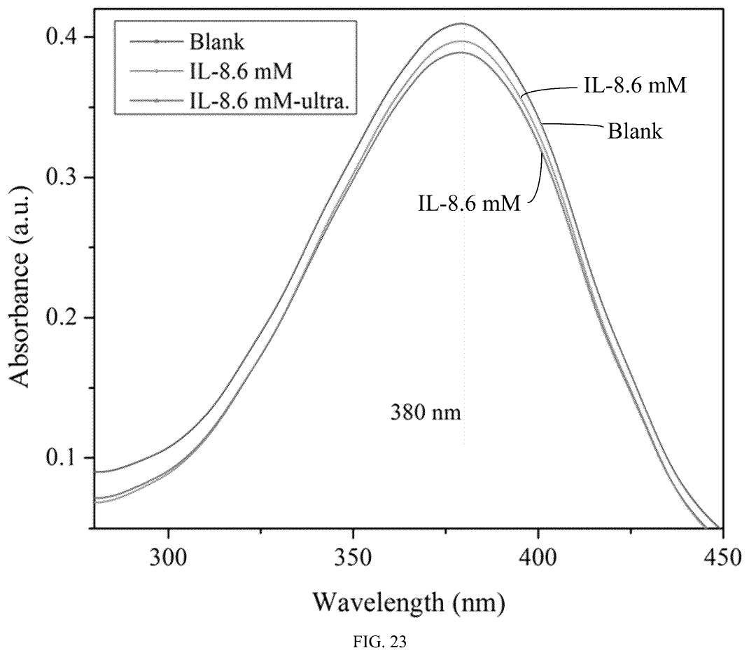

Also, as shown in FIG. 3C, the peak intensity of —COOR can be evidently decreased for the US−[EMmim⁺][NTF₂⁻]. The Brønsted acid sites of IL catalysts were further confirmed with the characteristic parameter of the Hammett functions, H₀, obtained by the UV-Vis spectroscopy. The H₀ values of the 8.6 mM [EMmim⁺][NTF₂⁻] and US−[EMmim⁺][NTF₂⁻] solutions are 2.49 and 2.26, respectively (FIG. 23, where, for example, the H₀ values of the 8.6 mM [EMmim⁺][NTF₂⁻] and US−[EMmim⁺][NTF₂⁻] solutions are 2.49 and 2.26, respectively, another indication of significant effect of ultrasound on the degree of the hydrolysis of ester group into desired mim⁺COOH, and Table 2), another indication of the significant effect of ultrasound on the degree of hydrolysis of the —COOR group into desired mim⁺COOH.

TABLE 2

| Samples | Aₘₐₓ | [I] (%) | [IH⁺](%) | H₀ |
|---|---|---|---|---|
| Blank | 0.411 | 100 | 0 | — |
| IL-8.6 mM | 0.398 | 96.91 | 3.09 | 2.49 |
| IL-8.6 mM-ultra. | 0.390 | 94.89 | 5.11 | 2.26 |

^{a}Indicator: 4-nitroaniline (Pka = 0.99), the concentration of 4-nitroaniline solution is 25 μm; H₀ = pKa + log([I]/[IH⁺]).

### 4.1.2. Mechanistic Studies

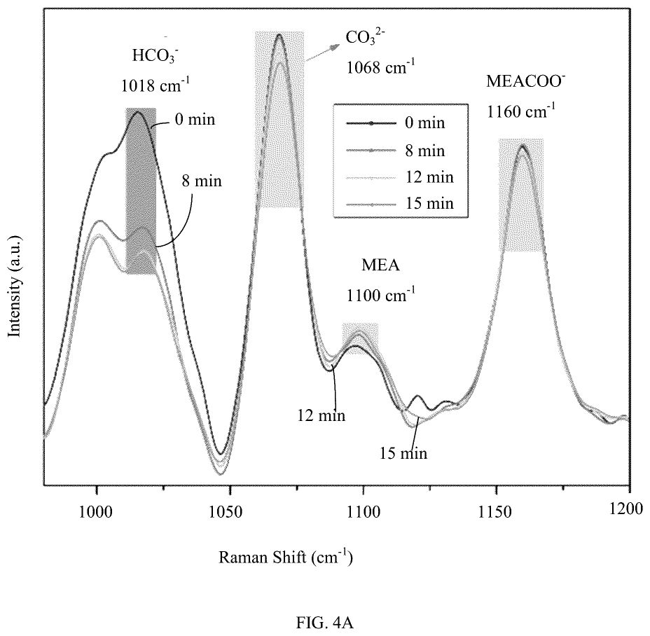

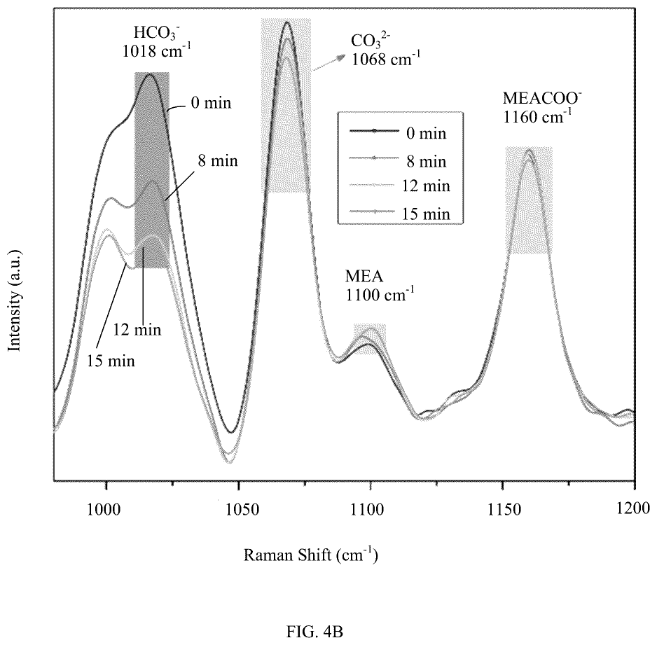

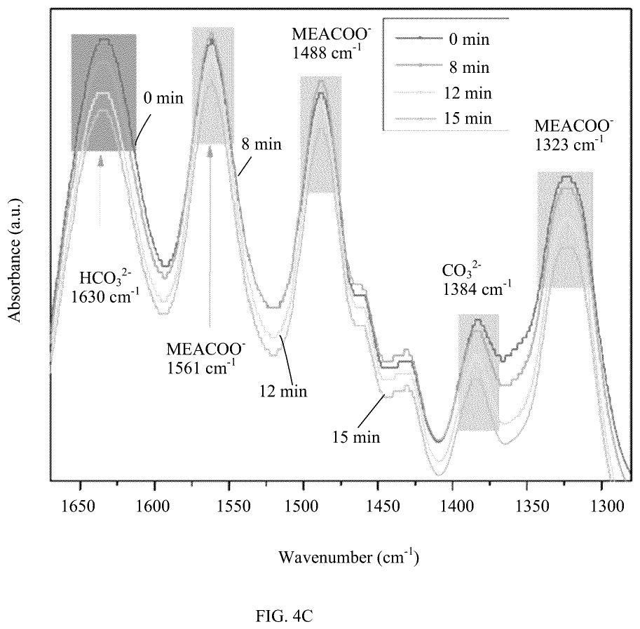

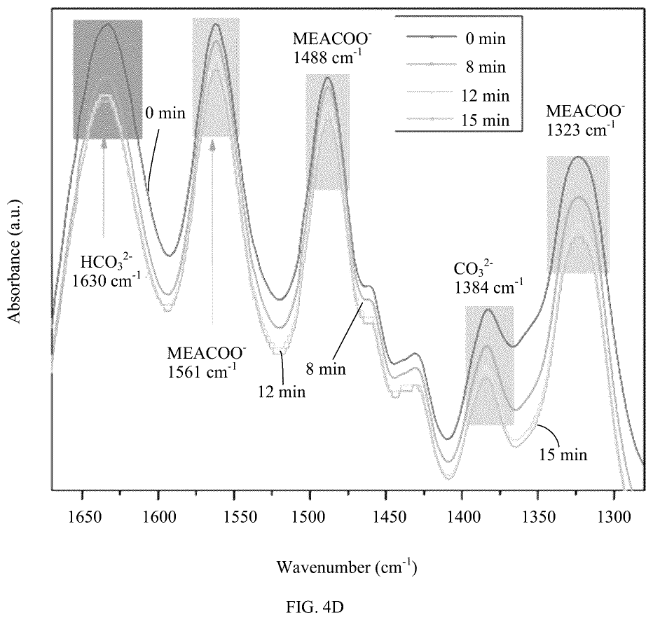

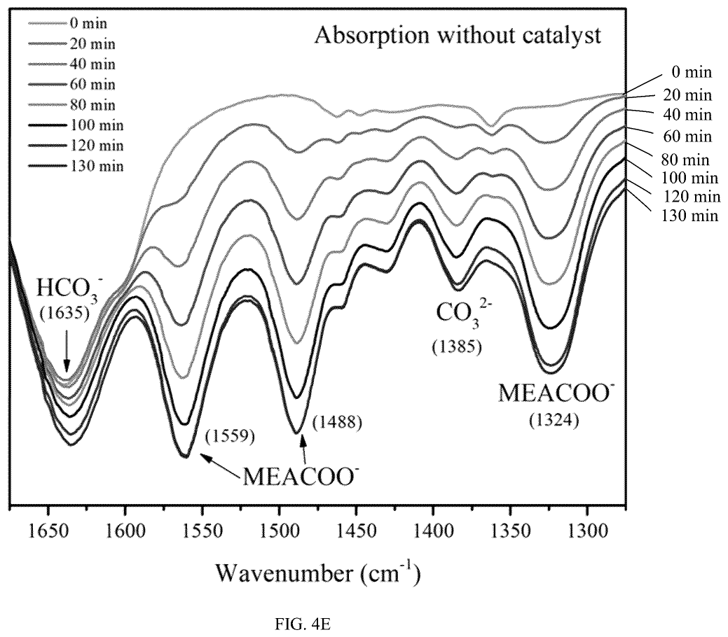

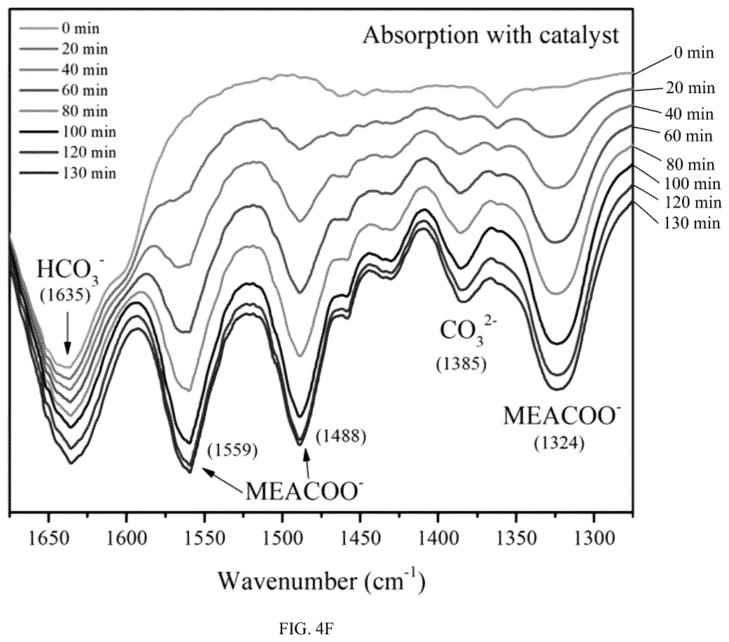

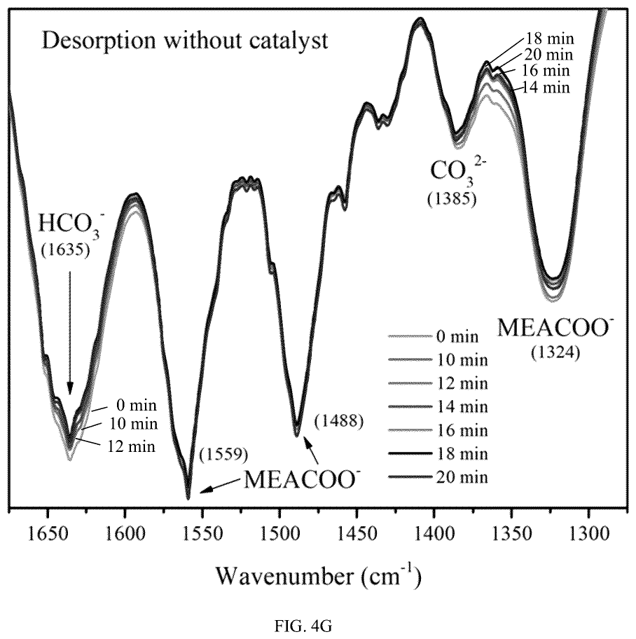

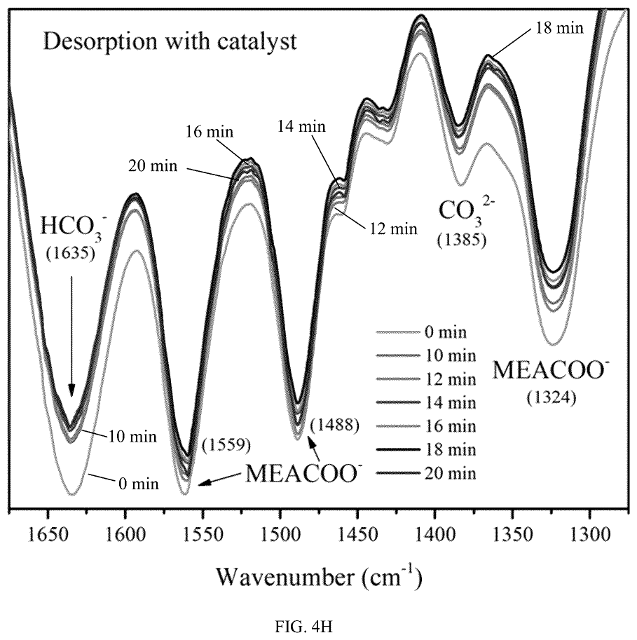

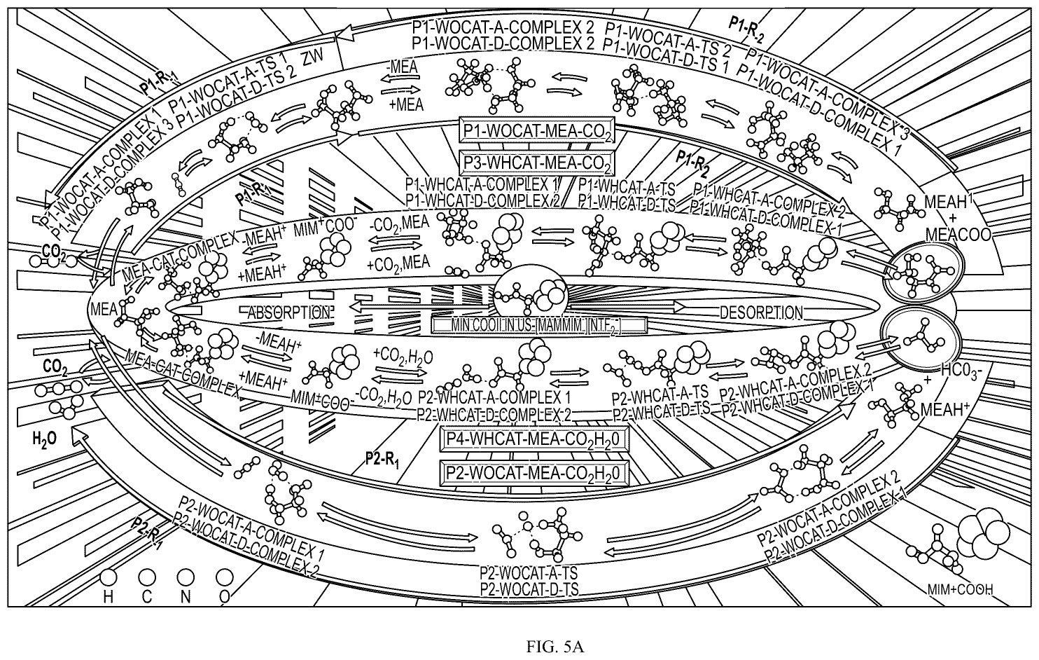

Although the catalytic effect of the 3,000 ppm US−[EMmim⁺][NTF₂⁻] can be clearly observed with the significant enhancement of CO₂ desorption rate at 85° C., the associated essential mechanism needs to be investigated for further development of next generation CO₂ capture catalysts. As a result, Raman and FT-IR spectroscopies were utilized for analyzing the solutions collected during CO₂ desorption with and without uses of US−[EMmim⁺][NTF₂⁻] at different desorption times. FIGS. 4A and 4B show the Raman spectra, while FIGS. 4C and 4D exhibit the FT-IR results. In the Raman spectrum of spent MEA solution, the peaks at 1018 (C—OH stretching), 1068 (C—O stretching) and 1160 cm⁻¹ (C—N stretching) are attributed to the bicarbonate (HCO₃⁻), carbonate (CO₃²⁻) and carbamate (MEACOO⁻) ions, respectively. With the use of the catalyst, the MEA-H₂O—CO₂ system contains higher amounts of HCO₃⁻ groups. The peak intensities of HCO₃⁻, and CO₃²⁻ in the spent MEA solution with the use of the US−[EMmim⁺][NTF₂⁻], especially the HCO₃⁻highlighted in FIGS. 4A and 4B, decrease more quickly than the catalyst-free spent MEA solution does. Also, similar observations on the catalytic effects were obtained with FT-IR spectra for the spent MEA solutions at different desorption times. In FIGS. 4C and 4D, the bands at 1323 (stretching of N—COO⁻), 1488 (symmetric stretching of COO⁻) and 1561 cm⁻¹ (asymmetric stretching of COO⁻) are ascribed to the MEACOO⁻, while the peaks at 1384 and 1630 cm⁻¹ are assigned to CO₃²⁻ and HCO₃⁻, respectively. The peak intensity of HCO₃⁻ in the spent MEA solution without use of US−[EMmim⁺][NTF₂⁻] decreases slowly with the continuous CO₂ desorption, and the intensities of CO₃²⁻ and MEACOO⁻ peaks and thus the concentrations of CO₃²⁻ and MEACOO⁻ barely change during the first 8 min, in spite of the subsequent slightly noticeable variations. However, the changes in the peak intensities of HCO₃⁻, CO₃²⁻, and MEACOO⁻, especially HCO₃⁻ shown in FIG. 4D during the initial 8 min of the catalytic spent MEA solutions decrease considerably fast. Obviously, the observations of the changes of the concentrations of intermediates, with both Raman and FT-IR spectra confirm the significant catalytic effect of the US−[EMmim⁺][NTF₂⁻], where, for example, as shown in FIGS. 4A and C, CO₂ desorption without catalyst, for example as shown in FIGS. 4B and 4D, CO₂ desorption with 3,000 ppm US−[EMmim+][NTF2−] equivalently containing 10.1 ppm of —COOH.

### 4.1.3 Experimental Study of the Reaction Mechanisms

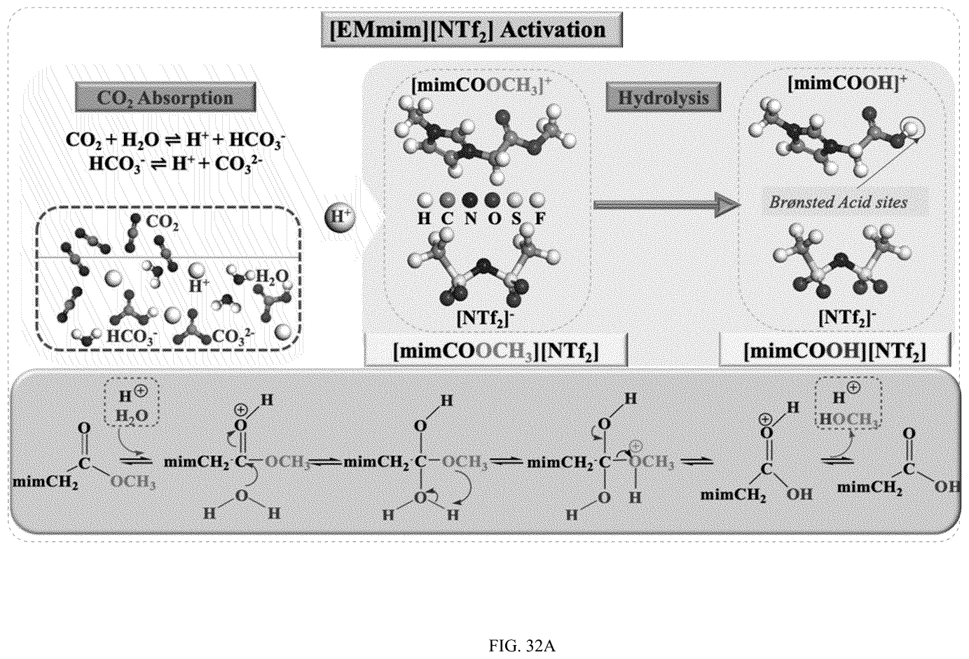

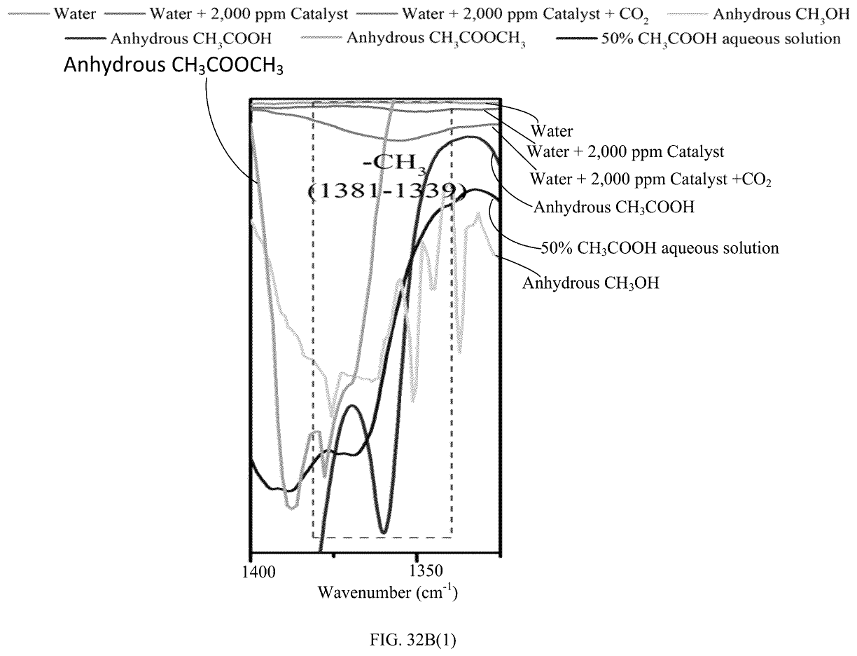

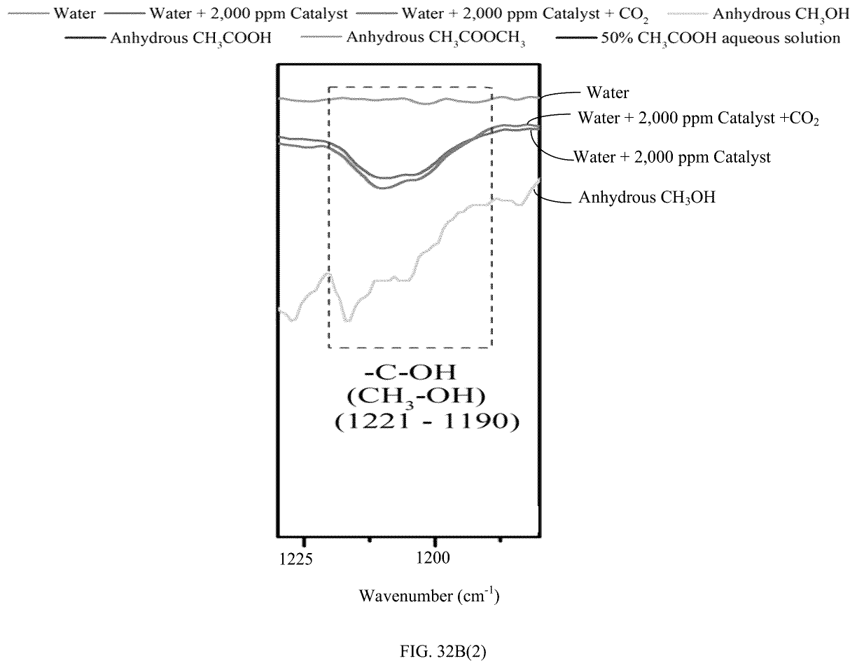

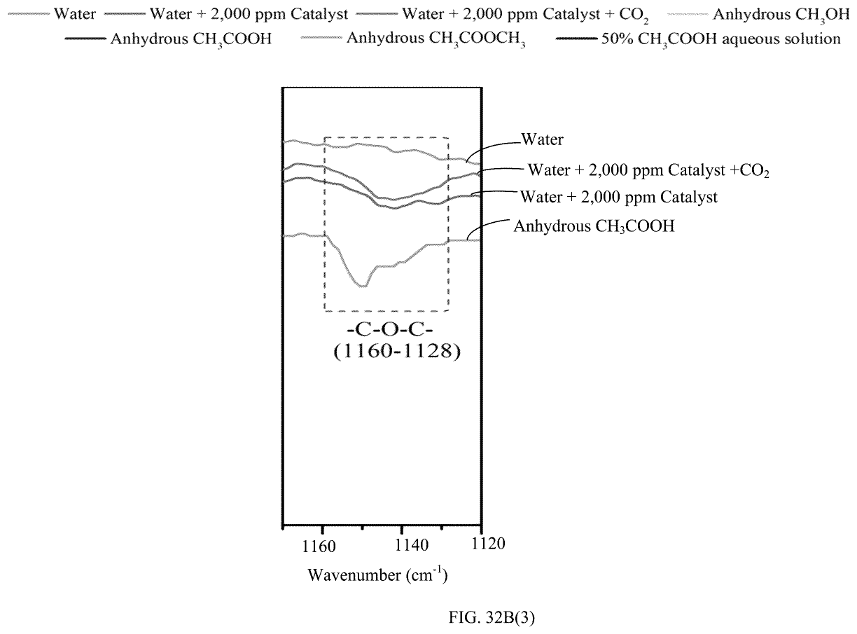

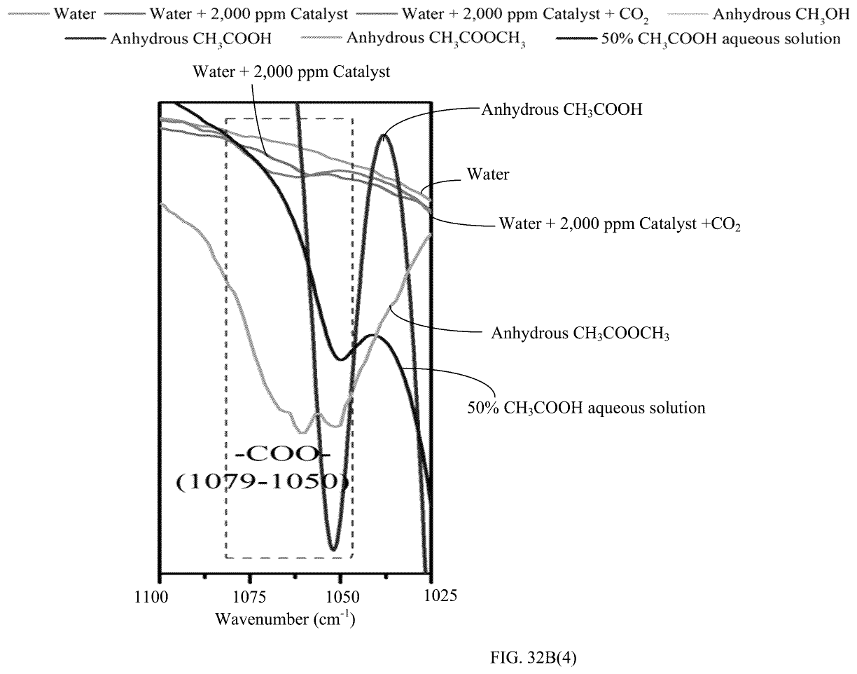

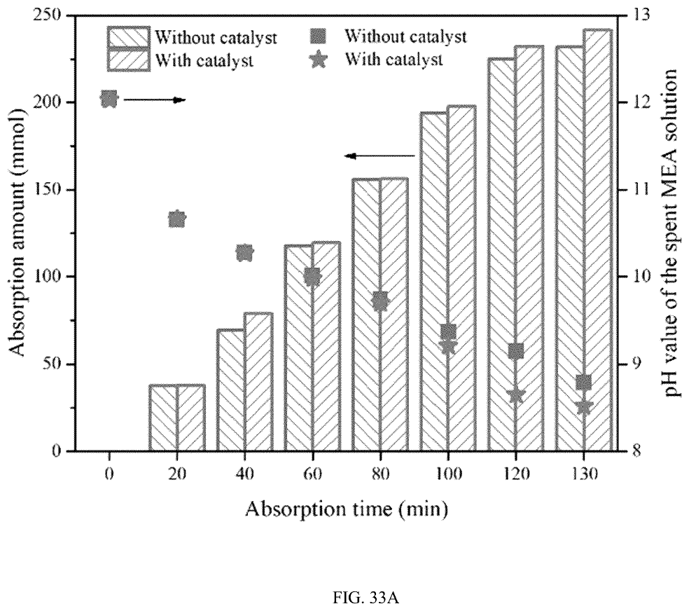

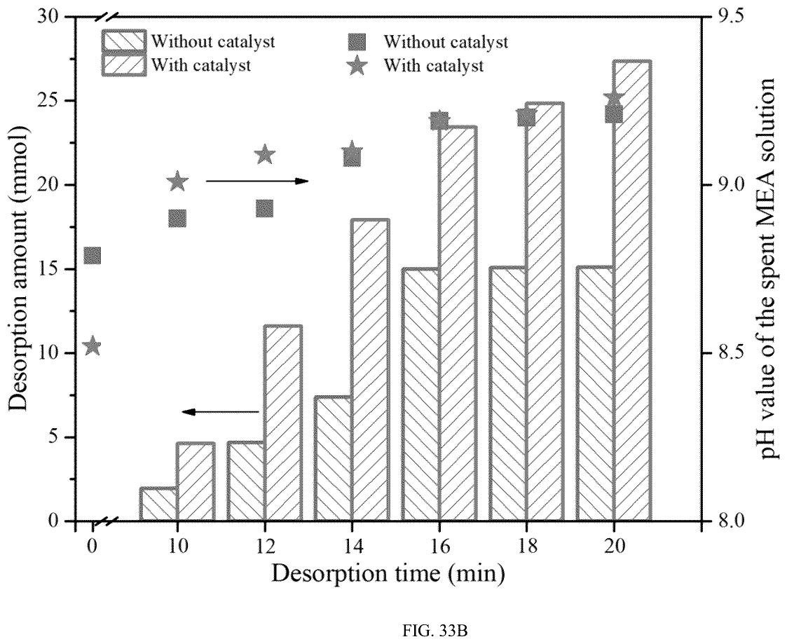

The molecular structure of the IL, [EMmim][NTf₂] is shown in FIG. 6. After CO₂ absorption, the pH of the capture system decreased from 12.01 to 8.52, indicating the increase of H⁺ concentration and promotion of the hydrolysis of the —COOCH3 in [EMmim][NTf₂] into —COOH, which is need for catalyzing CO₂ desorption. Thus, the activation of [EMmim][NTf₂] is accompanied with the enhancement of the acidity of [EMmim][NTf₂] after CO₂ absorption, as illustrated in FIG. 32A, which provides a schematic representation of the [EMmim][NTf₂] catalyst and the hydrolysis activation process. The FT-IR spectra of water, and the 2,000 ppm [EMmim][NTf₂] aqueous solution with or without CO₂ as shown in FIG. 32B(1)-(4) further confirms this mechanism. Anhydrous CH₃OH and CH₃COOCH₃ as well as CH₃COOH and 50% CH₃COOH solutions were used to identify the functional groups in the catalytic solutions with or without additions of CO₂. The bands around 1381-1339 cm⁻¹ in the catalytic solutions [as shown in FIG. 32B(1)] are assigned to the —CH₃ group in the IL catalyst (—COOCH3), observed in anhydrous CH₃OH, CH₃COOCH₃ and CH₃COOH and 50% CH₃COOH solutions. With the increase in the introduced CO₂ in the solution, hydrolysis of —COOCH3 is enhanced, leading to the increase the concentration of —CH₃ or CH₃OH in the catalytic solution as illustrated in FIG. 32A. Bands with wavenumbers between 1221-1190 cm⁻¹ [as shown in FIG. 32B(2)], detected in anhydrous CH₃OH as well, confirm the formation of CH₃OH with an enhanced hydrolysis process with CO₂. As concentration of —COOCH3 decreases, the —C—O—C peak [1160-1128 cm⁻¹, shown in FIG. 32B(3)] in the catalytic solution with the addition of CO₂ was weaker than that of the solution without addition of CO₂ according to the reference peaks of anhydrous CH₃COOCH₃. Consequently, more —COO— or —COOH formation or more —COOCH₃ hydrolysis, was detected within 1079-1050 cm⁻¹ [shown in FIG. 13B(4)], which are concluded from the observations of peaks of anhydrous CH₃COOCH₃ and CH₃COOH, and 50% CH₃COOH solution. Also, the acidity of the [EMmim][NTf₂] was verified via the measurement of the pH (6.19) of the solution resulting from the addition of 0.2 g [EMmim][NTf₂] to 80 g H₂O (Table 3). The FT-IR spectra of fresh catalytic solution, catalytic solutions after the 1^{st} absorption and the 1^{st} cyclic absorption-desorption runs are displayed in FIGS. 21A-21C. According to FIG. 21C, peak at 1023-1017 cm⁻¹ is assigned to —C—OH, belonging to MEA (—CH₂—OH) and HCO₃⁻ (—COOH) after absorption. Peak at 1075-1066 cm⁻¹ is assigned to —COO—/C—C, belonging to MEA (—CH₂—CH₂—), and HCO₃⁻ (—COO—) resulting from absorption. Peaks at 1171-1157 cm⁻¹ and 1385 cm⁻¹ are assigned to CO₃²⁻ resulting from absorption. Peaks at 1240-1185 cm⁻¹ and 1468-1406 cm⁻¹ are assigned to —C—OH, belonging to HCO₃⁻ (—C—OH) resulting from absorption. Peaks at 1559, 1488, 1324 cm⁻¹ are assigned to —COO— in MEACOO— resulting from absorption. Peak at 1635 cm⁻¹ is assigned to HCO₃⁻ or —OH, which is also a signature peak of water. The differences in the changes of the quantities of CO₂ absorbed and desorbed, and pH values of the uncatalytic and catalytic solutions with absorption and desorption times as shown in FIG. 33A-33B result from the use of the catalyst. For example, the pH value (8.65) of the catalytic solution at 120 min is lower than that (8.79) of the uncatalytic solution at 130 min, when both solutions absorb the same amount of CO₂, another direct evidence of hydrolysis of —COOCH₃ in the IL into —COOH, a key function group in catalyzing the subsequent CO₂ desorption.

TABLE 3

| Sample | pH |
|---|---|
| 80 g H₂O | 6.37 |
| 80 g H₂O + 0.2 g [EMmim][NTf₂] | 6.19 |
| 20 g MEA + (80 g H₂O + 0.2 g [EMmim][NTf₂]) | 12.01 |
| 20 g MEA + 80 g H₂O | 12.04 |
| MEA without catalyst after the 1^{st} abs. | 8.79 |
| MEA with [EMmim][NTf₂] catalyst after the 1^{st} abs. | 8.52 |
| MEA without catalyst after the 1^{st} cyclic abs.-des. | 9.47 |
| MEA with [EMmim][NTf₂] catalyst after the 1^{st} cyclic abs.-des. | 9.46 |
| MEA with [EMmim][NTf₂] catalyst after 50 cycles of abs.-des. | 9.34 |

The catalytic effect of [EMmim][NTf₂] at different absorption and desorption times is observed through FT-IR spectra, as shown in FIGS. 4E-4H. The bands at 1324 cm⁻¹ (stretching of N—COO⁻), 1488 cm⁻¹ (symmetric stretching of COO—) and 1559 cm⁻¹ (asymmetric stretching of COO⁻) are ascribed to the MEACOO⁻⁸, while peaks at 1385 cm⁻¹ and 1635 cm⁻¹ are assigned to CO₃²⁻ and HCO₃⁻, respectively. Intensities of peaks of HCO₃⁻in the catalytic MEA solution during CO₂ absorption (see FIG. 4F) increase faster than those of the uncatalytic ones, shown in FIG. 4E. Moreover, peak intensities of MEACOO⁻ and CO₃²⁻ for the catalytic MEA solutions at the end of CO₂ absorption (7800 s or 130 min) are stronger than those of the uncatalytic one. Differences are more obvious for the desorption tests, as shown in FIG. 4G and FIG. 4H. Peak intensities of HCO₃⁻ in the uncatalytic MEA solutions decrease slowly with the continuous CO₂ desorption, and the intensities of CO₃²⁻ and MEACOO⁻ peaks and thus the concentrations of CO₃²⁻ and MEACOO⁻ barely change, in spite of the subsequent slightly noticeable variations. However, peak intensities of HCO₃⁻, CO₃²⁻ and MEACOO⁻ of the catalytic MEA solutions decrease considerably fast with time during CO₂ desorption, especially in the initial 10 min. The experimental observations of the changes in concentrations of intermediates with FT-IR spectra confirm the significant catalytic effect of the [EMmim][NTf₂].

### 4.2. Unanalyzed and Catalyzed CO2 Sorption Pathways, Desorption Pathways, and Essential Differences

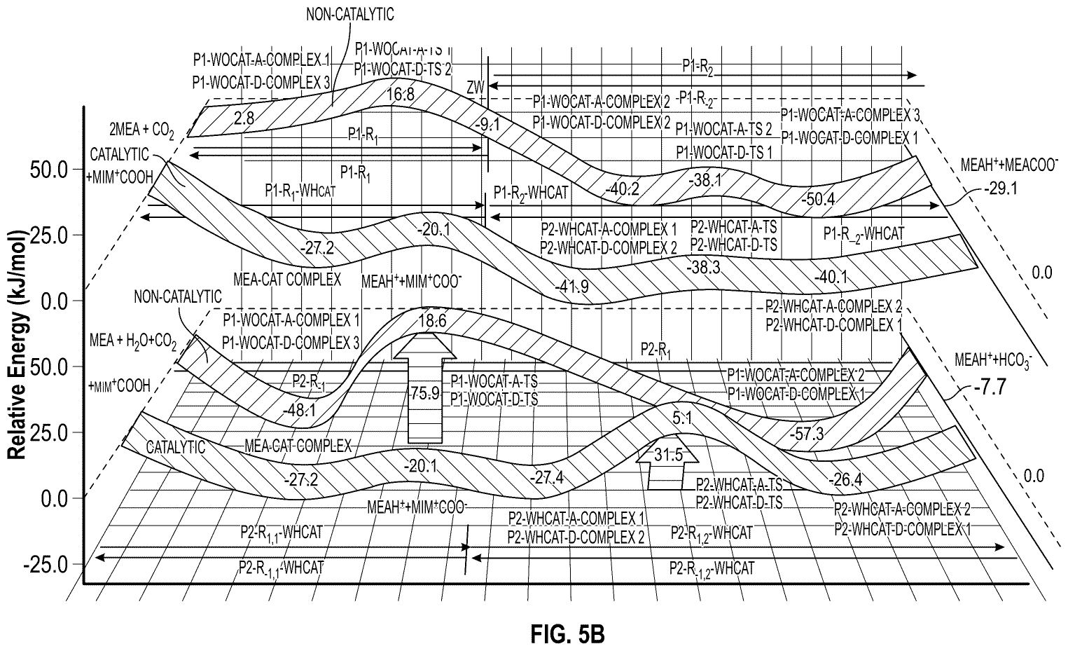

The density functional theory (DFT) calculations in this research have been performed by means of the Dmol3 program in the Materials Studio package. In order to evaluate the accuracy of the methods set for computing the catalytic effect of [EMmim⁺][NTF₂⁻], DFT based calculations for the reactions during CO₂ capture without use of the catalyst were conducted and compared to those reported in the disclosure. The reaction processes with and without use of catalysts are shown vertically and horizontally in FIG. 5A, respectively, while the corresponding energy changes for each step are provided in FIG. 5B. Also, the calculation results can help to identify the high energy barrier step in CO₂ desorption process, which give hints on the effectiveness of the [EMmim⁺][NTF₂⁻] catalyst.

When catalyst [EMmim⁺][NTF₂⁻] cannot be used, there are two possible CO₂ capture pathways, P1-WO_{cat}-MEA-CO₂ (pathway without use of both the catalyst and or in the presence of H₂O) and P2-WO_{cat}-MEA-CO₂—H₂O (pathway without use of the catalyst but with the presence of H₂O), based on the zwitterion (ZW) mechanism and bicarbonate (HCO₃⁻) formation, respectively. The step reactions in P1-WO_{cat}-MEA-CO₂ (without the presence of water) which is the reactions of function groups in any amines, such as MEA, including solid —NH₂ containing sorbent with CO₂ or liquid amine groups, include:

CO₂+MEA↔MEA⁺COO⁻(ZW) (P1-R₁)

MEA⁺COO⁻+MEA↔MEACOO⁻+MEAH⁺ (P1-R₂),

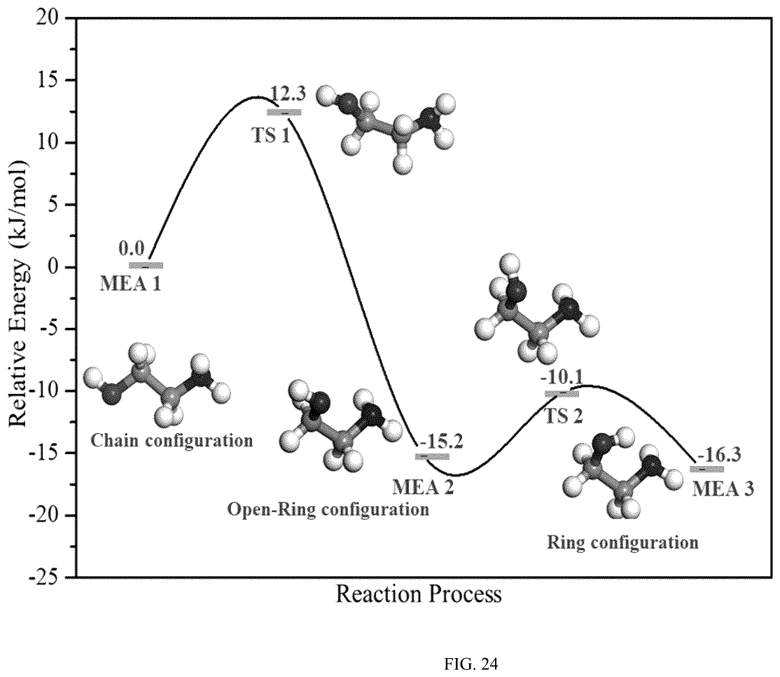

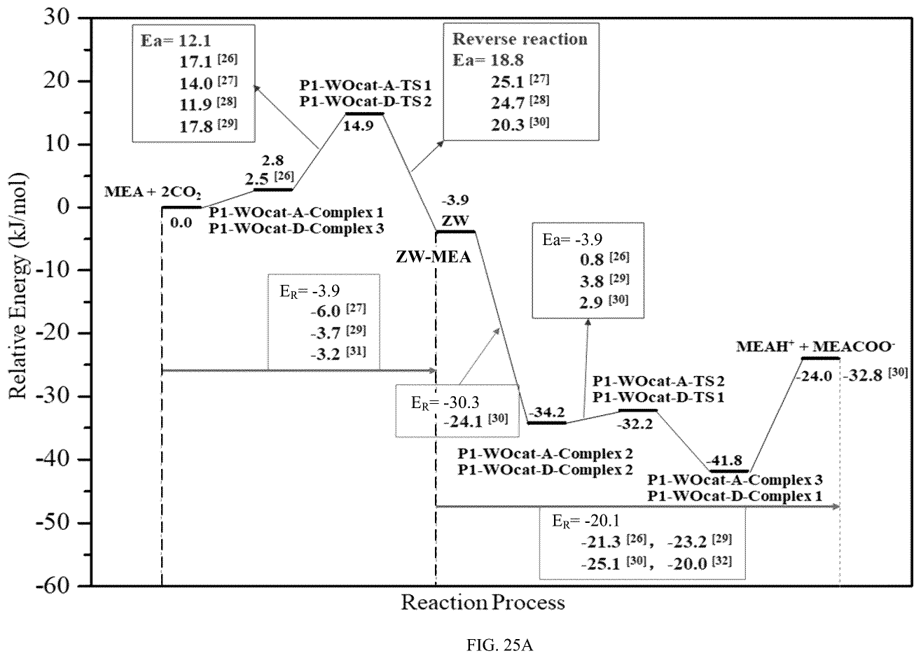

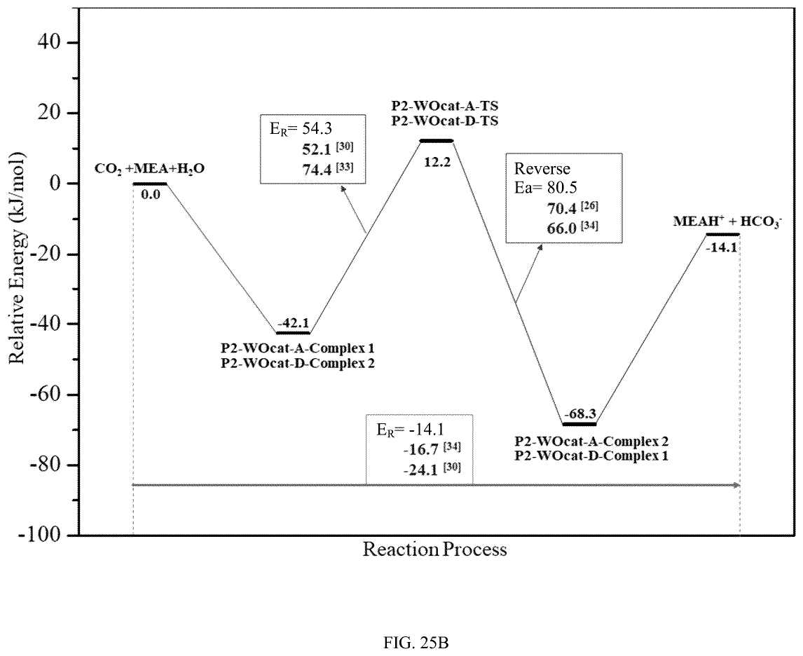

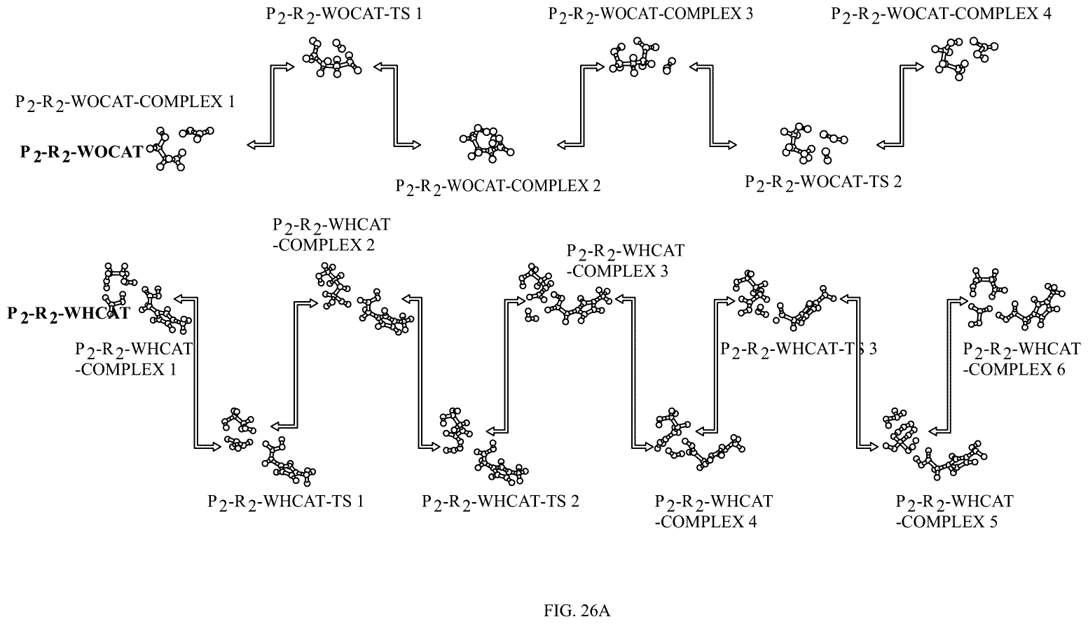

which are shown in FIG. 5A. If water is present, the reaction only forms MEAH⁺ along with HCO₃⁻ (Carbonic acid). The P1-WO_{cat}-MEA-CO₂ reaction mechanism allows solid based CO₂ capture. MEA is a —NH₂ based amine or one of the —NH₂ carrying amine compounds or containing an amine compound. The ring configuration of MEA as shown in FIG. 24 can be the most stable structure, where, for example, the stability order of MEA can be: Ring configuration>Open-Ring configuration>Chain configuration. However, the activation energies for transformation between each other can be moderate, indicating they could exist at the same time. Ring configuration, the most stable structure can be chosen for our calculations. As shown in FIG. 5B, the absorption process in P1-WO_{cat}-MEA-CO₂, including P1-R₁ and P1-R₂ can be exothermic because it can release between 24.0 kJ/mol and 29.1 kJ/mol, which can be not only consistent with the experimental observation that the solvent temperature can be found increase slightly during the CO₂ absorption process, but also agreed with the measured value. Furthermore, the calculated reaction energies (Eᵣ) and activation energies (Eₐ) in the forward (for CO₂ absorption) and reverse (for CO₂ desorption) of P1-WO_{cat}-MEA-CO₂, P1-R₁ and P1-R₂, as well as P1-R₋₁ and P1-R₋₂, respectively, are very close to those in the same literature, shown in FIGS. 25A and 25B. Thus, the computational methods are agreeable to these values. Special attention should be paid to P1-R₋₁ because it can be identified as the rate determining step of CO₂ desorption for P1-WO_{cat}-MEA-CO₂ due to its high reaction energy (31.1 kJ/mol). Due to the lack of the presence of water, HCO₃⁻ is not formed in the first step of the reaction. P1-R₁ and P1R₂ are the reactions of —NH₂ function groups in any amines including solid —NH2 contain sorbent with CO₂.

For P2-WO_{cat}-MEA-CO₂—H₂O where HCO₃⁻ can be involved due to the presence of water. The commonly bicarbonate generation reactions are:

CO₂+MEA+H₂O↔HCO₃⁻+MEAH⁺ (P2-R₁)

CO₂+H₂O↔HCO₃⁻+H⁺ (P2-R₂₋₁)

HCO₃⁻+MEA↔MEACOO⁻+H₂O (P2-R₂₋₂)

MEACOO⁻+H₃O⁺↔HCO₃⁻+MEAH⁺ (P2-R₂₋₃)

CO₂+MEA↔MEA⁺COO⁻ (P2-R₃₋₁)

MEA⁺COO⁻+H₂O→HCO₃⁻+MEAH⁺. (P2-R₃₋₂)

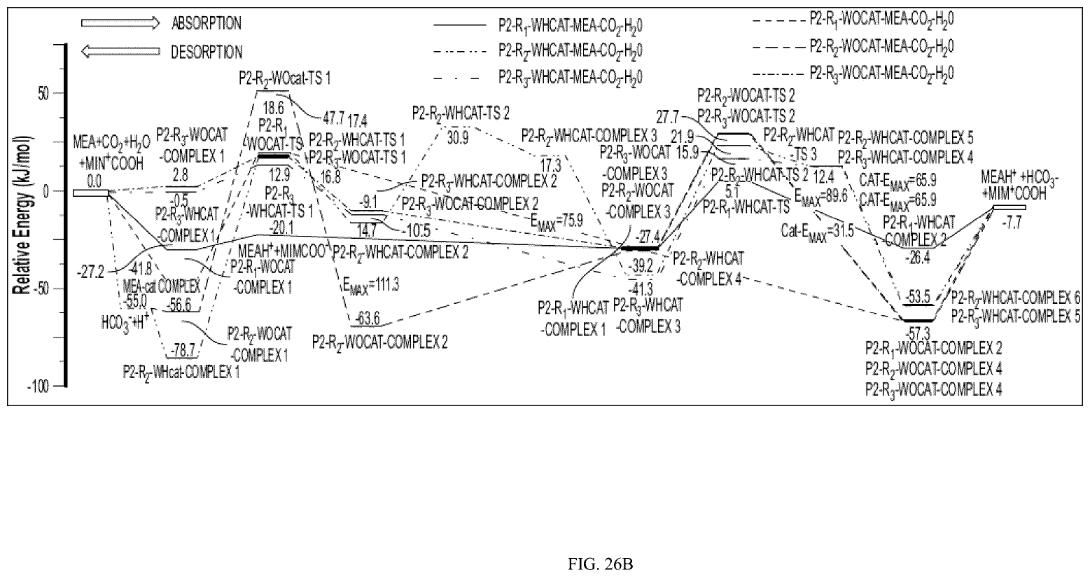

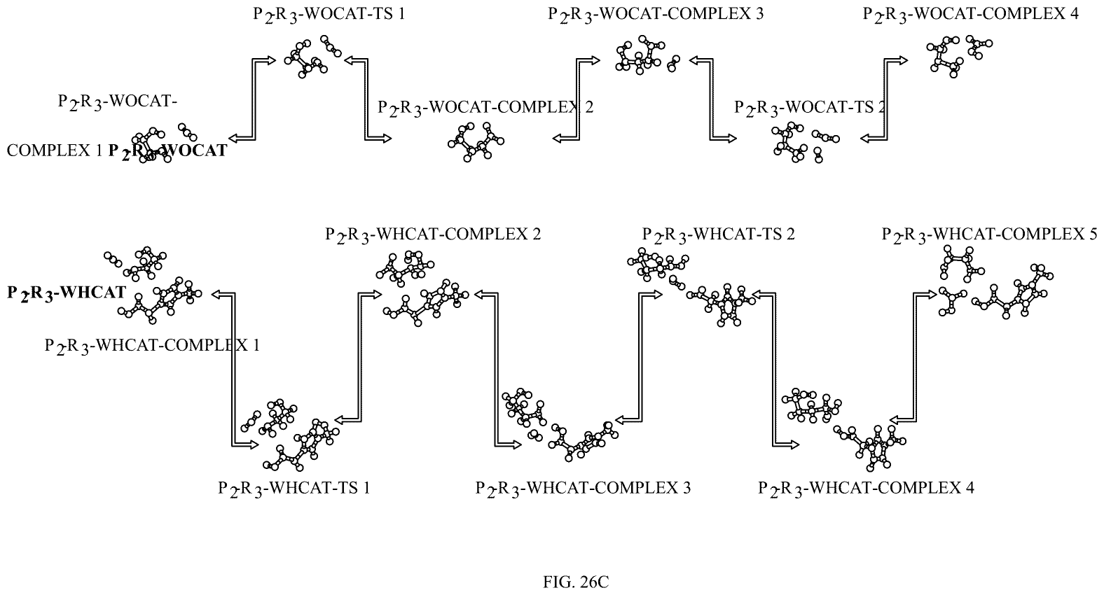

The reaction energy values of P2-R₁ to P2-R₃ were calculated and compared in FIG. 26. [mimCH₂COOH]⁺ as a Brønsted acid is the core of the catalytic CO₂ capture technology, thus, [mimCH₂COOH]⁺ instead of [EMmim][NTf₂] is used for modeling the catalyst. For example, the highest step reaction energy changes during catalytic CO₂ desorption, P2-R₁-WO_{cat}-MEA-CO₂-H₂O is the most sensitive step. In addition, CO₂ absorption in P2-R₁-WO_{cat}-MEA-CO₂—H₂O has the lowest maximum reaction energy, indicating that CO₂ absorption with P2-R₁-WO_{cat}-MEA-CO₂—H₂O is the easiest one among the three pathways. Thus, can be P2-WO_{cat}-MEA-CO₂—H₂O (P2-R₁) can be the preferred pathway because of its lowest energy barrier among all the steps of P2-R₁ to P2-R₃. That energy barrier can be 66.7 kJ/mol, which can be close to the value (74.4 kJ/mol) obtained by others. Also, P2-WO_{cat}-MEA-CO₂—H₂O can be a very possible reaction pathway in the presence of water according to the data in FIGS. 4A-4H. Thus, FIGS. 5A and 5B only show P2-WO_{cat}-MEA-CO₂—H₂O and its step reactions as well as the associated energy data. The ionic catalyst can accelerate CO₂ capture with and without the presence of water or the liquid and solid —NH₂ containing sorbents.

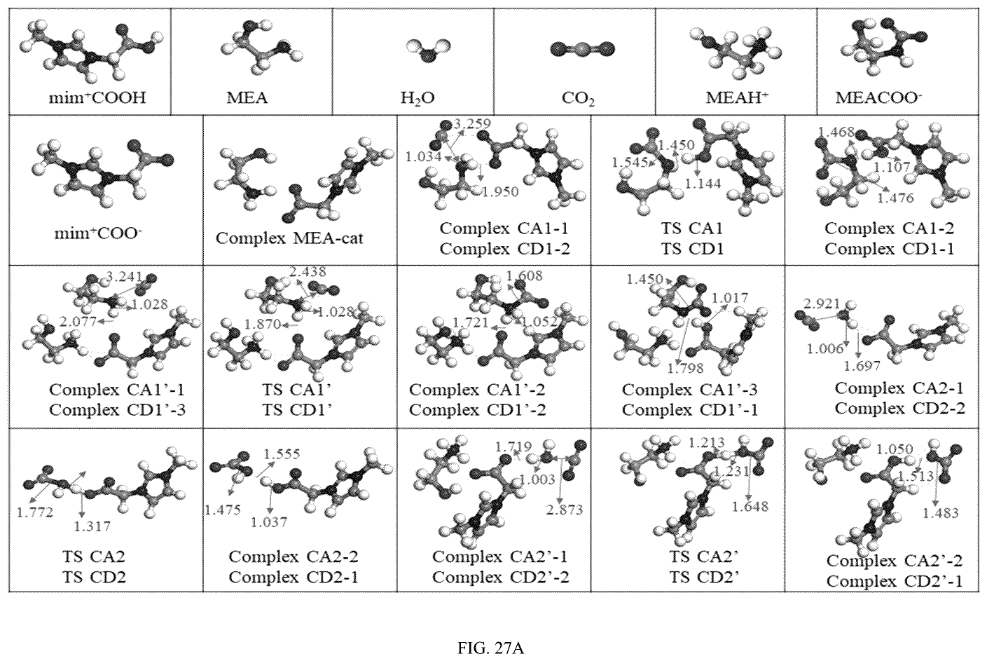

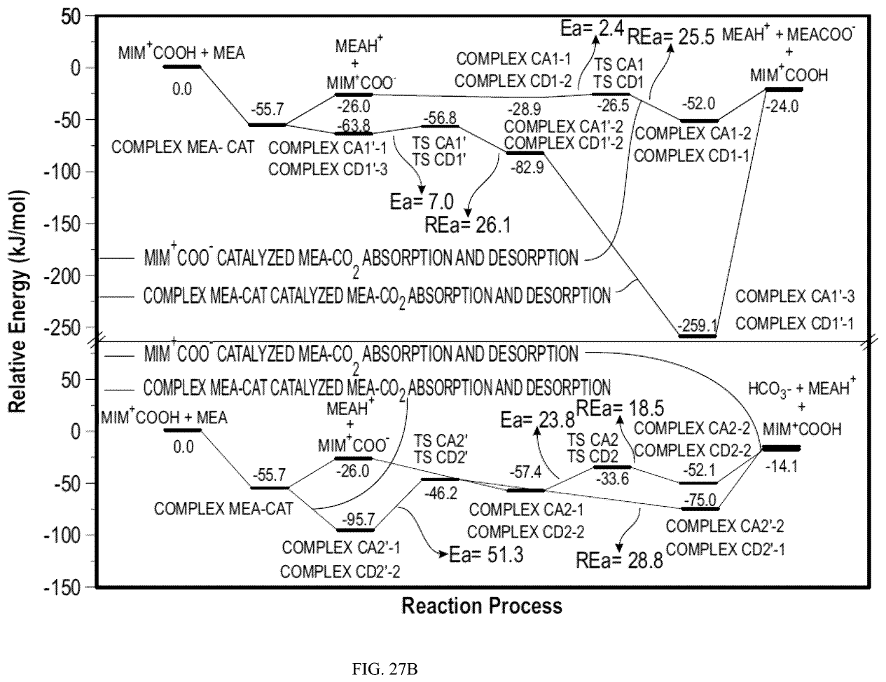

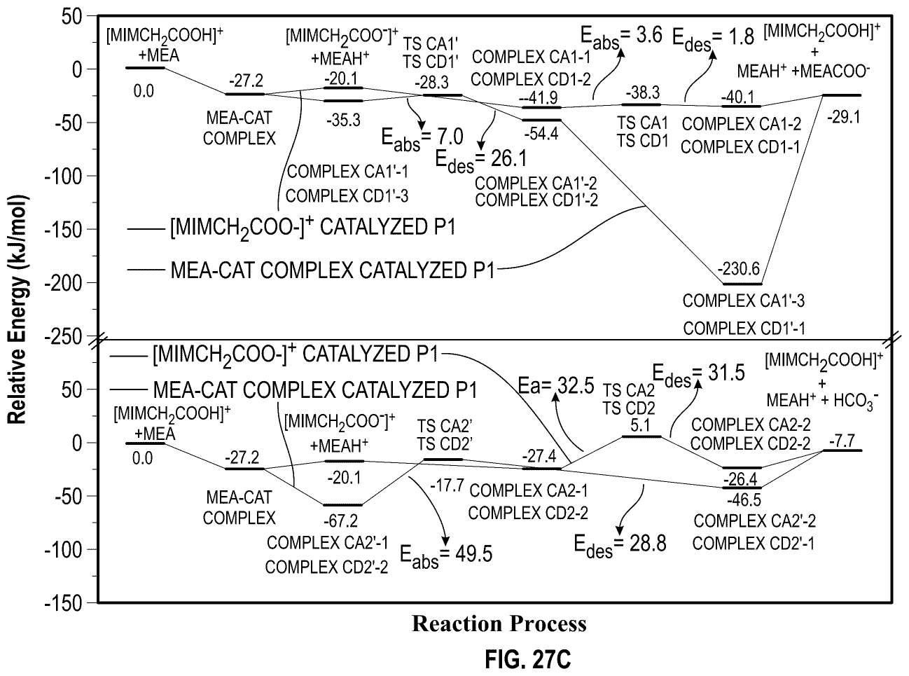

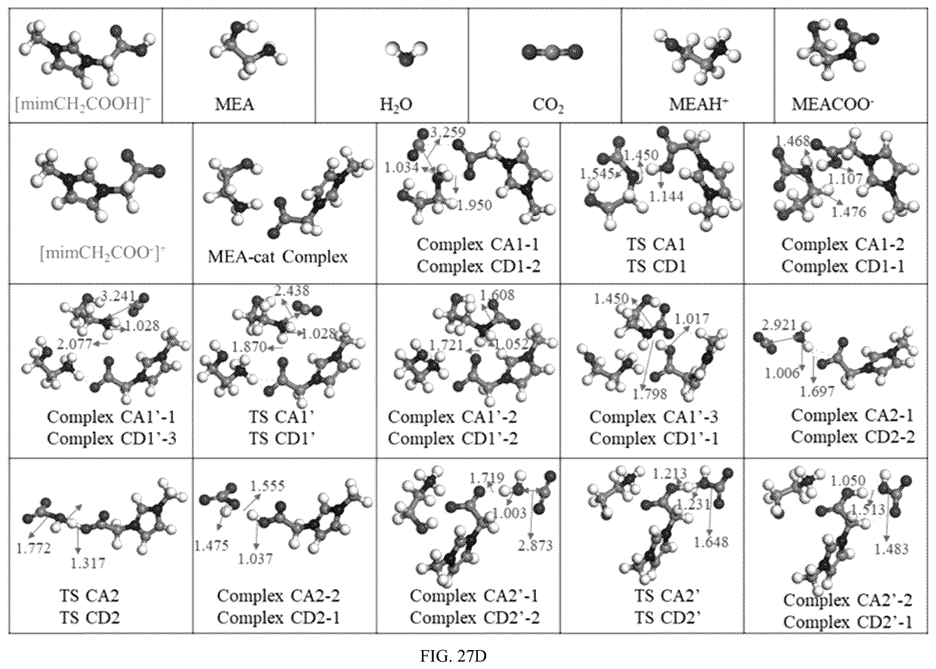

Then, the assured computational methods were applied to explain how the catalyst −[EMmim⁺][NTF₂⁻] can overcome the challenge of chemisorption-based CO₂ capture via significant acceleration of CO₂ desorption with catalysis in P1-WH_{cat}-MEA-CO₂ (pathway with use of the organocatalyst but without the presence of H₂O) and P2-WH_{cat}-MEA-CO₂—H₂O (pathway with use of both the catalyst, such as an organocatalyst, and H₂O). A liquid catalyst can accelerate CO₂ capture with and without the presence of water or a liquid and solid —NH₂ containing sorbent. The calculated results in FIGS. 5A and 5B clearly show that mim⁺COOH in EMmim⁺][NTF₂⁻] prefers to react with MEA to form the complex of MEAH⁺ and mim+COO⁻, denoted as MEA-cat Complex in FIGS. 5A and 5B without any energy barrier. As shown in FIGS. 27A-27D, after the decomposition of the MEA-cat Complex, where the acidic [mimCH₂COO⁻]⁺ reacts with the basic MEA, into MEAH⁺ and mim⁺COO⁻. The latter intermediate (mim+COO⁻) or [mimCH₂COO⁻]⁺ can be found to be more effective than the MEA-cat Complex in accelerating MEACOO⁻ formation in P1-WH_{cat}-MEA-CO₂. After a comparison, the individual [mimCH₂COO⁻]⁺ or (mim⁺COO⁻) is preferred to be the catalyst of the process. Where, specifically, in accordance with aspects of the present disclosure FIG. 27D discloses the optimized geometries associated with the possible catalyzed pathways for MEA-CO₂ and H₂O-MEA-CO₂. And, where, specifically, in accordance with aspects of the present disclosure FIG. 27C discloses the reaction energy profiles for the possible catalyzed pathways for MEA-CO₂ and H₂O-MEA-CO₂. E_{abs} marked with yellow stands for the energy barriers for absorption process and E_{des} marked with yellow represents that for desorption process. Therefore, after the decomposition of the MEA-cat Complex into MEAH⁺ and [mimCH₂COOH]⁺, the latter intermediate ([mimCH₂COO⁻]⁺) is found to be more effective than the MEA-cat Complex in accelerating the formation of MEACOO⁻ in P1-WH_{cat}-MEA-CO₂. As a result, in the presence of [mimCH₂COOH]⁺, P1-WH_{cat}-MEA-CO₂ can avoid the rate determining step of P1-WO_{cat}-MEA-CO₂, P1-R₁, which is the key point to lowering the overall CO₂ capture energy consumption. Instead, reactions in the catalyzed desorption pathway are in way of:

MEACOO⁻+mim⁺COOH→MEA+CO₂+mim⁺COO⁻(P1-R₋₂-WH_{cat})

MEAH⁺+mim⁺COO⁻→MEA+mim⁺COOH. (P1-R₋₁-WH_{cat})

Or

Or MEACOO⁻+mimCH₂COOH⁺→MEA+CO₂+[mimCH₂COO⁻]⁺ (P1-R₋₂-WH_{cat})

MEAH⁺+[mimCH₂COO⁻]⁺→MEA+[mimCH₂COOH]⁺. (P1-R₋₁-WH_{cat})

P1-R₁-WH_{cat} and P1-R₁-WH_{cat} provide the catalytic function of the ionic liquid for CO₂ capture without the presence of H₂O. Notice that the highest energy changes of the step reactions of P1-WH_{cat}-MEA-CO₂ in FIG. 5B, 11.0 kJ/mol for CO₂ absorption and 27.2 kJ/mol for CO₂ desorption, respectively, are lower than the corresponding values in P1-WO_{cat}-MEA-CO₂, 21.3 kJ/mol and 31.1 kJ/mol. Thus, [EMmim⁺][NTF₂⁻] can clearly facilitate the route of P1-WO_{cat}-MEA-CO₂ based CO₂ capture, with the P1-WH_{cat}-MEA-CO₂ more preferable.

Also, the energy profiles for CO₂ absorption-desorption in P2-R₁ to P2-R₃, with and without the presences of [EMmim⁺][NTF₂⁻], were calculated. The highest step reaction energy changes during catalytic CO₂ desorption, P2-R₁-WH_{cat}-MEA-CO₂—H₂O, P2-R₂-WH_{cat}-MEA-CO₂—H₂O and P2-R₃-WH_{cat}-MEA-CO₂—H₂O, are 31.5 kJ/mol, 65.9 kJ/mol and 65.9 kJ/mol, respectively, which are substantially lower than the corresponding values of non-catalytic P2-R₁-WO_{cat}-MEA-CO₂—H₂O, P2-R₂-WO_{cat}-MEA-CO₂—H₂O, and P2-R₃-WO_{cat}-MEA-CO₂—H₂O, which are 75.9 kJ/mol, 111.3 kJ/mol and 89.6 kJ/mol as shown in FIGS. 27A-27D. Although CO₂ desorption in all the three pathways can be accelerated with [EMmim⁺][NTF₂⁻], P2-R₁-WO_{cat}-MEA-CO₂—H₂O appears to be the most easiest one for the non-catalytic steps. Also, the CO₂ absorption in P2-R₁-WO_{cat}-MEA-CO₂—H₂O has the lowest maximum reaction energy, 32.5 kJ/mol, while those values for P2-R₂-WO_{cat}-MEA-CO₂—H₂O and P2-R₃-WO_{cat}-MEA-CO₂—H₂O are 104.3 kJ/mol and 55.1 kJ/mol, respectively. This result indicates that CO₂ absorption with P2-R₁-WO_{cat}-MEA-CO₂—H₂O can be the easiest one among the three pathways. Therefore, the P2-R₁-WH_{cat}-MEA-CO₂—H₂O based CO₂ capture pathway using catalyst can be also likely to be the most significant step. Accordingly, it can be further studied as detailed below.

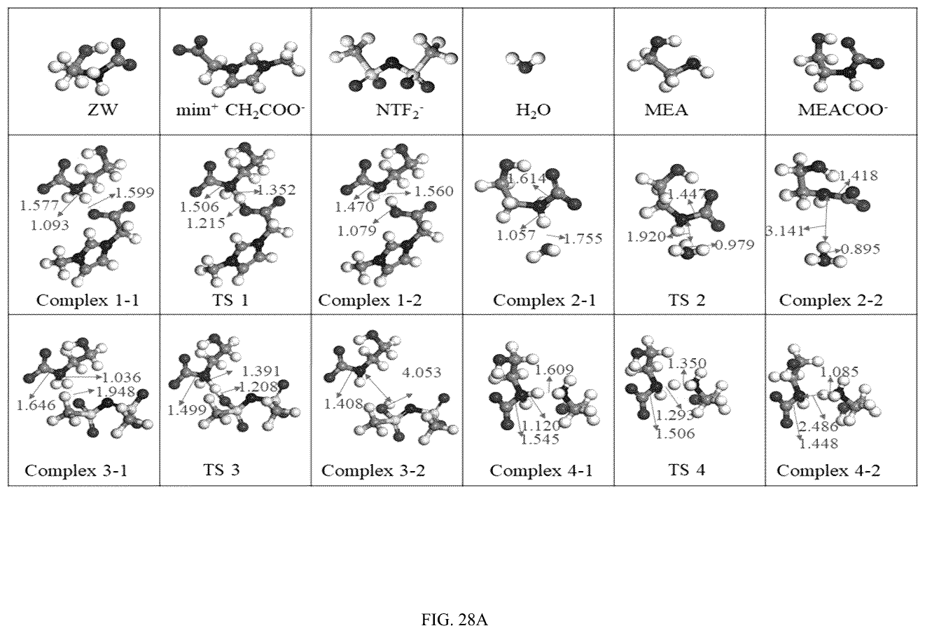

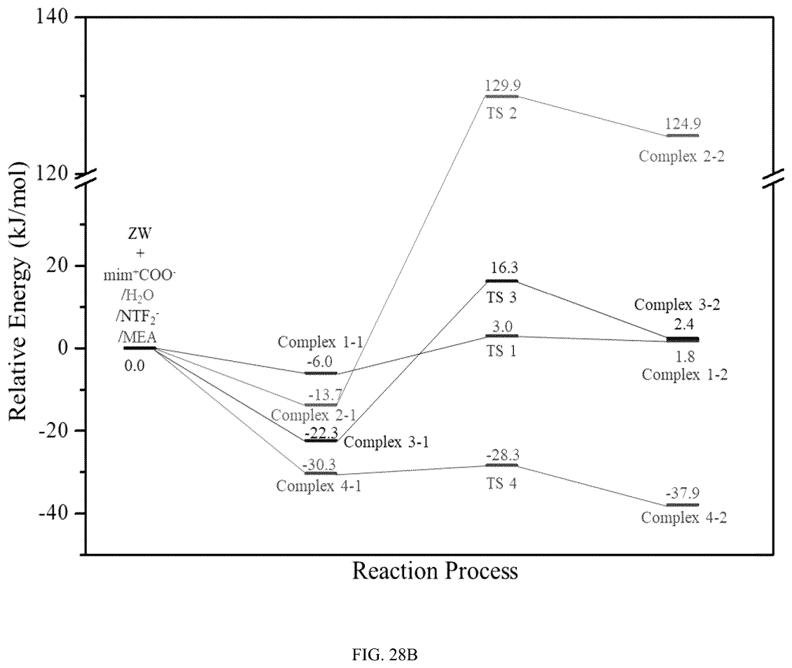

For P2-R₁-WH_{cat}-MEA-CO₂—H₂O with the presence of mim+COOH or [mimCH₂COO⁻]⁺, the CO₂ desorption can be very different from that in the uncatalyzed P2-R₁-WO_{cat}-MEA-CO₂—H₂O. The optimized geometries associated with the proton transfer reactions of ZW with [mimCH₂COOH]⁺ or mim⁺COOH, [NTF₂⁻], H2O and MEA are shown by way of example in FIG. 28A. In FIG. 28B, the reaction energy profiles for proton transfer reactions of ZW with [mimCH₂COOH]⁺, [NTF₂⁻], H2O and MEA are shown. When taking protons from ZW, the order of ability in withdrawing protons is: MEA>[mimCH₂COO⁻]⁺ or mim⁺COO⁻>[NTf₂]⁻>H₂O. The activation energies for the proton transfer process could be considered as the index of basicity.

As shown in FIG. 27A-27D, mim⁺COO⁻ and [mimCH₂COO⁻]⁺ can be more effective than MEA-cat Complex in accelerating both HCO₃⁻ formation for CO₂ absorption and HCO₃⁻ decomposition into CO₂ in P2-R₁-WH_{cat}-MEA-CO₂—H₂O, the latter especially from a reaction energy perspective. As shown in FIG. 5B, the highest step reaction energy changes of P2-R₁-WH_{cat}-MEA-CO₂—H₂O are 32.5 kJ/mol and 31.5 kJ/mol for CO₂ absorption and CO₂ desorption, respectively, which are lower than those corresponding values in P2-R₁-WO_{cat}-MEA-CO₂-H₂O, 66.7 kJ/mol and 75.9 kJ/mol. This result indicates that the CO₂ desorption (the proton transfer process from MEAH⁺ to HCO₃⁻ in P2-WO_{cat}-MEA-CO₂—H₂O, or in the presence of water) in FIG. 5A can be a difficult step, which can be significantly facilitated by using [EMmim⁺][NTF₂⁻]. Clearly, MEA can be stronger than [mimCH₂COOH]⁺ or mim⁺COO⁻ in withdrawing protons (FIG. 28A and FIG. 28B), thus the conjugated acid MEAH⁺ can be weaker than [mimCH₂COOH]⁺ or mim⁺COO⁻ in proton donation. It is consistent with the computed results because the change of MEAH⁺to HCO₃⁻ requires as high as 80.5 kJ/mol as marked in P2-R₁-WO_{cat}-MEA-CO₂—H₂O in FIG. 5B. However, with the presence of [EMmim⁺][NTF₂⁻], CO₂ desorption starts by the combination of HCO₃⁻ (another major species in spent MEA solution) with [mimCH₂COOH]⁺ or mim⁺COOH. The step only needs 31.5 kJ/mol and forms CO₂ and H₂O as highlighted in FIG. 5B, which can be much easier than the formation of CO₂ and OH⁻, as well as [mimCH₂COOH]⁺ or mim⁺COO⁻, due to its higher activation energy (102 kJ/mol) when catalysts are not used. Then, the resultant [mimCH₂COOH]⁺ or mim⁺COO⁻ and MEAH⁺ can easily react and form mim⁺COOH and MEA. The regenerated [mimCH₂COOH]⁺H can continuously catalyze CO₂ desorption during CO₂ desorption, thus [EMmim⁺][NTF₂⁻] can be a very effective catalyst for CO₂ desorption—the key step in reducing the overall energy consumption of CO₂ capture. Also, the regenerated MEA can be used for CO₂ absorption in the subsequent cyclic CO₂ capture.

The reactions in the desorption pathway with the use of [EMmim⁺][NTF₂⁻] are given below (P2-R_{-1,1}-WH_{cat} occurs without the presence of water):

HCO₃⁻+mim⁺COOH→CO₂+H₂O+mim⁺COO⁻ (P2-R_{-1,2}-WH_{cat})

MEAH⁺+mim⁺COO⁻→MEA+mim⁺COOH. (P2-R_{-1,1}-WH_{cat});

or

HCO₃⁻+mimCH₂COOH⁺→CO₂+H₂O+mimCH₂COOH⁺ (P2-R_{-1,2}-WH_{cat})

MEAH⁺+mimCH₂COO⁻]⁺MEA+[mimCH₂COOH]⁺. (P2-R_{-1,1}-WH_{cat}).

Obviously, [mimCH₂COOH]⁺ or mim⁺COOH as a Brønsted acid or the core of the novel catalytic CO₂ capture process and the chemisorption based capture CO₂ technologies including liquid and solid based CO₂ capture technologies, can be necessary for initiating and driving P2-R₋₁-WH_{cat}, which further confirms the significant function of ultrasonic [EMmim⁺][NTF₂⁻] activation or formation of-[EMmim⁺][NTF₂⁻]. The electrophilic characteristic of mim⁺ in mim⁺COOH or [mimCH₂COOH]⁺ can enhance the acidity of the —COOH in [mimCH₂COOH]⁺ or mim⁺COOH via inductive effect, which can be desired for P2-R_{-1,2}-WH_{cat} or formation of CO₂ and H₂O as well as mim⁺COO⁻ or [mimCH₂COOH]⁺. The stable intermediate [mimCH₂COO⁻]⁺ or (mim⁺COO⁻) resulting from the inherent resonance effect existing in —COO⁻ can be a conjugate base of [mimCH₂COOH]⁺ or mim⁺COOH, which can quickly react with Brønsted acid, MEAH⁺ in P2-R_{-1,1}-WH_{cat} for realization of MEA regeneration. Furthermore, the essential part of P2-R_{-1,2}-WH_{cat} can be to convert HCO₃⁻ into CO₂ and H₂O, which can be the common rate limiting step. Thus, [MAMmim⁺][NTF₂⁻] with the desired Brønsted acidity can be shown to be an highly effective organocatalyst for chemisorption based capture CO₂ technologies.

Consequently, the much quicker CO₂ desorption kinetics at low temperature enabled with the use of the catalyst can significantly advance the development of a new generation of CO₂ capture technology, from the perspectives of decreasing the parasitic penalty of these systems, capital investment, and environmental protection. The catalyst can make CO₂ capture much less demanding for high quality energy, and thus widely available low-temperature heat (e.g., those from solar collectors or waste heat) can be effectively used for CO₂ capture, which will not only lead to a significant decrease in parasitic energy penalty, capital and operating costs, but also be beneficial to the elimination of the secondary environmental pollutant resulting from MEA degradation during high-temperature CO₂ desorption of conventional CO₂ capture technologies. Therefore, [EMmim⁺][NTF₂⁻] can be a green transcendent catalyst for CO₂ capture technology.

### 5.0 Methods

### 5.1. Synthesis and Pre-Treatment of IL

The [EMmim⁺][NTF₂⁻] catalyst can be synthesized in accordance with the present disclosure, and the detailed synthesis information are presented as shown in FIG. 6.
(1) Synthesis of [CH₂COOCH₃mim⁺]Br, [CH₂COOCH₃mim⁺]Br can be synthesized by the reaction of 1-methylimidazole with methyl bromoacetate. In a typical experiment, methyl bromoacetate (0.155 mol) can be added dropwise to a solution of 1-methylimidazole (0.15 mol) in acetonitrile (150 ml) under nitrogen atmosphere. The mixture can be continuously stirred at room temperature until it can be thoroughly mixed, and then can be heated for 12 h at 55° C. The resulting solution can be evaporated under reduced pressure and can be repeatedly can be washed with ethyl acetate to remove excess methyl bromoacetate. After that, the above solution can be rotary evaporated under reduced pressure to obtain [CH₂COOCH₃mim⁺]Br also referred to as [EMmim][Br]. The resultant material can be dried under vacuum for at least 24 h before use (31.6 g, yield 89.6%).
(2) Synthesis of [CH₂COOCH₃mim⁺][NTF₂⁻], [CH₂COOCH₃mim⁺][NTF₂⁻] can be prepared from metathesis reaction of [CH₂COOCH₃mim⁺]Br with Li[NTF₂⁻]. In a typical procedure, [CH₂COOCH₃mim⁺]Br ([EMmim][Br]) (0.06 mol) can be mixed with equimolar amount of Li[NTF₂⁻] in water (20 ml), and the mixture can be vigorously stirred for 4 h at room temperature. Then, the bottom phase can be repeatedly washed with water or deionized water to remove excess salt. After that, the resulting solution can be rotary evaporated under reduced pressure to obtain [CH₂COOCH₃mim⁺][NTF₂⁻] ([EMmim⁺][NTF₂⁻]). The IL can be dried under vacuum for at least 24 h before use (23.1 g, yield 88.3%).

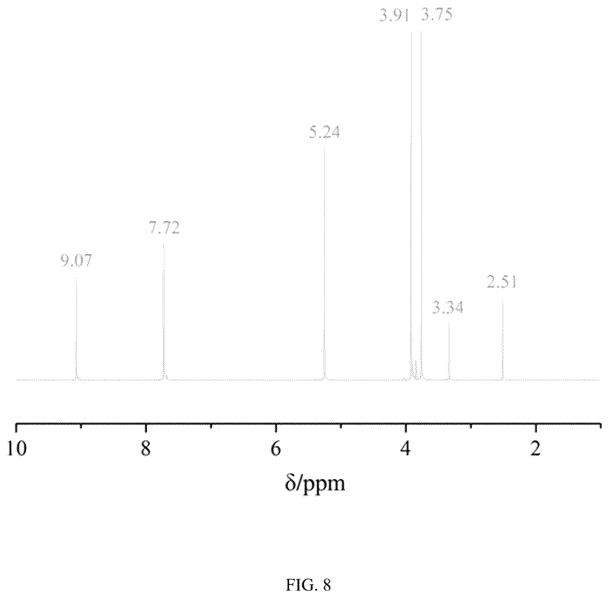

The structure of the synthesized IL can be confirmed by ¹H NMR, ¹³C NMR, FT-IR and ESI-MS spectrum (as shown in FIGS. 8-11B).

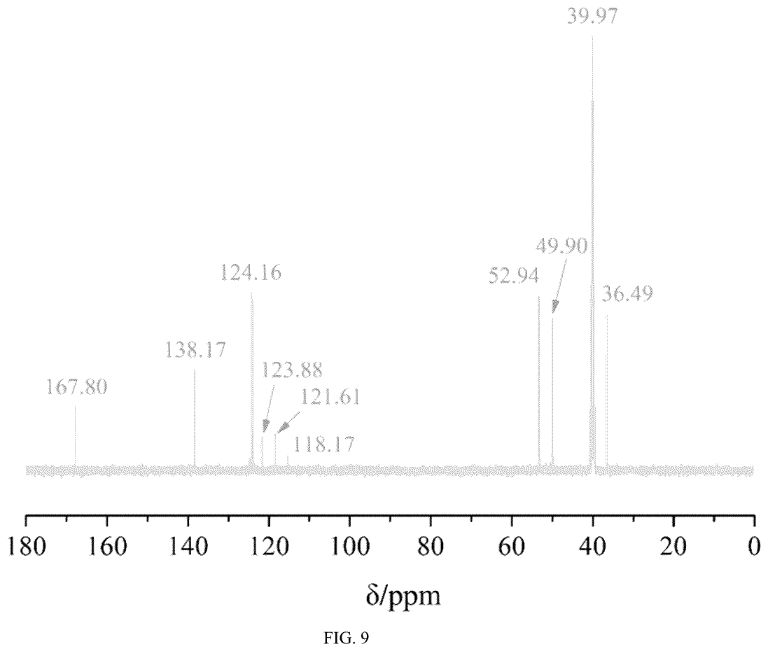

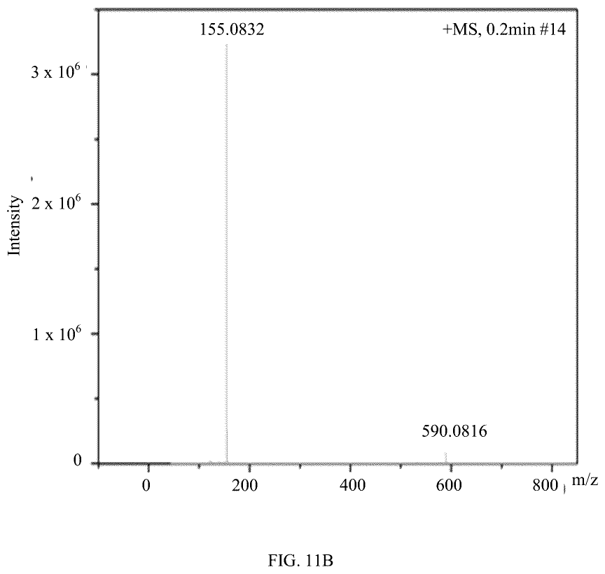

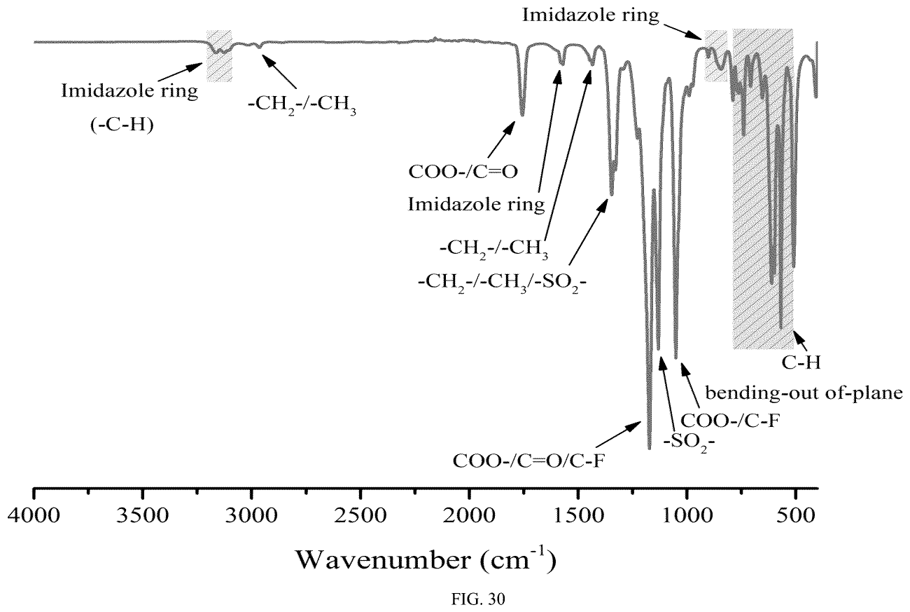

To further enhance the catalytic performance of the synthesized IL catalyst, the [EMmim⁺][NTF₂⁻] can be treated by ultrasonic treatment with the different conditions at room temperature (Powersonic P1100D-45, Advanced Ceramics Technology (M) SDN. BHD.), and then used for the catalytic CO₂ capture process. Structures of the synthesized IL were confirmed by ¹H NMR, ¹³C NMR, FT-IR and ESI-MS spectra in FIGS. 8, 9, 11A, 11B and 30, respectively. Where, specifically, in accordance with aspects of the present disclosure, FIG. 8 shows data of the ¹H NMR (Bruker spectrometer, 400 MHz, d6-DMSO) spectrum of [EMmim][NTf₂] is δ 9.07 (s, 1H, H2), 7.72 (s, 2H, H4 and H5), 5.24 (s, 2H, H6), 3.91 (s, 3H, H8), 3.75 (s, 3H, H3). Where, specifically, in accordance with aspects of the present disclosure, FIG. 9 shows data of the ¹³C NMR (Bruker spectrometer, 400 MHz, d6-DMSO) spectrum of [EMmim][NTf₂]: δ 36.49 (C3), 49.90 (C8), 52.94 (C6), 118.17, 121.61 (C9), 123.88, 124.16 (C4, C5), 138.17 (C2), 167.80 (C7). And, where, specifically, in accordance with aspects of the present disclosure, FIG. 8 shows as further illustrated in FIG. 30, the FT-IR spectrum of [EMmim][NTf₂] collects with a Thermo Nicolet Magna-IR 760 spectrometer with a resolution of 4 cm⁻¹ by scanning 32 times from 4000 to 400 cm⁻¹. Moreover, as shown in FIGS. 11A-11B, the ESI-MS spectrum of [EMmim][NTf₂] may present m/z=155.1 for [EMmim]+ in FIG. 11A, and m/z=279.9 for [NTf2]− in FIG. 11B, which the ESI-MS spectrum was obtained, by way of example, by ultra-high-resolution electro-spray time-of-flight mass spectrometry (Bruker micro TOF II, Germany).

### 5.2. Characterizations

¹H NMR and ¹³C NMR spectra were recorded on a Bruker spectrometer (400 MHz) in DMSO. ESI-MS spectrum can be obtained by Ultra-high-resolution electro-spray time-of-flight mass spectrometry (Bruker microTOF II, Germany). FT-IR spectra were collected using a Thermo Nicolet Magna-IR 760 spectrometer with a resolution of 4 cm⁻¹ by scanning 60 times from 400 to 4000 cm⁻¹. Raman spectrum measurements were conducted using an Advantage 785 Raman Spectrometer with a 758 nm laser and up to 60 mW radiation power during determination. About 1.5 mL liquid sample can be introduced into a clear shell vial, and then use for the Raman test. Thermogravimetric analyses (TGA) curve of IL can be obtained using a TA Instruments SDT Q600 apparatus with a heating ramp of 10° C./min at the temperature of 20-550° C.

The Brønsted acid sites of the IL can be monitored using the Hammett function (H₀) which obtained by UV-Vis spectroscopy technique. The 4-nitroaniline solution (25 μm) can be employed as an basic indicator to trap the dissociated acidic protons of the [EMmim⁺][NTF₂⁻] in water following the published method. The acidity parameter H₀ can be calculated using the following equation (1).

H₀=pKa+log([I]/[IH⁺]) (1)

where pKa can be 0.99 for the aqueous 4-nirtoaniline solution, [I] and [IH⁺] respectively represent the molar concentrations of the unprotonated and protonated forms of the 4-nirtoaniline in the aqueous solution. The absorbance of the indicator and the indicator with [EMmim⁺][NTF₂⁻] solution can be measured using a spectrophotometer (SpectraMax M2^{c}, CA, USA) at wavelength from 250 to 500 nm. The maximum absorbance of the samples can be found at 380 nm (aqueous 4-nirtoaniline solution).

### 5.3. CO₂ Absorption-Desorption Test

The CO₂ absorption-desorption test can be carried out using the experimental apparatus presented in FIGS. 12A and 12B. 250 mL three-necked flask can be employed as a reactor. 100 mL of 20 wt % aqueous MEA (99+%, product number: 11016-7-4L, Aldrich chemical company, Inc.) solution with desired quality of IL catalyst were added for each test. The first run of CO₂ absorption process was conducted at 30° C. and atmospheric pressure (0.78 bar at Laramie, Wyoming, USA, where the experiment was conducted), while the cyclic tests were conducted at 22° C. (room temperature). The 20 wt % MEA solution can be obtained by diluting pure MEA solvent with DI-water. CO₂ absorption process can be conducted at 30° C. and atmospheric pressure. The simulated flue gas containing 10 vol % CO₂, 10 vol % 02 and 80 vol % N₂ with a flow rate of 500 mL/min can be bubbled into amine solution sing the inlet gas 15. (Gas flow can be calibrated at local atmospheric pressure: 0.78 bar at Laramie). The N₂ gas is kept in the N₂ gas cylinder 1, the O₂ gas may be housed in the O₂ gas cylinder 12 or stored in the mixed gas cylinder 2. The CO₂ gas may be housed in the CO₂ gas cylinder 11 or the mixed gas cylinder 2 along with the O₂. Other gases may be housed in their own cylinders or in the mixed gas cylinder 2. The gas flow from each cylinder may be controlled through the mass flow controller 3. The outlet gas concentration can be monitored with an inline gas analyzer 5 (NDIR ZRE, California Analytical Instruments) or flue gas analyzer 5, and then recorded using a data recording unit 5 and sent to a data analyzing computer 10. The quality of absorbed CO₂ in the MEA solution can be calculated by integrating the obtained CO₂ absorption curves (CO₂ concentration vs. absorption time). For the fresh MEA solution absorbed CO₂ process, when the desired amount of absorbed CO₂ can be obtained (178.0 mmol), the absorption process can be stopped. Absorption time for the first run test was 7800 s and that for each cyclic test was 1800 s.

Upon the finish of the CO₂ absorption experiment, the temperature of the MEA solution, housed in a furnace 6 of a thermostatic water bath system 4, can be gradually heated to 85° C. using a thermocouple 14 controlled by a temperature controller 13. During the desorption process, the released CO₂ can be carried by the N₂ gas with the flow rate of 500 mL/min from the reaction system to the gas analyzer. Each CO₂ desorption process can be duration for 1,800 s. A magnetic stirring 16 or mechanical stirring can be used to make the MEA solution and catalyst uniform. A condenser 7 with a cooling water (5° C.) can be connected with the three-necked flask to avoid the loss of MEA solution. A cooling unit 17 may be operatively connected to the condenser 7 to cool the condenser 7 or control the temperature. Moisture is removed by the moisture remover 8 prior to being sent to the flue gas analyzer 5 or the mass spectrometer 9.

### 5.4. Theoretical Studies

Density functional theory (DFT) studies on catalytic mechanism of CO₂ absorption and desorption processes are performed by means of Dmol³ program in Materials studio 6.0 package. The exchange correlation functional utilized can be the local density approximation with Perdew-Burke-Emzehof, known as GGA-PBE, and a double numerical basis set with polarization function on all atoms (the DNP basis set) can be used throughout the study. The following thresholds are used for the geometry optimization: 1×10⁵ Hartree for the maximum energy change, 2×10⁻³ Hartree/Å for the maximum force, and 5×10⁻³ Å for the maximum displacement. The complete linear synchronous transit and quadratic synchronous transit (LST/QST) calculations are performed to obtain the structures of transition state. Vibrational frequencies are calculated at the optimized geometries to identify the nature of the stationary points (no imaginary frequency) and the transition state (only one imaginary frequency). Bond dissociation energy of A−B bond can be calculated as follow:

BDE(A−B)=Energy(A)+Energy(B)−Energy(A−B).

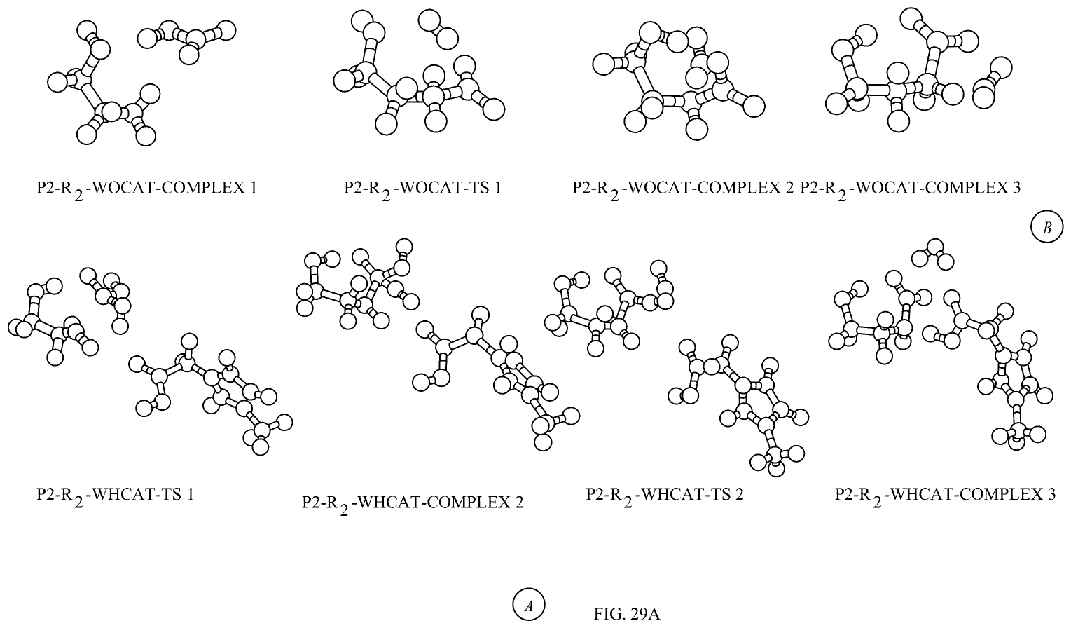

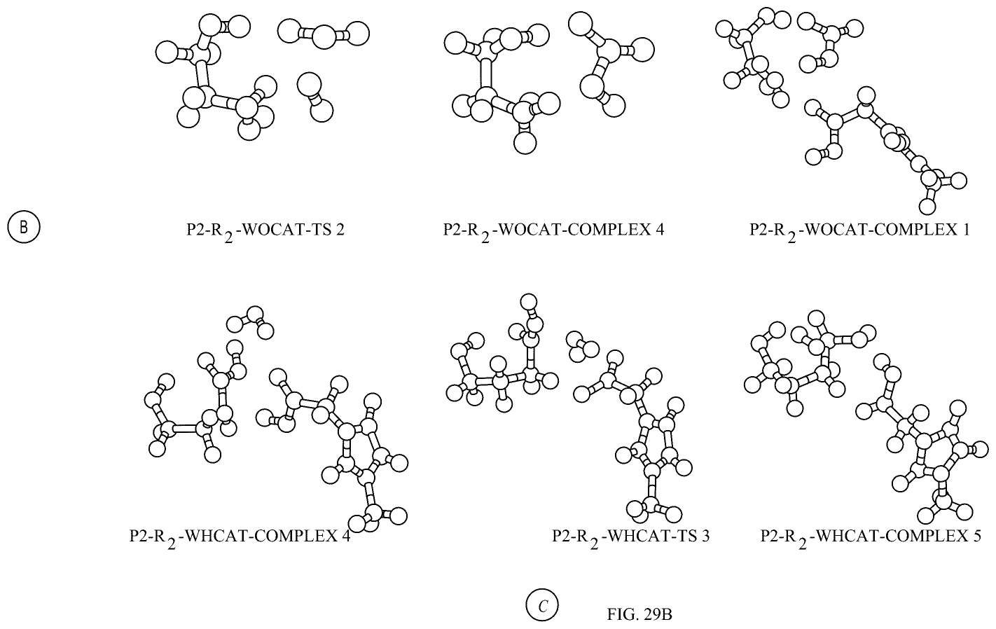

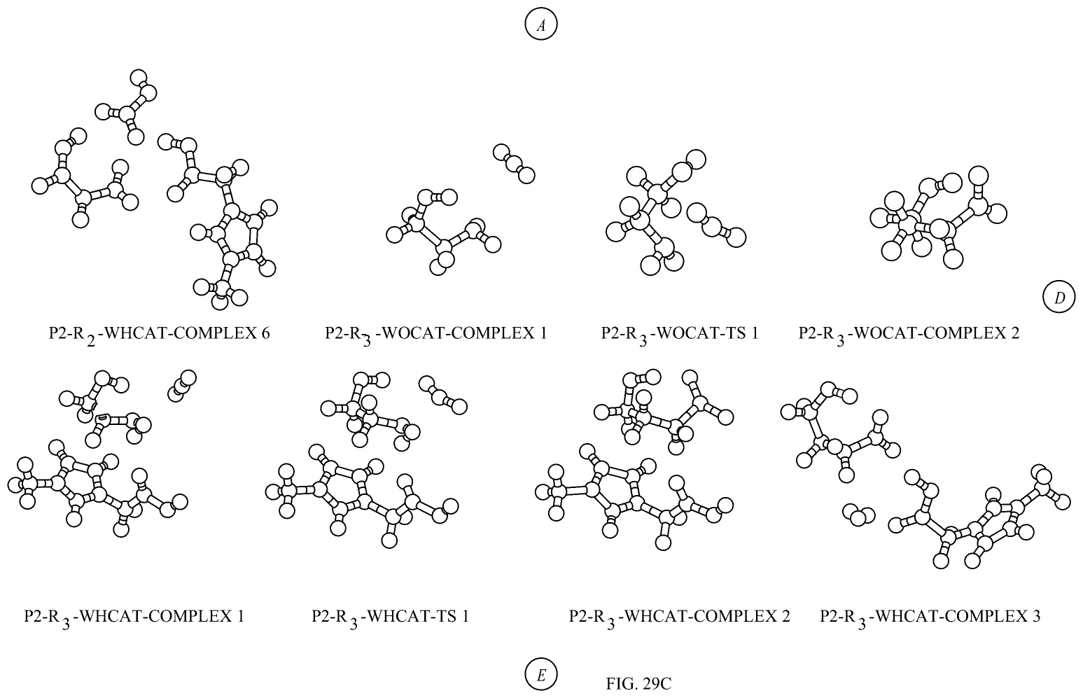

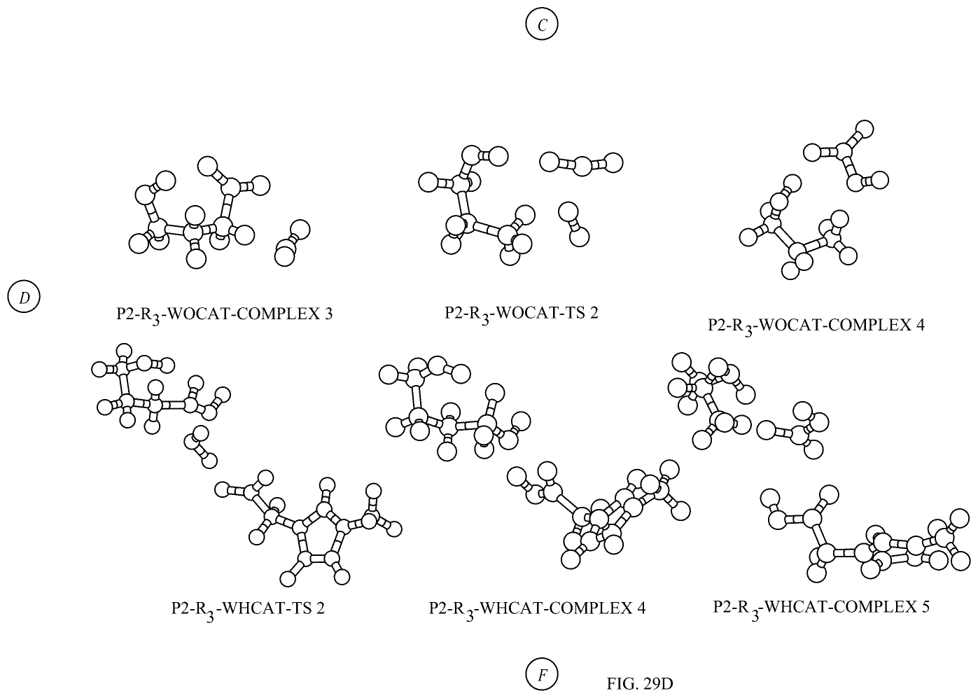

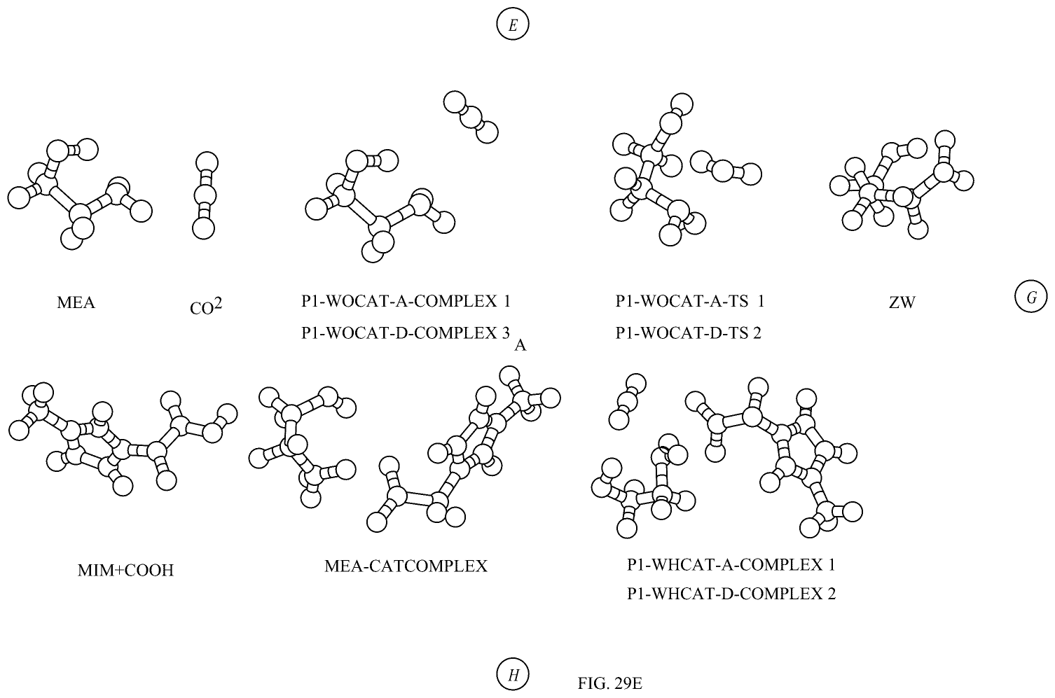

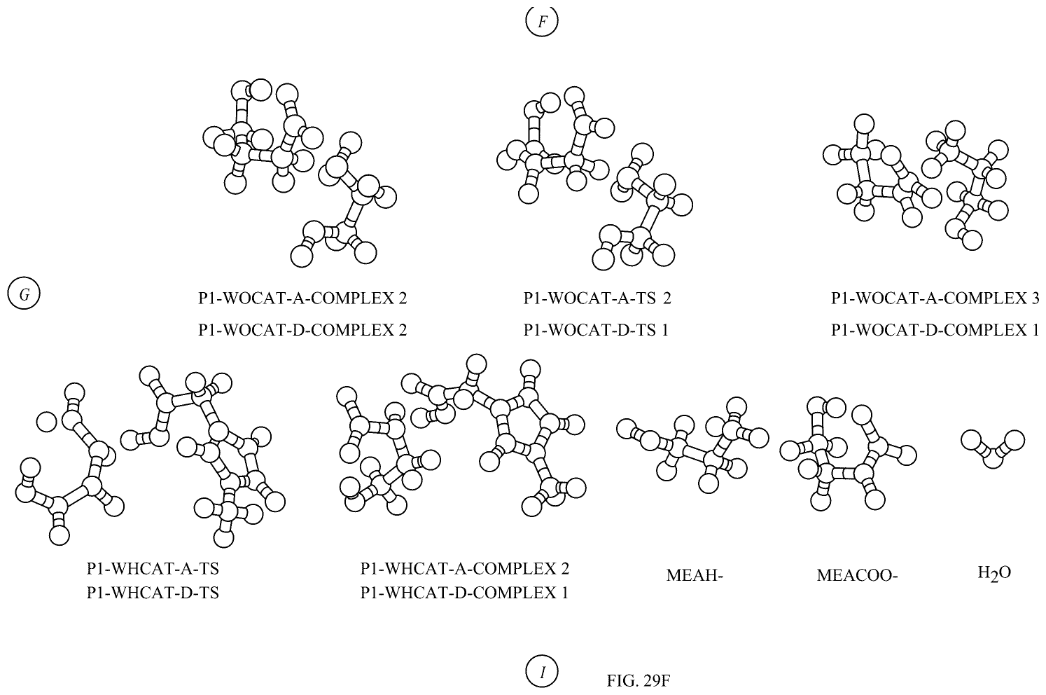

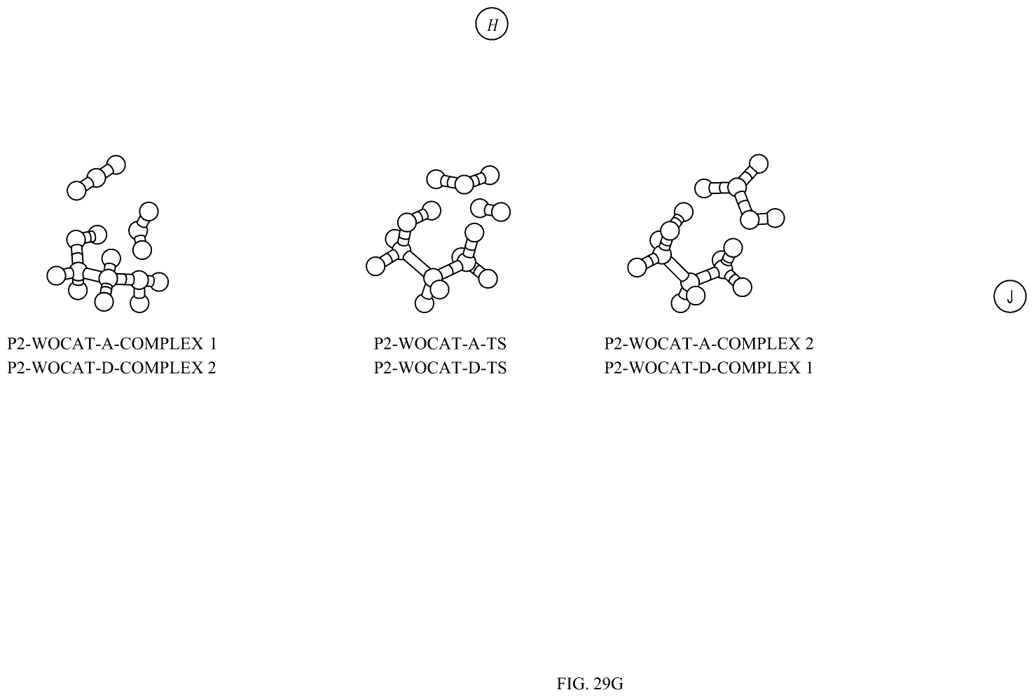

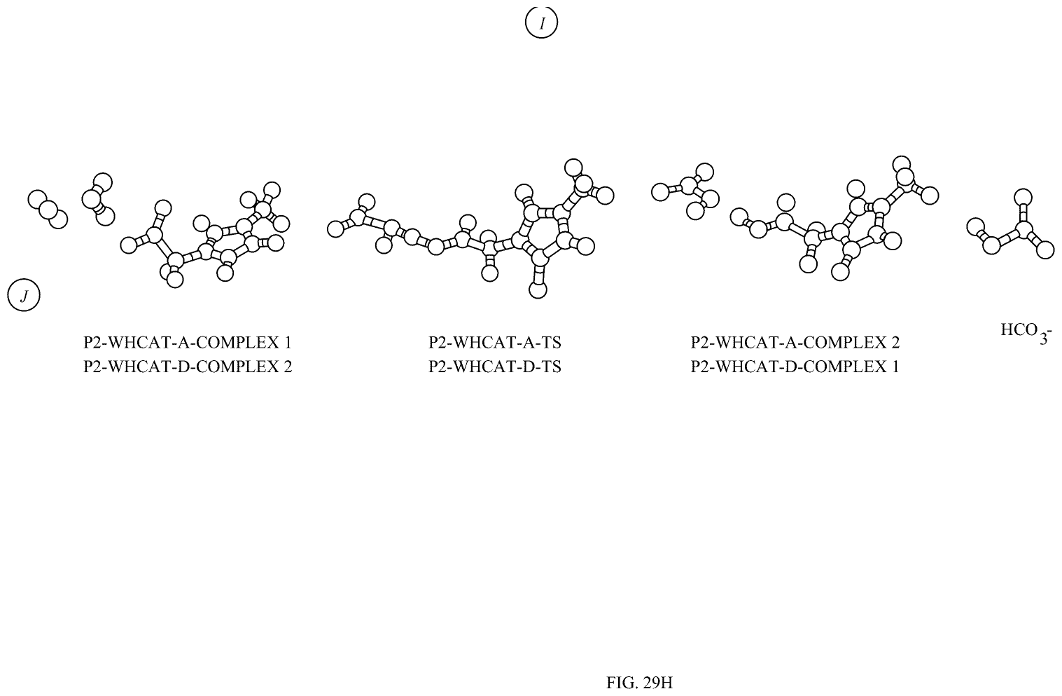

FIG. 29 provides graphs illustrating all the configurations, including reactants, intermediate, such as complexes, transition states and products listed in the Figures.

The disclosure is not to be limited to the particular aspects described herein. In particular, the disclosure contemplates numerous variations in ultrafast catalytic CO₂ capture catalyzed by a novel ultrasound-treated ionic liquid. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions can be made, which are within the intended spirit and scope of the disclosure.

What is claimed is:

1. A method for catalyzing both CO₂ sorption and desorption of chemisorption-based technologies; comprising:
providing an ionic liquid catalyst, wherein the ionic liquid catalyst is configured to capture CO₂ and wherein the ionic liquid catalyst is produced from a reaction between a catalytic amine and an ionic liquid;
providing CO₂ through a gas inlet; and
absorbing and desorbing the CO₂.

2. The method of claim 1, wherein an ester group of the ionic liquid reacts with the catalytic amine to produce an ionic catalyst.

3. The method of claim 1, wherein the ionic liquid catalyst contains fully disassociated —COOH.

4. The method of claim 1, further comprising:
treating monoethanolamine with the ionic liquid catalyst.

5. The method of claim 1, wherein the catalytic amine is regenerated.

6. The method of claim 1, wherein the ionic liquid catalyst is activated by hydrolysis.

7. A method for catalyzing both CO₂ sorption and desorption of chemisorption-based technologies; comprising:
providing an ionic liquid;
treating monoethanolamine (MEA) with the ionic liquid to form an ionic liquid catalyst, wherein the MEA is configured to capture CO₂;
activating the ionic liquid catalyst;
providing CO₂ through a gas inlet; and
absorbing or desorbing the CO₂.

8. The method of claim 7, wherein the IL catalyst comprises EMmim.

9. The method of claim 7, wherein the IL catalyst is a catalyst for any chemisorption based CO₂ captures.

10. The method of claim 7, wherein the ionic liquid catalyst is activated by ultrasonic hydrolysis.

11. The method of claim 7, wherein a —COOCH3 group in the ionic liquid is hydrolyzed into —COOH.

12. The method of claim 7, wherein the ionic liquid catalyst provides CO₂ capture for high quality energy with less energy demand.

13. The method of claim 7, wherein the ionic liquid catalyst eliminates secondary environmental pollutants resulting from the MEA degradation during high-temperature CO₂ desorption of chemisorption-based technologies.

14. The method of claim 7, wherein the ionic liquid catalyst is thermally stable at temperatures of at least 300° C.

15. A method for catalyzing both CO₂ sorption and desorption of chemisorption-based technologies; comprising:
mixing an amine with an acid to form a cation solution under a nitrogen atmosphere;
evaporating the cation solution to obtain a cation;
reaction the cation with an anion to form an ionic liquid solution;
ultrasonically treating the ionic liquid;
evaporating the ionic liquid solution to form an ionic liquid catalyst, wherein the ultrasonic treatment promotes catalytic activity;
providing CO₂; and
absorbing or desorbing the CO₂.

16. The method of claim 15, wherein the ionic liquid catalyst is formed by homogenous catalysis.

17. The method of claim 15, wherein the amine is monoethanolamine, and wherein the monethanolamine is regenerated.

18. The method of claim 17, wherein the IL catalyst is an EMmin catalyst promoting both CO₂ absorption and desorption.

19. The method of claim 15 wherein the absorbing and desorbing CO₂ is a solid based CO₂ capture.

20. The method of claim 15 wherein the absorbing and desorbing CO₂ is a liquid based CO₂ capture.
